(19) United States
(12) Patent Application Publication
(10) Pub. No.: US 2024/0275941 A1
(43) Pub. Date: Aug. 15, 2024

(54) METHOD, APPARATUS, AND MEDIUM FOR VIDEO PROCESSING

(71) Applicants: Beijing Bytedance Network Technology Co., Ltd, Beijing (CN); Bytedance Inc., Los Angeles, CA (US)

(72) Inventors: Na ZHANG, Beijing (CN); Kai Zhang, Los Angeles, CA (US); Li Zhang, Los Angeles, CA (US)

(21) Appl. No.: 18/615,916

(22) Filed: Mar. 25, 2024

Related U.S. Application Data
(63) Continuation of application No. PCT/CN2022/121154, filed on Sep. 24, 2022.

(30) Foreign Application Priority Data
Sep. 25, 2021 (WO) PCT/CN2021/120511

(51) Int. Cl. H04N 19/103; H04N 19/176

(52) U.S. Cl. CPC H04N 19/103; H04N 19/176

(57) ABSTRACT

A method for video processing comprises: determining, during a conversion between a target video block of a video and a bitstream of the video, an intra block copy (IBC)-based mode to be applied for the target video block based on at least one of: a mode based on affine motion compensated prediction, an affine IBC merge mode with block vector differences (MBVD), an intra template matching for IBC mode (TM_IBC), wherein a derived block vector (BV) is used as base candidates for the MBVD, an intra template matching for IBC mode (TM_IBC), wherein a derived BV is used as BV prediction candidate for IBC non-merge mode, an IBC prediction mode based on multi-hypothesis, a mode based on overlapped block motion compensation (OBMC), a mode based on geometric partitioning with the MBVD, or a mode based on geometric partitioning with TM; and performing the conversion based on the IBC-based mode.

### CROSS-REFERENCE TO RELATED APPLICATIONS

This application is a continuation of International Application No. PCT/CN2022/121154, filed on Sep. 24, 2022, which claims the benefit of International Application No. PCT/CN2021/120511 filed on Sep. 25, 2021. The entire contents of these applications are hereby incorporated by reference in their entireties.

### FIELD

Embodiments of the present disclosure relates generally to video coding techniques, and more particularly, to intra block copy (IBC) extension.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, during a conversion between a target video block of a video and a bitstream of the video, an intra block copy (IBC) -based mode to be applied for the target video block, the IBC-based mode being based on at least one of the following: an IBC mode based on affine motion compensated prediction, an affine IBC merge mode with block vector differences (MBVD), an intra template matching for IBC mode (TM_IBC), wherein a derived block vector (BV) by the TM_IBC is used as base candidates for the MBVD, an intra template matching for IBC mode (TM_IBC), wherein a derived block vector (BV) by the TM_IBC is used as BV prediction candidate for IBC non-merge mode, an IBC prediction mode based on multi-hypothesis, an IBC mode based on overlapped block motion compensation (OBMC), an IBC mode based on geometric partitioning with the MBVD, or an IBC mode based on geometric partitioning with template matching (TM); and performing the conversion based on the IBC-based mode. The method in accordance with the first aspect of the present disclosure provides improvement for IBC. More IBC based modes can be supported to improve the coding efficiency of IBC-based mode.

In a second aspect, an apparatus for processing video data is proposed. The apparatus for processing video data comprising a processor and a non-transitory memory with instructions thereon, wherein the instructions upon execution by the processor, cause the processor to perform a method in accordance with the first aspect.

In a third aspect, an apparatus for processing video data is proposed. The non-transitory computer-readable storage medium storing instructions that cause a processor to perform a method in accordance with the first aspect.

In a fourth aspect, a non-transitory computer-readable recording medium is proposed. The non-transitory computer-readable recording medium storing a bitstream of a video which is generated by a method performed by a video processing apparatus, wherein the method comprises: determining an IBC-based mode to be applied for the target video block, the IBC-based mode being based on at least one of the following: an IBC mode based on affine motion compensated prediction, an affine IBC MBVD, an TM_IBC, wherein a derived BV by the TM_IBC is used as base candidates for the MBVD, an TM_IBC, wherein a derived BV by the TM_IBC is used as BV prediction candidate for IBC non-merge mode, an IBC prediction mode based on multi-hypothesis, an IBC mode based on OBMC, an IBC mode based on geometric partitioning with the MBVD, or an IBC mode based on geometric partitioning with TM; and generating the bitstream based on the IBC-based mode.

In a fifth aspect, another method for video processing is proposed. The method for storing a bitstream of a video, comprising: determining an IBC-based mode to be applied for the target video block, the IBC-based mode being based on at least one of the following: an IBC mode based on affine motion compensated prediction, an affine IBC MBVD, an TM_IBC, wherein a derived BV by the TM_IBC is used as base candidates for the MBVD, an TM_IBC, wherein a derived BV by the TM_IBC is used as BV prediction candidate for IBC non-merge mode, an IBC prediction mode based on multi-hypothesis, an IBC mode based on OBMC, an IBC mode based on geometric partitioning with the MBVD, or an IBC mode based on geometric partitioning with TM; generating the bitstream based on the IBC-based mode; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example diagram showing example positions of spatial merge candidate;

FIG. 5 illustrates an example diagram showing candidate pairs considered for redundancy check of spatial merge candidates;

FIG. 6 illustrates an example diagram showing an example motion vector scaling for temporal merge candidate;

FIG. 7 illustrates an example diagram showing candidate positions for temporal merge candidate, C0 and C1;

FIG. 8 illustrates an example diagram showing VVC spatial neighboring blocks of the current block;

FIG. 9 illustrates an example diagram showing the relationship between the virtual block and the current block;

FIG. 10 illustrates an example diagram showing spatial neighboring blocks used to derive the spatial merge candidates;

FIG. 11A and FIG. 11B illustrate the SbTMVP process in VVC;

FIGS. 12A-12D illustrate current CTU processing order and available samples in current and left CTU;

FIG. 13 illustrates example neighboring samples used for calculating SAD;

FIG. 14 illustrates example neighboring samples used for calculating SAD for sub-CU level motion information;

FIG. 15 illustrates an example diagram showing a sorting process;

FIG. 16 illustrates an example diagram illustrating a reorder process in an encoder;

FIG. 17 illustrates an example diagram illustrating a reorder process in a decoder;

FIG. 18 illustrates an example diagram illustrating template matching performs on a search area around initial MV;

FIG. 19 illustrates an example diagram showing the template matching prediction;

FIG. 20 illustrates an example diagram showing intra template matching search area used;

FIG. 21 illustrates an example diagram showing template and its reference samples used in TIMD;

FIG. 22 illustrates an example diagram showing template and reference samples of the template;

FIG. 23 illustrates an example diagram showing template and reference samples of the template in reference list 0 and reference list 1;

FIG. 24 illustrates an example diagram showing template and reference samples of the template for block with sub-block motion using the motion information of the subblocks of current block;

FIG. 25 illustrates an example diagram showing template and reference samples of the template for block with sub-block motion using the motion information of each sub-template;

FIG. 26 illustrates an example diagram showing template and reference samples of the template for block with OBMC;

FIG. 27 illustrates an example diagram showing motion estimation for rectangular block with hash values for square subblocks;

FIG. 28 illustrates example luma mapping with chroma scaling architecture;

FIG. 29 illustrates an example diagram showing MMVD search point;

FIG. 30 illustrates an example diagram showing an example of triangle partition based inter prediction;

FIG. 31 illustrates an example of uni-prediction MV selection for triangle partition mode;

FIG. 32 illustrates example weights used in the blending process;

FIGS. 33A-33C illustrate three MV storage areas for triangleDir equal to 0;

FIG. 34 illustrates examples of the GPM splits grouped by identical angles;

FIG. 35 illustrates an example of uni-prediction MV selection for geometric partitioning mode;

FIG. 36 illustrates an example of exemplified generation of a bending weight w_0 using geometric partitioning mode;

FIG. 37 illustrates an example of top and left neighboring blocks used in CIIP weight derivation;

FIGS. 38A-38B illustrates examples of candidate positions for spatial candidate and temporal candidate;

FIG. 39 illustrates an example of deriving sub-CU by motion field from the corresponding collocated sub-CUs by applying a motion shift from spatial neighbor;

FIG. 40 illustrates an example of intra template matching;

FIG. 41 illustrates an example of sub-blocks where OBMC applies;

FIGS. 42A-42B illustrate 4 parameter affine model and 6 parameter affine model for control point based affine motion model, respectively;

FIG. 43 illustrates an example of affine MVF per subblock;

FIG. 44 illustrates an example of locations of inherited affine motion predictors;

FIG. 45 illustrates an example of control point motion vector inheritance;

FIG. 46 illustrates an example of locations of candidates position for constructed affine merge mode;

FIG. 47 illustrates an example of motion vector usage for proposed combined method;

FIG. 48 illustrates an example of subblock MV VSB and pixel Δv(i,j)(with arrow 4810);

FIG. 49 illustrates an example of the adjacent spatial neighboring blocks used in accordance with some embodiments of the present disclosure;

FIG. 50 illustrates an example of top and left neighboring blocks used in CIIP_N1 and CIIP_N2 weight derivation in accordance with some embodiments of the present disclosure;

FIG. 51 illustrates an example of triangle partition based IBC prediction in accordance with some embodiments of the present disclosure;

FIGS. 52A-52B illustrate two example search patterns in accordance with some embodiments of the present disclosure;

FIG. 53 illustrates a flowchart of a method for video processing in accordance with some embodiments of the present disclosure;

FIG. 54 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

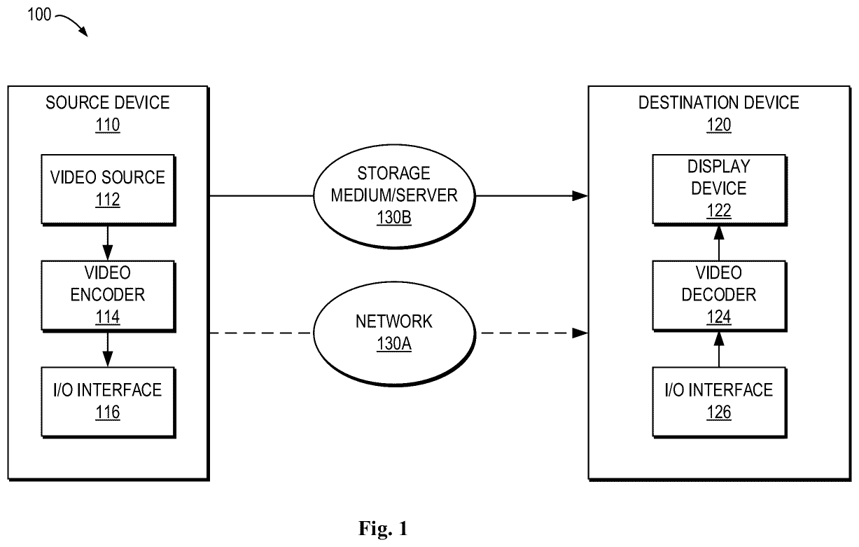

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

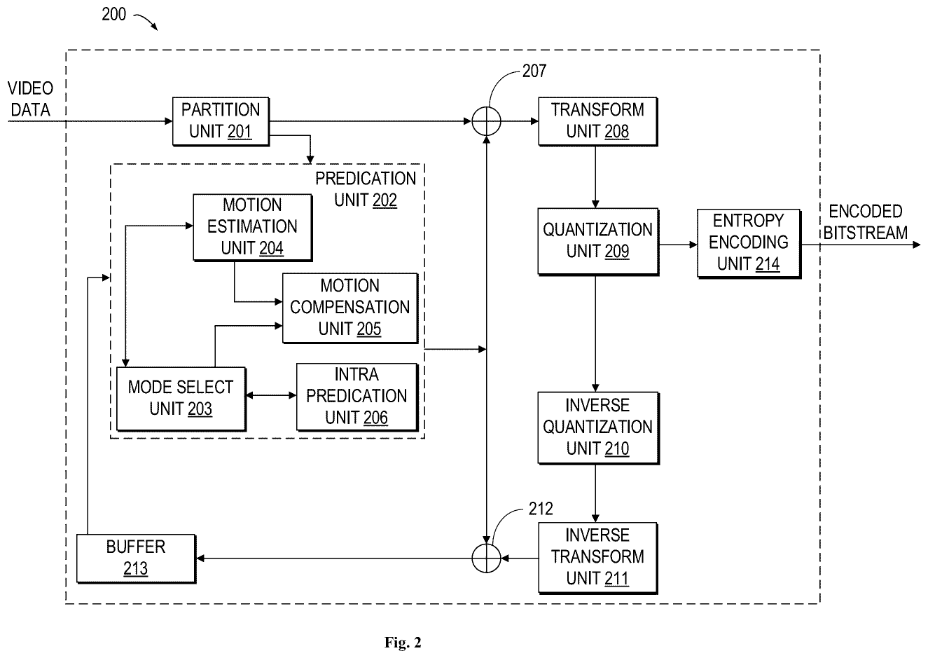

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

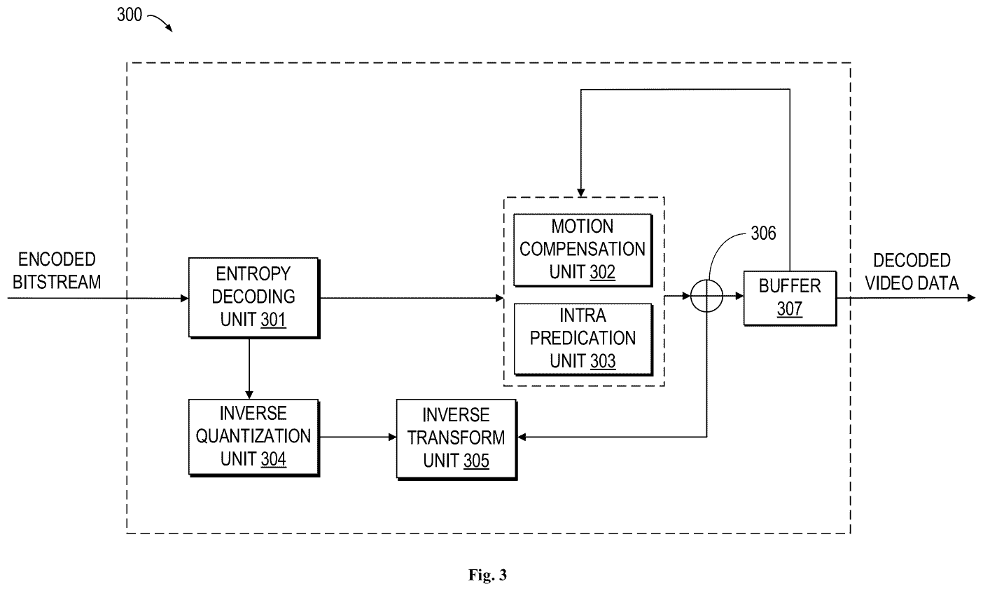

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

This disclosure is related to video coding technologies. Specifically, it is about IBC prediction and related techniques in video coding. It may be applied to the existing video coding standard like HEVC, VVC, etc. It may be also applicable to future video coding standards or video codec.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1. Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.1 Spatial Candidates Derivation

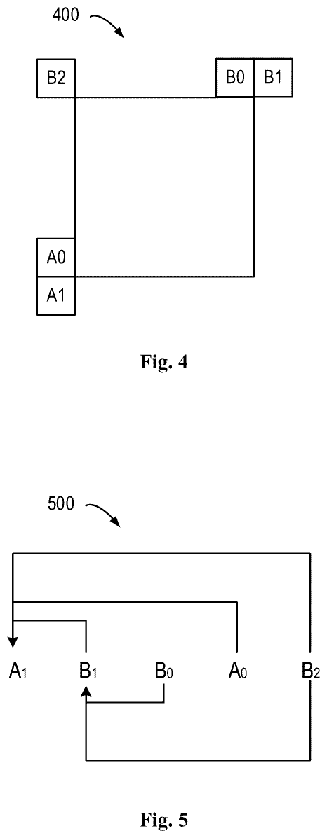

FIG. 4 illustrates an example diagram 400 illustrating example positions of spatial merge candidate. The derivation of spatial merge candidates in VVC is same to that in HEVC except the positions of first two merge candidates are swapped. A maximum of four merge candidates are selected among candidates located in the positions depicted in FIG. 4. The order of derivation is B₁, A₁, B₀, A₀, and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 5 illustrates an example diagram 500 illustrating candidate pairs considered for redundancy check of spatial merge candidates. Instead only the pairs linked with an arrow in FIG. 5 are considered and a candidate is only added to the list if the corresponding candidate used for redundancy check has not the same motion information.

### 2.1.2 Temporal Candidates Derivation

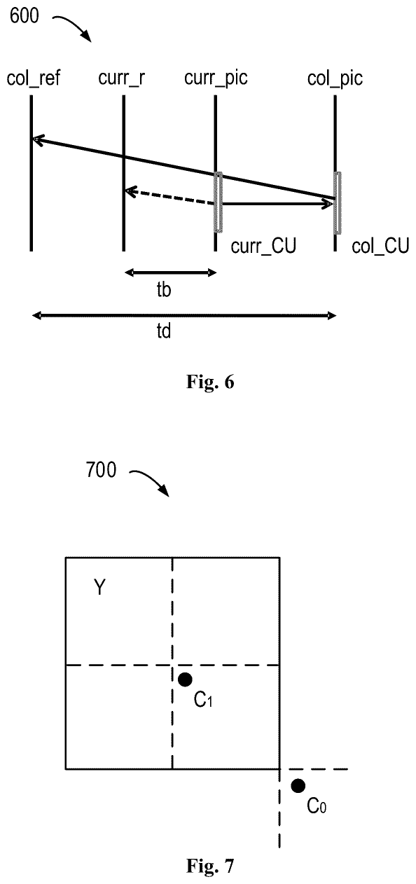

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. FIG. 6 illustrates an example motion vector scaling 600 for temporal merge candidate. The scaled motion vector for temporal merge candidate is obtained as illustrated by the dotted line in FIG. 6, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

FIG. 7 illustrates an example diagram 700 illustrating candidate positions for temporal merge candidate, C₀ and C₁. The position for the temporal candidate is selected between candidates C₀ and C₁, as depicted in FIG. 7. If CU at position C₀ is not available, is intra coded, or is outside of the current row of CTUs, position C₁ is used. Otherwise, position C₀ is used in the derivation of the temporal merge candidate.

### 2.1.3 History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward,

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. Number of HMPV candidates is used for merge list generation is set as (N<=4) ? M: (8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

### 2.1.4 Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid. When the merge list is not full after pair-wise average merge candidates are added, the zero MVPs are inserted in the end until the maximum merge candidate number is encountered.

### 2.2. New Merge Candidates

2.2.1 Non-adjacent merge candidates derivation

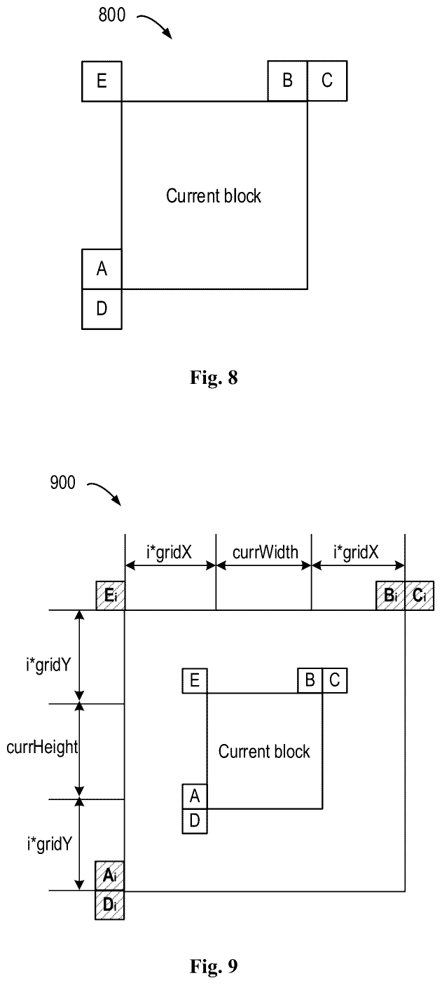

FIG. 8 illustrates an example diagram 800 illustrating VVC spatial neighboring blocks of the current block. In VVC, five spatially neighboring blocks shown in FIG. 8 as well as one temporal neighbor are used to derive merge candidates.

It is proposed to derive the additional merge candidates from the positions non-adjacent to the current block using the same pattern as that in VVC. To achieve this, for each search round i, a virtual block is generated based on the current block as follows:

First, the relative position of the virtual block to the current block is calculated by:

$$Offsetx = - i \times gridX ,$$

$$Offsety = - i \times gridY$$

where the Offsetx and Offsety denote the offset of the top-left corner of the virtual block relative to the top-left corner of the current block, gridX and gridY are the width and height of the search grid.

Second, the width and height of the virtual block are calculated by:

$$newWidth = i \times 2 \times gridX + currWidth$$

$$newHeight = i \times 2 \times gridY + currHeight .$$

where the currWidth and currHeight are the width and height of current block. The newWidth and newHeight are the width and height of new virtual block.
gridX and gridY are currently set to currWidth and currHeight, respectively.

FIG. 9 illustrates an example diagram 900 showing the relationship between the virtual block and the current block. FIG. 9 also illustrates virtual block in the ith search round.

After generating the virtual block, the blocks A₁, B₁, C₁, D₁ and E₁ can be regarded as the VVC spatial neighboring blocks of the virtual block and their positions are obtained with the same pattern as that in VVC. Obviously, the virtual block is the current block if the search round i is 0. In this case, the blocks A₁, B₁, C₁, D₁ and E₁ are the spatially neighboring blocks that are used in VVC merge mode. When constructing the merge candidate list, the pruning is performed to guarantee each element in merge candidate list to be unique. The maximum search round is set to 1, which means that five non-adjacent spatial neighbor blocks are utilized.

Non-adjacent spatial merge candidates are inserted into the merge list after the temporal merge candidate in the order of B₁−>A₁->C₁−>D₁->E₁.

### 2.2.2 Non-Adjacent Spatial Candidate

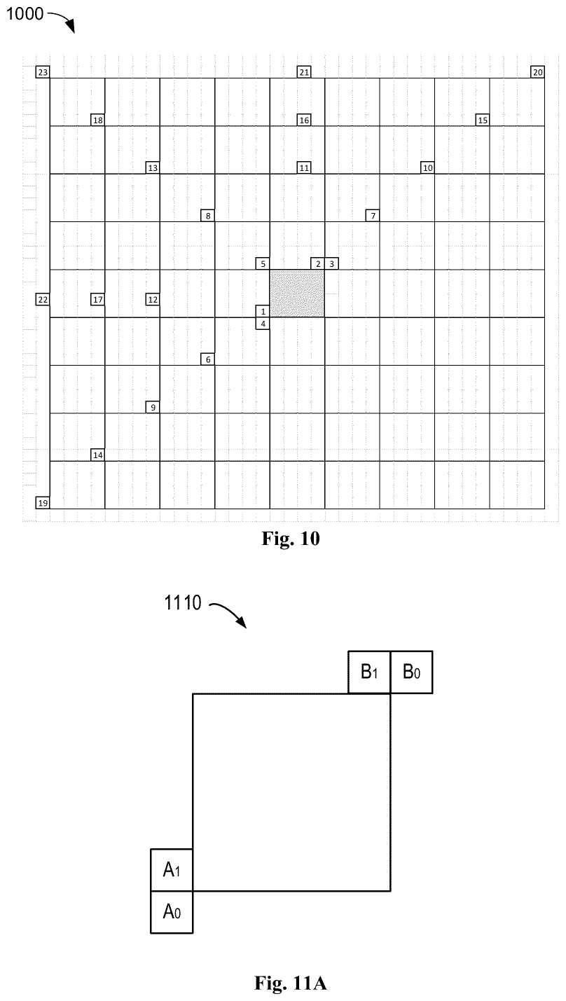

FIG. 10 illustrates an example diagram 1000 illustrating spatial neighboring blocks used to derive the spatial merge candidates. The non-adjacent spatial merge candidates are inserted after the TMVP in the regular merge candidate list. The pattern of spatial merge candidates is shown in FIG. 10. The distances between non-adjacent spatial candidates and current coding block are based on the width and height of current coding block. The line buffer restriction is not applied.

### 2.2.3 Stmvp

It is proposed to derive an averaging candidate as STMVP candidate using three spatial merge candidates and one temporal merge candidate.

STMVP is inserted before the above-left spatial merge candidate.

The STMVP candidate is pruned with all the previous merge candidates in the merge list.

For the spatial candidates, the first three candidates in the current merge candidate list are used.

For the temporal candidate, the same position as VTM/HEVC collocated position is used.

For the spatial candidates, the first, second, and third candidates inserted in the current merge candidate list before STMVP are denoted as F, S, and T.

The temporal candidate with the same position as VTM/HEVC collocated position used in TMVP is denoted as Col.

The motion vector of the STMVP candidate in prediction direction X (denoted as mvLX) is derived as follows:
1) If the reference indices of the four merge candidates are all valid and are all equal to zero in prediction direction X (X=0 or 1),

$$\\ mvLX = ( mvLX\_F + mvLX\_S + mvLX\_T + mvLX\_Col ) >> 2$$

2) If reference indices of three of the four merge candidates are valid and are equal to zero in prediction direction X (X=0 or 1),

$$\\ mvLX = ( mvLX\_F \times 3 + mvLX\_S \times 3 + mvLX\_Col \times 2 ) >> 3 or$$

$$\\ mvLX = ( mvLX\_F \times 3 + mvLX\_T \times 3 + mvLX\_Col \times 2 ) >> 3 or$$

$$\\ mvLX = ( mvLX\_S \times 3 + mvLX\_T \times 3 + mvLX\_Col \times 2 ) >> 3$$

3) If reference indices of two of the four merge candidates are valid and are equal to zero in prediction direction X (X=0 or 1),

$$\\ mvLX = ( mvLX\_F + mvLX\_Col ) >> 1 or$$

$$\\ mvLX = ( mvLX\_S + mvLX\_Col ) >> 1 or$$

$$\\ mvLX = ( mvLX\_T + mvLX\_Col ) >> 1$$

Note: If the temporal candidate is unavailable, the STMVP mode is off.

### 2.2.4 Merge List Size

If considering both non-adjacent and STMVP merge candidates, the size of merge list is signalled in sequence parameter set header and the maximum allowed size of merge list is increased (e.g. 8).

### 2.3. Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTMVP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

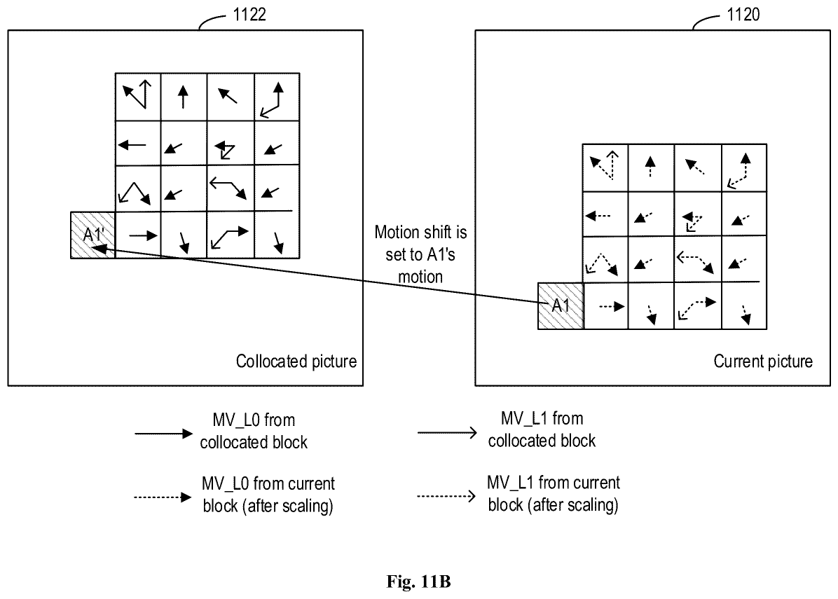

FIG. 11A and FIG. 11B illustrate the SbTMVP process in VVC. FIG. 11A illustrates an example diagram 1110 illustrating patial neighboring blocks used by SbTMVP. SbTMVP predicts the motion vectors of the sub-CUs within the current CU in two steps. In the first step, the spatial neighbor A1 in FIG. 11A is examined. If A 1 has a motion vector that uses the collocated picture as its reference picture, this motion vector is selected to be the motion shift to be applied. If no such motion is identified, then the motion shift is set to (0, 0).

FIG. 11B illustrates deriving sub-CU motion field of the current picture 1120 by applying a motion shift from spatial neighbor and scaling the motion information from the corresponding collocated sub-CUs of the collocated picture 1122. In the second step, the motion shift identified in Step 1 is applied (i.e. added to the current block's coordinates) to obtain sub-CU-level motion information (motion vectors and reference indices) from the collocated picture as shown in FIG. 11B. The example in FIG. 11B assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTMVP candidate and affine merge candidates is used for the signalling of subblock based merge mode. The SbTMVP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in P or B slice, an additional RD check is performed to decide whether to use the SbTMVP candidate.

### 2.4. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.4.1 Simplification of IBC Vector Prediction

The BV predictors for merge mode and AMVP mode in IBC will share a common predictor list, which consist of the following elements:
2 spatial neighboring positions (A0, B0 as in FIG. 4)
5 HMVP entries
Zero vectors by default

For merge mode, up to first 6 entries of this list will be used; for AMVP mode, the first 2 entries of this list will be used. And the list conforms with the shared merge list region requirement (shared the same list within the SMR).

### 2.4.2 IBC Reference Region

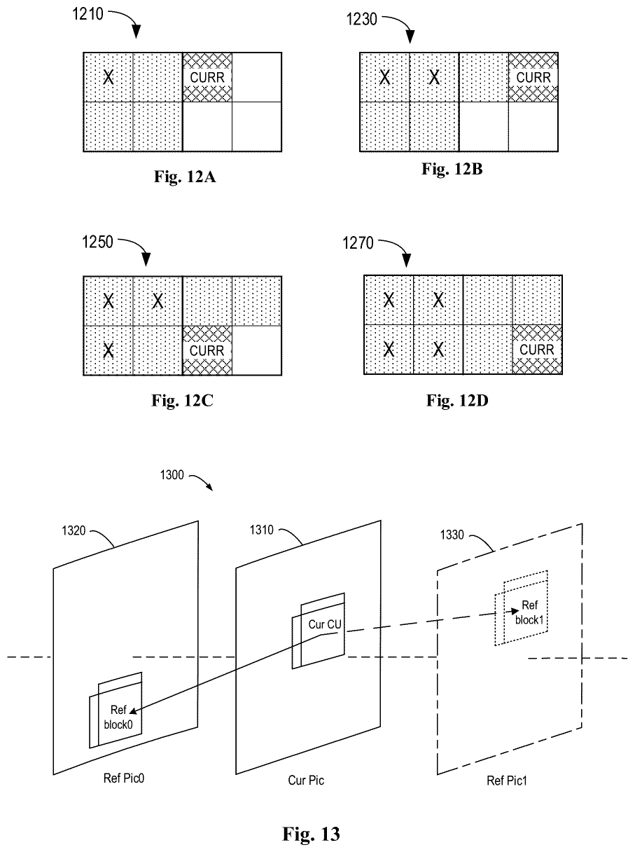

To reduce memory consumption and decoder complexity, the IBC in VVC allows only the reconstructed portion of the predefined area including the region of current CTU and some region of the left CTU. FIGS. 12A-12D illustrate example diagrams illustrating current CTU processing order and available samples in current and left CTU. As an example, FIGS. 12A-12D illustrate the reference region of IBC Mode, where each block represents 64×64 luma sample unit.

Depending on the location of the current coding CU location within the current CTU, the following applies:
As shown in the diagram 1210 of FIG. 12A, if current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
As shown in the diagram 1230 of FIG. 12B, if current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
As shown in the diagram 1250 of FIG. 12C, if current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
As shown in the diagram 1270 of FIG. 12D, if current block falls into the bottom-right 64×64 block of the current CTU, it can only refer to the already reconstructed samples in the current CTU, using CPR mode.

This restriction allows the IBC mode to be implemented using local on-chip memory for hardware implementations.

2.4.3 IBC Interaction with Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitstream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min(ctbSize, 64) in each dimension, Wᵥ=min(ctbSize, 64).

The virtual IBC buffer, ibcBuf is maintained as follows.
At the beginning of decoding each CTU row, refresh the whole ibcBuf with an invalid value −1.
At the beginning of decoding a VPDU (xVPDU, yVPDU) relative to the top-left corner of the picture, set the ibcBuf[x][y]−1, with x=xVPDU % wIbcBuf, . . . , xVPDU % wIbcBuf+Wᵥ−1; y=yVPDU % ctbSize, . . . , yVPDU % ctbSize+Wᵥ−1.
After decoding a CU contains (x, y) relative to the top-left corner of the picture, set
   ibcBuf[x % wIbcBuf][y % ctbSize]=recSample[x][y]

For a block covering the coordinates (x, y), if the following is true for a block vector by =(bv[0], bv[1]), then it is valid; otherwise, it is not valid:

$$\\ ibcBuf [ ( x + bv [ 0 ] ) \% wIbcBuf ] [ ( y + bv [ 1 ] ) \% ctbSize ]$$

$$\\ shall not be equal to - 1.$$

### 2.4.4 IBC Virtual Buffer Test

A luma block vector bvL (the luma block vector in, 1/16 fractional-sample accuracy) shall obey the following constraints:
CtbSizeY is greater than or equal to ((yCb+(bvL[1]>>4)) & (CtbSizeY−1))+cbHeight.
IbcVirBuf[0][(x+(bvL[0]>>4))&(IbcBufWidthY−1)][(y+(bvL[1]>>4))&(CtbSizeY−1)] shall not be equal to −1 for x=xCb..xCb+cbWidth−1 and y=yCb..yCb+cbHeight−1.

Otherwise, bvL is considered as an invalid by.

The samples are processed in units of CTBs. The array size for each luma CTB in both width and height is CtbSizeY in units of samples.
(xCb, yCb) is a luma location of the top-left sample of the current luma coding block relative to the top-left luma sample of the current picture,
cbWidth specifies the width of the current coding block in luma samples,
cbHeight specifies the height of the current coding block in luma samples.

### 2.5. Template Matching Based Adaptive Merge Candidate Reorder

To improve the coding efficiency, after the merge candidate list is constructed, the order of each merge candidate is adjusted according to the template matching cost. The merge candidates are arranged in the list in accordance with the template matching cost of ascending order. It is operated in the form of sub-group.

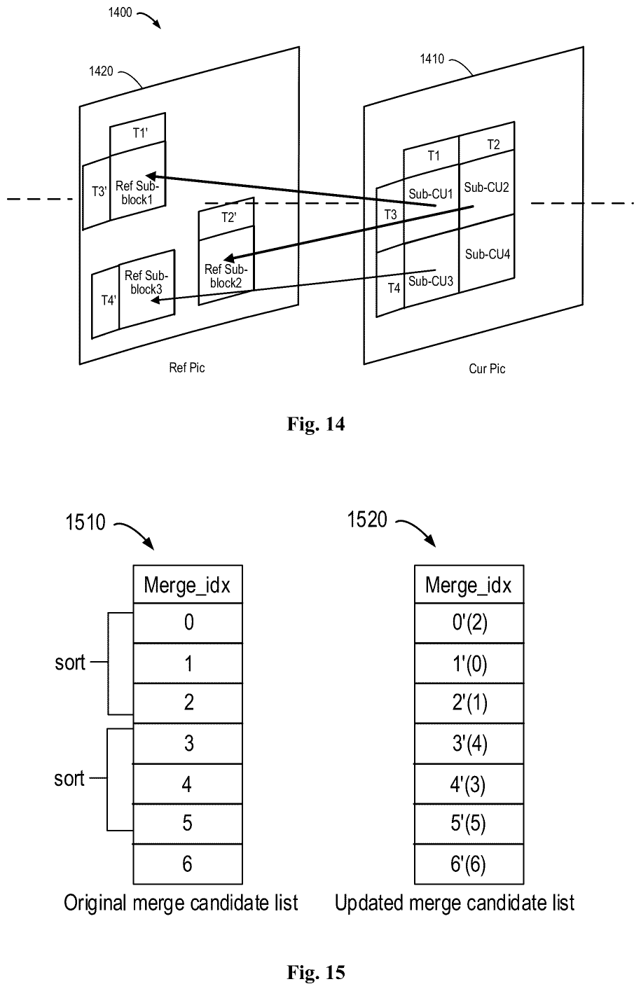

FIG. 13 illustrates an example diagram 1300 showing neighboring samples used for calculating SAD. The template matching cost is measured by the SAD (Sum of absolute differences) between the neighbouring samples of the current CU of the current picture 1310 and their corresponding reference samples. If a merge candidate includes bi-predictive motion information, the corresponding reference samples are the average of the corresponding reference samples in reference list0 1320 and the corresponding reference samples in reference list1 1330, as illustrated in FIG. 13. FIG. 14 illustrates an example diagram 1400 showing neighboring samples used for calculating SAD for sub-CU level motion information. If a merge candidate includes sub-CU level motion information of the current picture 1410, the corresponding reference samples consist of the neighbouring samples of the corresponding reference sub-blocks in the reference picture 1420, as illustrated in FIG. 14.

FIG. 15 illustrates a sorting process sorting an original merge candidate list 1510 into an updated merge candidate list 1520. The sorting process is operated in the form of sub-group, as illustrated in FIG. 15. The first three merge candidates are sorted together. The following three merge candidates are sorted together.

The template size (width of the left template or height of the above template) is 1. The sub-group size is 3.

### 2.6. Adaptive Merge Candidate List

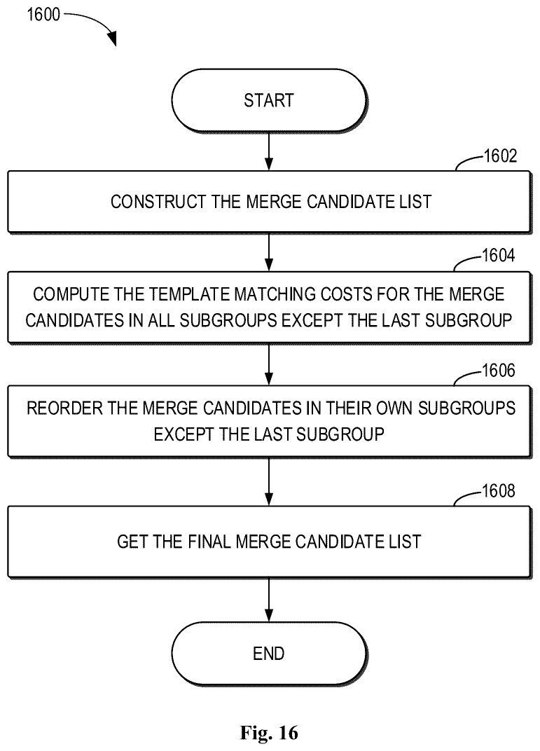

We can assume the number of the merge candidates is 8. We take the first 5 merge candidates as a first subgroup and take the following 3 merge candidates as a second subgroup (i.e. the last subgroup). FIG. 16 illustrates an example diagram 1600 illustrating a reorder process in an encoder. For the encoder, after the merge candidate list is constructed at block 1602, some merge candidates are adaptively reordered in an ascending order of costs of merge candidates as shown in FIG. 16.

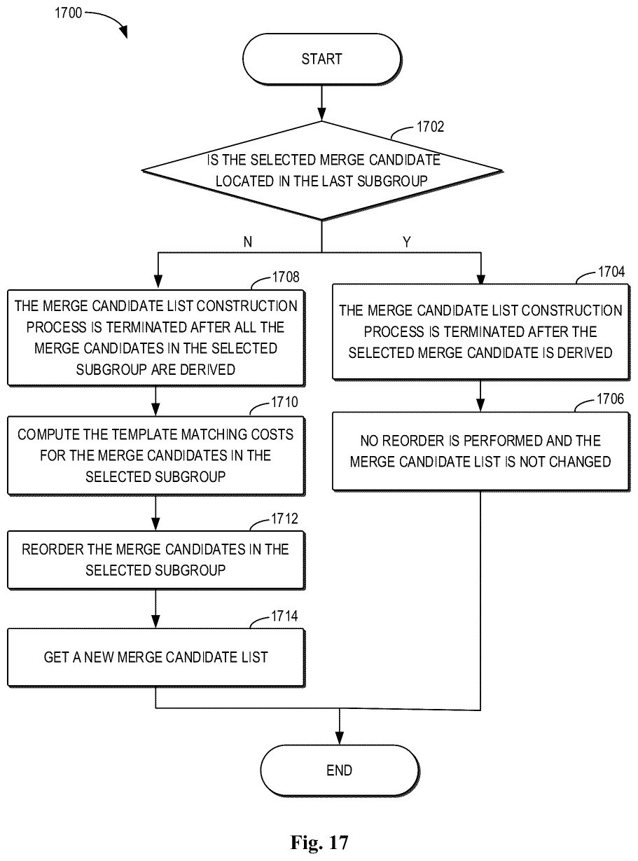

More specifically, the template matching costs for the merge candidates in all subgroups except the last subgroup are computed at block 1604; then reorder the merge candidates in their own subgroups except the last subgroup at block 1606; finally, the final merge candidate list will be got at block 1608. FIG. 17 illustrates an example diagram 1700 illustrating a reorder process in a decoder. For the decoder, after the merge candidate list is constructed, some/no merge candidates are adaptively reordered in ascending order of costs of merge candidates as shown in FIG. 17. In FIG. 17, the subgroup the selected (signaled) merge candidate located in is called the selected subgroup.

More specifically, if the selected merge candidate is located in the last subgroup at block 1702, the merge candidate list construction process is terminated after the selected merge candidate is derived at block 1704, no reorder is performed and the merge candidate list is not changed at block 1706; otherwise, the execution process is as follows:

The merge candidate list construction process is terminated after all the merge candidates in the selected subgroup are derived at block 1708; compute the template matching costs for the merge candidates in the selected subgroup at block 1710; reorder the merge candidates in the selected subgroup at block 1712; finally, a new merge candidate list will be got at block 1714.

For both encoder and decoder,

A template matching cost is derived as a function of T and RT, wherein T is a set of samples in the template and RT is a set of reference samples for the template.

When deriving the reference samples of the template for a merge candidate, the motion vectors of the merge candidate are rounded to the integer pixel accuracy. It can also be derived using 8 tap or 12 tap luma interpolation filter.

The reference samples of the template (RT) for bi-directional prediction are derived by weighted averaging of the reference samples of the template in reference list0 (RT₀) and the reference samples of the template in reference list1 (RiT₁) as follows.

$$\\ RT = ( ( 8 - w ) * {RT}_{0} + w * {RT}_{1} + 4 ) ≫ 3$$

where the weight of the reference template in reference list0 (8-w) and the weight of the reference template in reference list1 (w) are decided by the BCW index of the merge candidate. BCW index equal to {0, 1, 2, 3, 4} corresponds to w equal to {-2,3,4,5,10}, respectively.

If the Local Illumination Compensation (LIC) flag of the merge candidate is true, the reference samples of the template are derived with LIC method.

The template matching cost is calculated based on the sum of absolute differences (SAD) of T and RT.

The template size is 1. That means the width of the left template and/or the height of the above template is 1.

If the coding mode is MMVD, the merge candidates to derive the base merge candidates are not reordered.

If the coding mode is GPM, the merge candidates to derive the uni-prediction candidate list are not reordered.

### 2.7. Template Matching (TM)

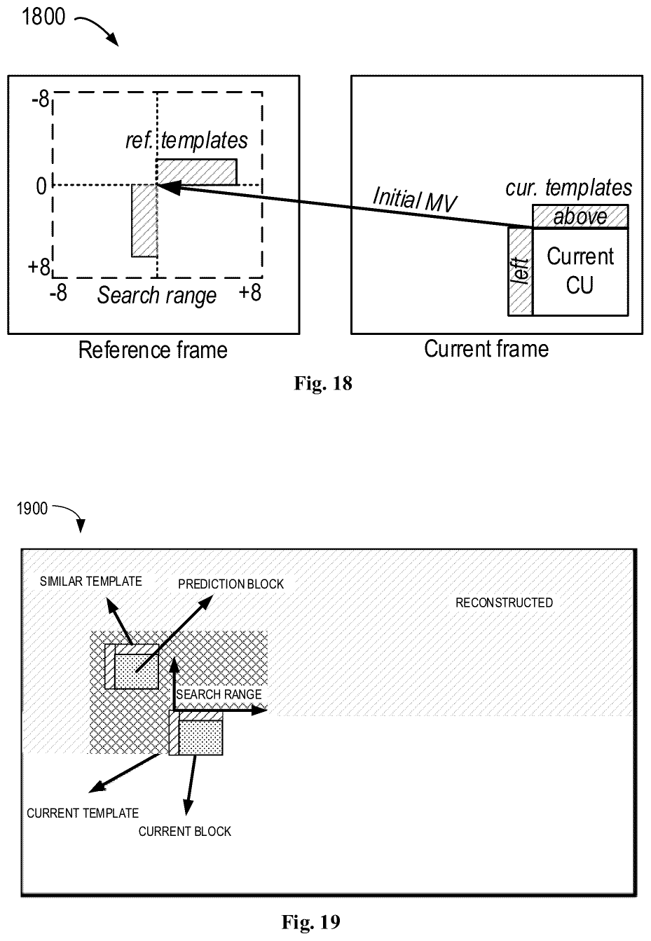

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. FIG. 18 illustrates an example diagram 1800 illustrating template matching performs on a search area around initial MV. As illustrated in FIG. 18, a better MV is to be searched around the initial motion of the current CU within a [−8, +8]-pel search range. The template matching is adopted in this contribution with two modifications: search step size is determined based on AMVR mode and TM can be cascaded with bilateral matching process in merge modes.

In AMVP mode, an MVP candidate is determined based on template matching error to pick up the one which reaches the minimum difference between current block template and reference block template, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by AMVR mode after TM process.

TABLE 1
Search patterns of AMVR and merge mode with AMVR.

| | AMVR mode | | | | Merge mode | |
|---|---|---|---|---|---|---|
| | 4- | Full- | Half- | Quarter- | AltIF = | AltIF = |
| Search pattern | pel | pel | pel | pel | 0 | 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, similar search method is applied to the merge candidate indicated by the merge index. As Table 1 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

At encoder side, TM merge mode will do MV refinement for each merge candidate.

### 2.8. Intra Template Matching for IBC (TM_IBC)

Template matching prediction (TMP) is a special intra prediction mode that copies the best prediction block from the reconstructed part of the current frame, whose L-shaped templated matches the current template. FIG. 19 illustrates an example diagram 1900 showing the template matching prediction. For a predefined search range, the encoder searches for the most similar template to the current template in the reconstructed part of the current frame, and uses the corresponding block as a prediction block. The encoder then signals the usage of this mode, and the inverse operation is made at the decoder side.

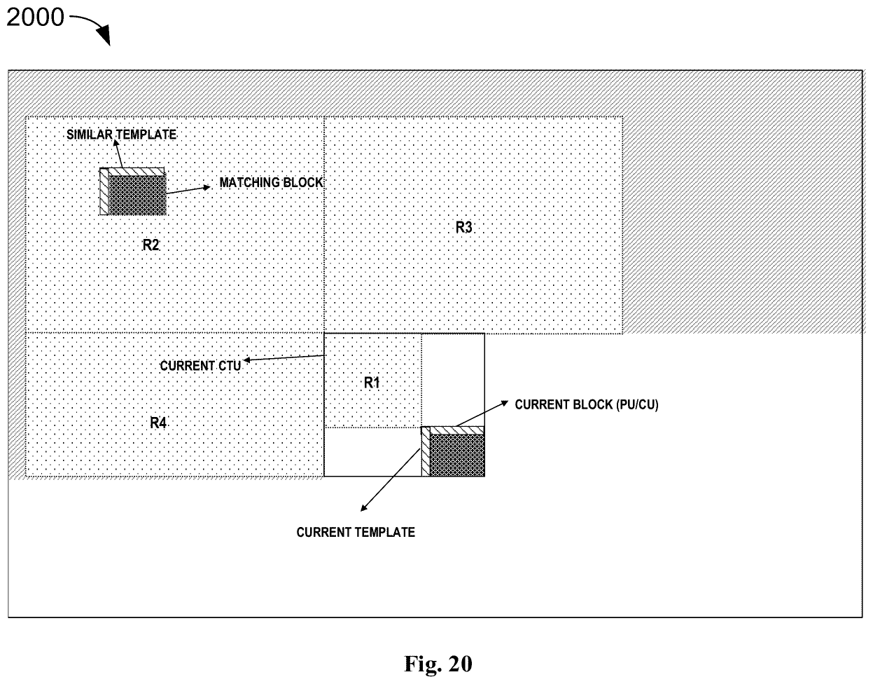

It is a coding tool that is mostly adapted for screen content coding. The prediction signal is generated at the decoder side by matching the L-shaped causal neighbor of the current block with another block in a predefined search area. This is illustrated in FIG. 20. FIG. 20 illustrates an example diagram 2000 showing intra template matching search area used. Specifically, the search range is divided into 3 regions:
R1: within the current CTU
R2: top-left outside the current CTU
R3: above the current CTU
R4: left to the current CTU

Within each region, the decoder searches for the template the has least SAD with respect to the current one and uses its corresponding block as a prediction block.

The dimensions of all regions (SearchRange_w, SearchRange_h) are set proportional to the block dimension (BlkW, BlkH) in order to have a fixed number of SAD comparisons per pixel. That is:

$$\\ SearchRange\_w = a * BlkW$$

$$\\ SearchRange\_h = a * BlkH$$

Where ‘α’ is a constant that controls the gain/complexity trade-off.

### 2.9. Template-Based Intra Mode Derivation Using MPMs

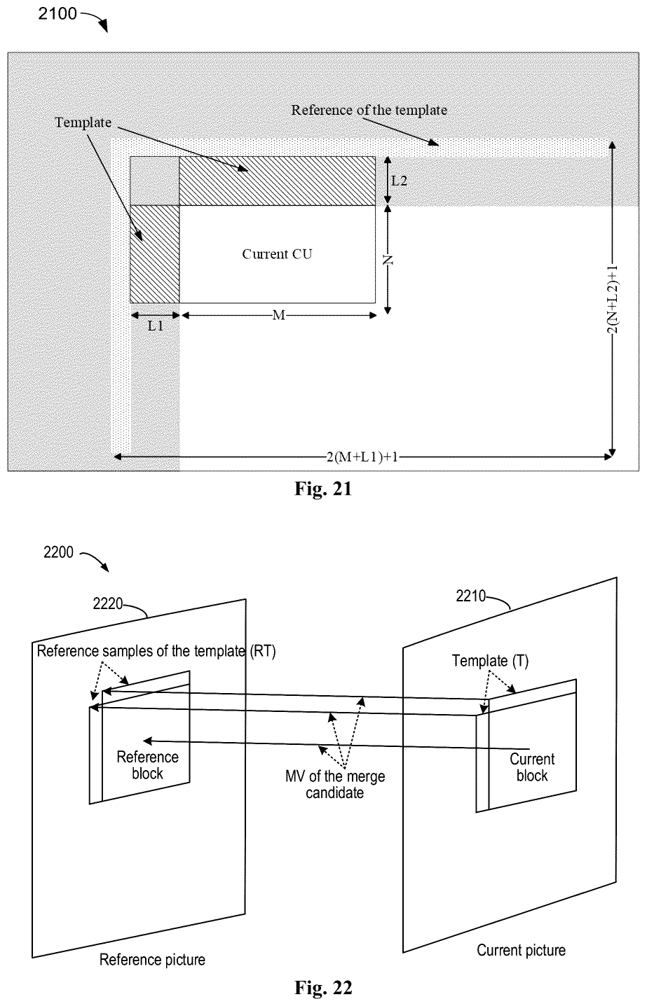

A TIMD mode is derived from MPMs using the neighbouring template. The TIMD mode is used as an additional intra prediction method for a CU. FIG. 21 illustrates an example diagram 2100 showing template and its reference samples used in TIMD. As shown in FIG. 21, the prediction samples of the template are generated using the reference samples of the template for each candidate mode. A cost is calculated as the sum of absolute transformed differences (SATD) between the prediction and the reconstruction samples of the template. The intra prediction mode with the minimum cost is selected as the TIMD mode and used for intra prediction of the CU.

### 2.9.1 TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) and gradient PDPC are supported in the derivation of the TIMD mode.

### 2.9.2 TIMD Signalling

A flag is signalled in sequence parameter set (SPS) to enable/disable TIMD. When the flag is true, a CU level flag is signalled to indicate whether TIMD is used for the CU. The TIMD flag is signalled right after the MIP flag. If the TIMD flag is equal to true, the remaining syntax elements related to luma intra prediction mode, is skipped.

2.9.3 Interaction with New Coding Tools in ECM-1.0

When DIMD flag or MIP flag is equal to true, the TIMD flag is not signalled and set equal to false.

TIMD is allowed to be combined with ISP and MRL. When TIMD is combined with ISP or MRL and the TIMD flag is equal to true, the derived TIMD mode is used as the intra prediction mode for ISP or MRL.

When the secondary MPM is enabled, both the primary MPMs and the secondary MPMs are used to derive the TIMD mode.

6-tap interpolation filter is not used in the derivation of the TIMD mode.

### 2.9.4 Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list.

### 2.10. Adaptive Merge Candidate List

Hereinafter, template is a set of reconstructed samples adjacently or non-adjacently neighboring to the current block. Reference samples of the template are derived according to the same motion information of the current block. For example, reference samples of the template are mapping of the template depend on a motion information. In this case, reference samples of the template are located by a motion vector of the motion information in a reference picture indicated by the reference index of the motion information. FIG. 22 illustrates an example diagram 2200 showing template and reference samples of the template, wherein RT represents the reference samples in a reference picture 2220 of the template T in a current picture 2210.

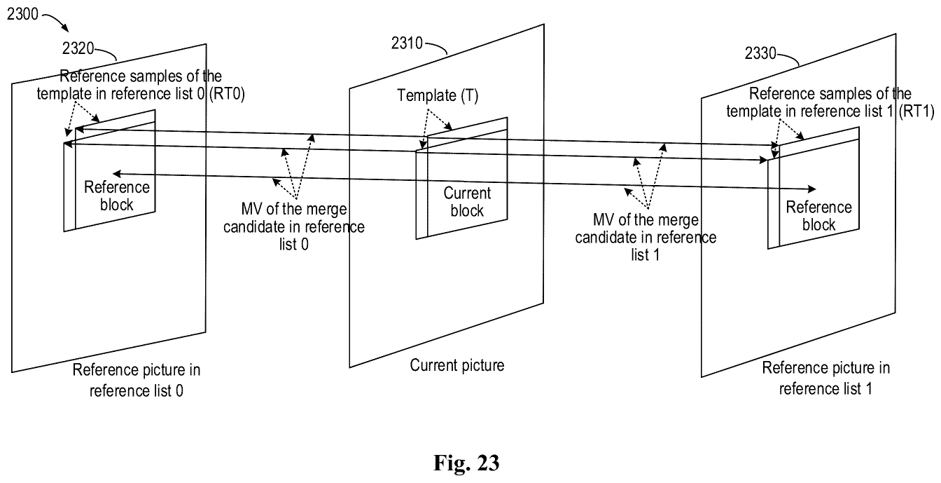

When a merge candidate utilizes bi-directional prediction, the reference samples of the template of the merge candidate are denoted by RT and RT may be generated from RT₀ which are derived from a reference picture in reference picture list 0 and RT₁ derived from a reference picture in reference picture list 1. In one example, RT₀ includes a set of reference samples on the reference picture of the current block indicated by the reference index of the merge candidate referring to a reference picture in reference list 0 with the MV of the merge candidate referring to reference list 0), In one example, RiT₁ includes a set of reference samples on the reference picture of the current block indicated by the reference index of the merge candidate referring to a reference picture in reference list 1 with the MV of the merge candidate referring to reference list 1). FIG. 23 illustrates an example diagram 2300 showing template in a current picture 2310 and reference samples of the template in reference list 0 2320 and reference list 12330.

In one example, the reference samples of the template (RT) for bi-directional prediction are derived by equal weighted averaging of the reference samples of the template in reference list0 (RT₀) and the reference samples of the template in reference list1 (RiT₁). One example is as follows:

$$\\ RT = ( {RT}_{0} + {RT}_{1} + 1 ) ≫ 1$$

In one example, the reference samples of the template (RT_{bi-pred}) for bi-directional prediction are derived by weighted averaging of the reference samples of the template in reference list0 (RT₀) and the reference samples of the template in reference list1 (RiT₁). One example is as follows:

$$\\ RT = ( ( {2}^{{}_{} N} - w ) * {RT}_{0} + w * {RT}_{1} + {2}^{{}_{} N - 1} ) ≫ N ,$$

In one example, the weight of the reference template in reference list0 such as (8−w) and the weight of the reference template in reference list1 such as (w) maybe decided by the BCW index of the merge candidate.

The merge candidates can be divided to several groups according to some criterions. Each group is called a subgroup. For example, we can take adjacent spatial and temporal merge candidates as a first subgroup and take the remaining merge candidates as a second subgroup; In another example, we can also take the first N (N>2) merge candidates as a first subgroup, take the following M (M>2) merge candidates as a second subgroup, and take the remaining merge candidates as a third subgroup. Note that the proposed methods may be applied to merge candidate list construction process for inter coded blocks (e.g., translational motion), affine coded blocks; or other motion candidate list construction process (e.g., AMVP list; IBC AMVP list; IBC merge list).

W and H are the width and height of current block (e.g., luma block). Taking merge candidate list construction process as an example in the following descriptions:

1. The merge candidates can be adaptively rearranged in the final merge candidate list according to one or some criterions.
a. In one example, partial or full process of current merge candidate list construction process is firstly invoked, followed by the reordering of candidates in the list.
   i. Alternatively, candidates in a first subgroup may be reordered and they should be added before those candidates in a second subgroup wherein the first subgroup is added before the second subgroup.
      (i) In one example, multiple merge candidates for a first category may be firstly derived and then reordered within the first category; then merge candidates from a second category may be determined according to the reordered candidates in the first category (e.g., how to apply pruning).
   ii. Alternatively, a first merge candidate in a first category may be compared to a second merge candidate in a second category, to decide the order of the first or second merge candidate in the final merge candidate list.
b. In one example, the merge candidates may be adaptively rearranged before retrieving the merge candidates.
   i. In one example, the procedure of arranging merge candidates adaptively may be processed before the obtaining the merge candidate to be used in the motion compensation process.
c. In one example, if the width of current block is larger than the height of current block, the above candidate is added before the left candidate.
d. In one example, if the width of current block is smaller than the height of current block, the above candidate is added after the left candidate.
e. Whether merge candidates are rearranged adaptively may depend on the selected merging candidate or the selected merging candidate index.
   i. In one example, if the selected merging candidate is in the last sub-group, the merge candidates are not rearranged adaptively.
f. In one example, a merge candidate is assigned with a cost, the merge candidates are adaptively reordered in an ascending order of costs of merge candidates.
   i. In one example, the cost of a merge candidate may be a template matching cost.
   ii. In one example, template is a set of reconstructed samples adjacently or non-adjacently neighboring to the current block.
   iii. A template matching cost is derived as a function of T and RT, wherein T is a set of samples in the template and RT is a set of reference samples for the template.
      (i) How to obtain the reference samples of the template for a merge candidate may depend on the motion information of the merge candidate.
         a) In one example, when deriving the reference samples of the template, the motion vectors of the merge candidate are rounded to the integer pixel accuracy, where the integer motion vector may be its nearest integer motion vector.
         b) In one example, when deriving the reference samples of the template, N-tap interpolation filtering is used to get the reference samples of the template at sub-pixel positions. For example, N may be 2, 4, 6, or 8.
         c) In one example, when deriving the reference samples of the template, the motion vectors of the merge candidates may be scaled to a given reference picture (e.g., for each reference picture list if available).
         d) For example, the reference samples of the template of a merge candidate are obtained on the reference picture of the current block indicated by the reference index of the merge candidate with the MVs or modified MVs (e.g., according to bullets a)-b)) of the merge candidate as shown in FIG. 22.
         e) For example, when a merge candidate utilizes bi-directional prediction, the reference samples of the template of the merge candidate are denoted by RT and RT may be generated from RT₀ which are derived from a reference picture in reference picture list 0 and RiT₁ derived from a reference picture in reference picture list 1.
         [1] In one example, RTₒ includes a set of reference samples on the reference picture of the current block indicated by the reference index of the merge candidate referring to a reference picture in reference list 0 with the MV of the merge candidate referring to reference list 0),
         [2] In one example, RiT₁ includes a set of reference samples on the reference picture of the current block indicated by the reference index of the merge candidate referring to a reference picture in reference list 1 with the MV of the merge candidate referring to reference list 1).
         [3] An example is shown in FIG. 23.
         f) In one example, the reference samples of the template (RT) for bi-directional prediction are derived by equal weighted averaging of the reference samples of the template in reference list0 (RT₀) and the reference samples of the template in reference list1 (RiT₁). One example is as follows:

$$\\ RT = ( {RT}_{0} + {RT}_{1} + 1 ) ≫ 1$$

g) In one example, the reference samples of the template (RT_{bi-pred}) for bi-directional prediction are derived by weighted averaging of the reference samples of the template in reference list0 (RT₀) and the reference samples of the template in reference list1 (RiT₁).

One example is as follows:

$$\\ RT = ( ( {2}^{{}_{} N} - w ) * {RT}_{0} + w * {RT}_{1} + {2}^{{}_{} N - 1} ) ≫ N ,$$

h) h) In one example, the weight of the reference template in reference list0 such as (8-w) and the weight of the reference template in reference list1 such as (w) maybe decided by the BCW index of the merge candidate.
   [1] In one example, BCW index is equal to 0, w is set equal to −2.
   [2] In one example, BCW index is equal to 1, w is set equal to 3.
   [3] In one example, BCW index is equal to 2, w is set equal to 4.
   [4] In one example, BCW index is equal to 3, w is set equal to 5.
   [5] In one example, BCW index is equal to 4, w is set equal to 10
   i) In one example, if the Local Illumination Compensation (LIC) flag of the merge candidate is true, the reference samples of the template are derived with LIC method.
(ii) The cost may be calculated based on the sum of absolute differences (SAD) of T and RT.
   a) Alternatively, the cost may be calculated based on the sum of absolute transformed differences (SATD) of T and RT.
   b) Alternatively, the cost may be calculated based on the sum of squared differences (SSD) of T and RT.
   c) Alternatively, the cost may be calculated based on weighted SAD/weighted SATD/weighted SSD.
(iii) The cost may consider the continuity (Boundary_SAD) between RT and reconstructed samples adjacently or non-adjacently neighboring to T in addition to the SAD calculated in (ii). For example, reconstructed samples left and/or above adjacently or non-adjacently neighboring to T are considered.
   a) In one example, the cost may be calculated based on SAD and Boundary_SAD
   [1] In one example, the cost may be calculated as (SAD +w*Boundary_SAD). w may be pre-defined, or signaled or derived according to decoded information.

2. Whether to and/or how to reorder the merge candidates may depend on the category of the merge candidates.
a. In one example, only adjacent spatial and temporal merge candidates can be reordered.
b. In one example, only adjacent spatial, STMVP, and temporal merge candidates can be reordered.
c. In one example, only adjacent spatial, STMVP, temporal and non-adjacent spatial merge candidates can be reordered.
d. In one example, only adjacent spatial, STMVP, temporal, non-adjacent spatial and HMVP merge candidates can be reordered.
e. In one example, only adjacent spatial, STMVP, temporal, non-adjacent spatial, HMVP and pair-wise average merge candidates can be reordered.
f. In one example, only adjacent spatial, temporal, HMVP and pair-wise average merge candidates can be reordered.
g. In one example, only adjacent spatial, temporal, and HMVP merge candidates can be reordered.
h. In one example, only adjacent spatial merge candidates can be reordered.
i. In one example, only the first subgroup can be reordered.
j. In one example, the last subgroup can not be reordered.
k. In one example, only the first N merge candidates can be reordered.
i. In one example, N is set equal to 5.
l. In one example, for the candidates not to be reordered, they will be arranged in the merge candidate list according to the initial order.
m. In one example, candidates not to be reordered may be put behind the candidates to be reordered.
n. In one example, candidates not to be reordered may be put before the candidates to be reordered.
o. In one example, a combination of some of the above items (a-k) can be reordered.
p. Different subgroups may be reordered separately.
q. Two candidates in different subgroups cannot be compared and/or reordered.
r. A first candidate in a first subgroup must be put ahead of a second candidate in a second subgroup after reordering if the first subgroup is ahead of a second subgroup.

3. Whether to and/or how to reorder the merge candidates may depend on the coding mode.
a. In one example, if the coding mode is regular merge mode, the merge candidates can be reordered.
b. In one example, if the coding mode is MMVD, the merge candidates to derive the base merge candidates are not reordered.
   i. Alternatively, the reordering method may be different for the MMVD mode and other merge modes.
c. In one example, if the coding mode is CIIP, the merge candidates used for combination with intra prediction are based on the reordered merge candidates.
   i. Alternatively, the reordering method may be different for the CIIP mode and other merge modes.
d. In one example, if the coding mode is GPM, the merge candidates to derive the uni-prediction candidate list are not reordered.
   i. Alternatively, the reordering method may be different for the GPM mode and other merge modes.
e. In one example, if the coding mode is a triangle partition mode, the merge candidates to derive the uni-prediction candidate list are not reordered.
   i. Alternatively, the reordering method may be different for the triangular mode and other merge modes.
f. In one example, if the coding mode is a subblock based merge mode, partial or full subblock based merge candidates are reordered.
   i. Alternatively, the reordering method may be different for the subblock based merge mode and other merge modes.
   ii. In one example, the uni-prediction subblock based merge candidates are not reordered.
   iii. In one example, the SbTMVP candidate is not reordered.
   iv. In one example, the constructed affine candidates are not reordered.
   v. In one example, the zero padding affine candidates are not reordered.

4. Whether to and/or how to reorder the merge candidates may depend on the available number of adjacent spatial and/or STMVP and/or temporal merge candidates.

5. Whether the merge candidates need to be reordered or not may depend on decoded information (e.g., the width and/or height of the CU).
a. In one example, if the height is larger than or equal to M, the width is larger than or equal to N, and width*height is larger than or equal to R, the merge candidates can be reordered.
   i. In one example, M, N, and R are set equal to 8, 8, and 128.
   ii. In one example, M, N, and R are set equal to 16, 16, and 512.
b. In one example, if the height is larger than or equal to M and the width is larger than or equal to N, the merge candidates can be reordered.
   i. In one example, M and N are set equal to 8 and 8.
   ii. In one example, M and N are set equal to 16 and 16.

6. The subgroup size can be adaptive.
a. In one example, the subgroup size is decided according to the available number of adjacent spatial and/or STMVP and/or temporal merge candidates denoted as N.
   i. In one example, if N is smaller than M and larger than Q, the subgroup size is set to N;
   ii. In one example, if N is smaller than or equal to Q, no reordering is performed;
   iii. In one example, if N is larger than or equal to M, the subgroup size is set to M.
   iv. In one example, M and Q are set equal to 5 and 1, respectively.
      (i) Alternatively, M and/or Q may be pre-defined, or signaled or derived according to decoded information.
b. In one example, the subgroup size is decided according to the available number of adjacent spatial and temporal merge candidates denoted as N.
   i. In one example, if N is smaller than M and larger than Q, the subgroup size is set to N;
   ii. In one example, if N is smaller than or equal to Q, no reorder is performed;
   iii. In one example, if N is larger than or equal to M, the subgroup size is set to M.
   iv. In one example, M and Q are set equal to 5 and 1, respectively.

7. The template shape can be adaptive.
a. In one example, the template may only comprise neighboring samples left to the current block.
b. In one example, the template may only comprise neighboring samples above to the current block.
c. In one example, the template shape is selected according to the CU shape.
d. In one example, the width of the left template is selected according to the CU height.
   i. For example, if H<=M, then the left template size is w1×H; otherwise, the left template size is w2×H.
e. In one example, M, w1, and w2 are set equal to 8, 1, and 2, respectively.
f. In one example, the height of the above template is selected according to the CU width.
   i. For example, if W<=N, then the above template size is W×h1; otherwise, the above template size is W×h2.
   (i) In one example, N, h1, and h2 are set equal to 8, 1, and 2, respectively.
g. In one example, the width of the left template is selected according to the CU width.
i. For example, if W<=N, then the left template size is w1×H; otherwise, the left template size is w2×H.
   (i) In one example, N, w1, and w2 are set equal to 8, 1, and 2, respectively.
h. In one example, the height of the above template is selected according to the CU height.
i. For example, if H<=M, then the above template size is W×h1; otherwise, the above template size is W×h2.
   (i) In one example, M, h1, and h2 are set equal to 8, 1, and 2, respectively.
i. In one example, samples of the template and the reference samples of the template samples may be subsampled or downsampled before being used to calculate the cost.
   i. Whether to and/or how to do subsampling may depend on the CU dimensions.
   ii. In one example, no subsampling is performed for the short side of the CU.

8. In above examples, the merge candidate is one candidate which is included in the final merge candidate list (e.g., after pruning).
a. Alternatively, the merge candidate is one candidate derived from a given spatial or temporal block or HMVP table or with other ways even it may not be included in the final merge candidate list.

9. The template may comprise samples of specific color component(s).
a. In one example, the template only comprises samples of the luma component.

10. Whether to apply the adaptive merge candidate list reordering may depend on a message signaled in VPS/SPS/PPS/sequence header/picture header/slice header/CTU/CU/TU/PU. It may also be a region based on signaling. For example, the picture is partitioned into groups of CTU/CUs evenly or unevenly, and one flag is coded for each group to indicate whether merge candidate list reordering is applied or not.

### 2.11. Adaptive Motion Candidate List

1. The motion candidates in a motion candidate list of a block can be adaptively rearranged to derive the reordered motion candidate list according to one or some criterions, and the block is encoded/decoded according to the reordered motion candidate list.
a. The motion candidates in a motion candidate list of a block which is not a regular merge candidate list can be adaptively rearranged to derive the reordered motion candidate list according to one or some criterions.
b. In one example, whether to and/or how to reorder the motion candidates may depend on the coding mode (e.g. affine merge, affine AMVP, regular merge, regular AMVP, GPM, TPM, MMVD, TM merge, CIIP, GMVD, affine MMVD).
c. In one example, whether to and/or how to reorder the motion candidates may depend on the category (e.g., spatial, temporal, STMVP, HMVP, pair-wise, SbTMVP, constructed affine, inherited affine) of the motion candidates.
d. In one example, the motion candidate list may be the AMVP candidate list.
e. In one example, the motion candidate list may be the merge candidate list.
f. In one example, the motion candidate list may be the affine merge candidate list.
g. In one example, the motion candidate list may be the sub-block-based merge candidate list.
h. In one example, the motion candidate list may be the GPM merge candidate list.
i. In one example, the motion candidate list may be the TPM merge candidate list.
j. In one example, the motion candidate list may be the TM merge candidate list.
k. In one example, the motion candidate list may be the candidate list for MMVD coded blocks.
l. In one example, the motion candidate list may be the candidate list for DMVR coded blocks.

2. How to adaptively rearrange motion candidates in a motion candidate list may depend on the decoded information, e.g., the category of a motion candidate, a category of a motion candidate list, a coding tool.
a. In one example, for different motion candidate lists, different criteria may be used to rearrange the motion candidate list.
   i. In one example, the criteria may include how to select the template.
   ii. In one example, the criteria may include how to calculate the template cost.
   iii. In one example, the criteria may include how many candidates and/or how many sub-groups in a candidate list need to be reordered.
b. In one example, the motion candidates in a motion candidate list are firstly adaptively rearranged to construct a fully rearranged candidate list or partially rearranged candidate list, and at least one motion candidate indicated by at least one index is then retrieved from the rearranged candidate list to derive the final motion information to be used by the current block.
c. In one example, the motion candidates before refinement (e.g., using TM for TM coded blocks; adding MVD for MMVD coded blocks) are firstly adaptively rearranged to construct a fully rearranged candidate list or partially rearranged candidate list. Then at least one motion candidate indicated by at least one index is retrieved from the rearranged candidate list, and refinement (e.g., using TM for TM coded blocks; adding MVD for MMVD coded blocks) is applied to the retrieved one to derive the final motion information for the current block.
d. In one example, refinement (e.g., using TM for TM coded blocks; adding MVD for MMVD coded blocks) is applied to at least one of the motion candidates in a motion candidate list, then they are adaptively rearranged to construct a fully rearranged candidate list or partially rearranged candidate list, and at least one motion candidate indicated by at least one index is then retrieved from the rearranged candidate list to derive final the motion information without any further refinement for the current block.

3. In one example, new MERGE/AMVP motion candidates may be generated based on the candidates reordering.
i. For example, L0 motion and L1 motion of the candidates may be reordered separately.
   ii. For example, new bi-prediction merge candidates may be constructed by combining one from the reordered L0 motion and the other from the reordered L1 motion.
   iii. For example, new uni-prediction merge candidates may be generated by the reordered L0 or L1 motion.

### 2.12. Adaptive Motion Candidate List

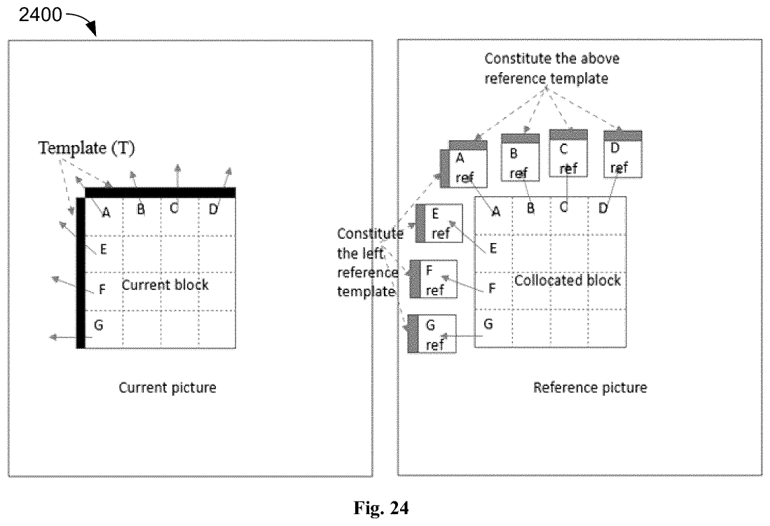

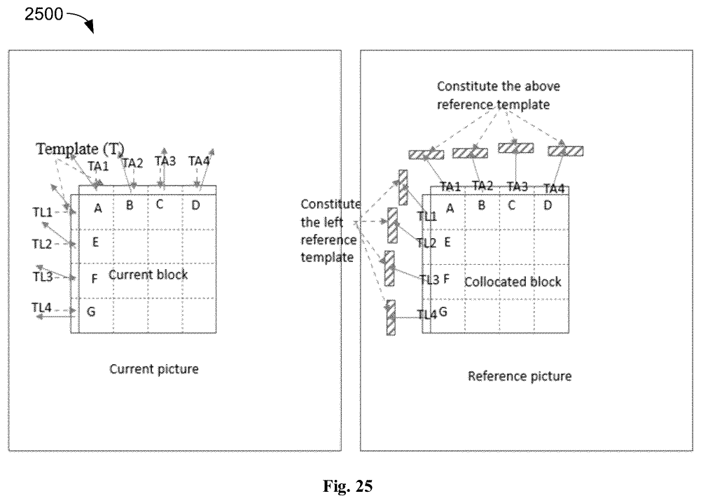

For subblock motion prediction, if the subblock size is Wsub*Hsub, the height of the above template is Ht, the width of the left template is Wt, the above template can be treated as a constitution of several sub-templates with the size of Wsub*Ht, the left template can be treated as a constitution of several sub-templates with the size of Wt*Hsub. After deriving the reference samples of each sub-template in the above similar way, the reference samples of the template are derived. Two examples are shown in FIG. 24 and FIG. 25. FIG. 24 illustrates an example diagram 2400 showing template and reference samples of the template for block with sub-block motion using the motion information of the subblocks of current block. FIG. 25 illustrates an example diagram 2500 showing template and reference samples of the template for block with sub-block motion using the motion information of each sub-template.

It is noted that the terminologies mentioned below are not limited to the specific ones defined in existing standards. Any variance of the coding tool is also applicable. For example, the term “GPM” is used to represent any coding tool that derive two sets of motion information and use the derived information and the splitting pattern to get the final prediction, e.g., TPM is also treated as GPM.

Note that the proposed methods may be applied to merge candidate list construction process for inter coded blocks (e.g., translational motion), affine coded blocks, or IBC coded blocks; or other motion candidate list construction process (e.g., normal AMVP list; affine AMVP list; IBC AMVP list).

W and H are the width and height of current block (e.g., luma block).

1. In one example, if the coding mode is TM merge, partial or full TM merge candidates may be reordered.
a. In one example, if the coding mode is TM merge, the partial or full original TM merge candidates may be reordered, before the TM refinement process.
b. Alternatively, if the coding mode is TM merge, the partial or full refined TM merge candidates may be reordered, after the TM refinement process.
c. Alternatively, if the coding mode is TM merge, the TM merge candidates may not be reordered.
d. Alternatively, the reordering method may be different for the TM merge mode and other merge modes.

2. In one example, if the coding mode is a subblock based merge mode, partial or full subblock based merge candidates may be reordered.
a. Alternatively, the reordering method may be different for the subblock based merge mode and other merge modes.
b. In one example, a template may be divided into sub-templates. Each sub-template may possess an individual piece of motion information.
   i. In one example, the cost used to reorder the candidates may be derived based on the cost of each sub-template. For example, the cost used to reorder the candidates may be calculated as the sum of the costs of all sub-templates. For example, the cost for a sub-template may be calculated as SAD, SATD, SSD or any other distortion measurement between the sub-template and its corresponding reference sub-template.
c. In one example, to derive the reference samples of a sub-template, the motion information of the subblocks in the first row and the first column of current block may be used.
   i. In one example, the motion information of a sub-template may be derived (e.g. copied) from its adjacent sub-block in the current block. An example is shown in FIG. 24.
d. In one example, to derive the reference samples of a sub-template, the motion information of the sub-template may be derived without referring to motion information of a sub-block in the current block. An example is shown in FIG. 25.
   i. In one example, the motion information of each sub-template is calculated according to the affine model of current block.
      (i) In one example, the motion vector of the center sample of each subblock containing a sub-template calculated according to the affine model of current block is treated as the motion vector of the sub-template.
      (ii) In one example, the motion vector of the center sample of each sub-template calculated according to the affine model of current block is treated as the motion vector of the sub-template.
      (iii) For 4-parameter affine motion model, motion vector at sample location (x, y) in a block is derived as:

$$\\ \{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix}$$

(iv) For 6-parameter affine motion model, motion vector at sample location (x, y) in a block is derived as:

$$\\ \{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix}$$

(v) For (iii) and (iv), the coordinates of above-left, above-right, and bottom-left corner of current block are (0,0), (W, 0) and (0,H), the motion vectors of above-left, above-right, and bottom-left corner of current block are (mv₀ₓ, mv_{0y}), (mv₁ₓ, mv_{1y}) and (mv₂ₓ, mv_{2y}).
(vi) In one example, the coordinate (x, y) in the above equations may be set equal to a position in the template, or a position of a sub-template. E.g., the coordinate (x, y) may be set equal to a center position of a sub-template.
e. In one example, this scheme may be applied to affine merge candidates.
f. In one example, this scheme may be applied to affine AMVP candidates.
g. In one example, this scheme may be applied to SbTMVP merge candidate.
h. In one example, this scheme may be applied to GPM merge candidates.
i. In one example, this scheme may be applied to TPM merge candidates.
j. In one example, this scheme may be applied to TM-refinement merge candidates.
k. In one example, this scheme may be applied to DMVR-refinement merge candidates.
l. In one example, this scheme may be applied to MULTI_PASS_DMVR-refinement merge candidates.

3. In one example, if the coding mode is MMVD, the merge candidates to derive the base merge candidates may be reordered.
a. In one example, the reordering process may be applied on the merge candidates before the merge candidates is refined by the signaled or derived MVD(s).
b. For example, the reordering method may be different for the MMVD mode and other merge modes.

4. In one example, if the coding mode is MMVD, the merge candidates after the MMVD refinement may be reordered.
a. In one example, the reordering process may be applied on the merge candidates after the merge candidates is refined by the signaled or derived MVD(s).
b. For example, the reordering method may be different for the MMVD mode and other merge modes.

5. In one example, if the coding mode is affine MMVD, the merge candidates to derive the base merge candidates may be reordered.
a. In one example, the reordering process may be applied on the merge candidates before the affine merge candidates is refined by the signaled or derived MVD(s).
b. For example, the reordering method may be different for the affine MMVD mode and other merge modes.

6. In one example, if the coding mode is affine MMVD, the merge candidates after the affine MMVD refinement may be reordered.
a. In one example, the reordering process may be applied on the affine merge candidates after the merge candidates is refined by the signaled or derived MVD(s).
b. For example, the reordering method may be different for the affine MMVD mode and other merge modes.

7. In one example, if the coding mode is GMVD, the merge candidates to derive the base merge candidates may be reordered.
a. In one example, the reordering process may be applied on the merge candidates before the merge candidates is refined by the signaled or derived MVD(s).
b. For example, the reordering method may be different for the GMVD mode and other merge modes.

8. In one example, if the coding mode is GMVD, the merge candidates after the GMVD refinement may be reordered.
a. In one example, the reordering process may be applied on the merge candidates after the merge candidates is refined by the signaled or derived MVD(s).
b. For example, the reordering method may be different for the GMVD mode and other merge modes.

9. In one example, if the coding mode is GPM, the merge candidates may be reordered.
a. In one example, the reordering process may be applied on the original merge candidates before the merge candidates are used to derive the GPM candidate list for each partition (a.k.a. the uni-prediction candidate list for GPM).
b. In one example, if the coding mode is GPM, the merge candidates in the uni-prediction candidate list may be reordered.
c. In one example, the GPM uni-prediction candidate list may be constructed based on the reordering.
   i. In one example, a candidate with bi-prediction (a.k.a. bi-prediction candidate) may be separated into two uni-prediction candidates.
      (i) If the number of original merge candidates is M, at most 2M uni-prediction candidates may be separated from them.
   ii. In one example, uni-prediction candidates separated from a bi-prediction candidate may be put into an initial uni-prediction candidate list.
   iii. In one example, candidates in the initial uni-prediction candidate list may be reordered with the template matching costs.
   iv. In one example, the first N uni-prediction candidates with smaller template matching costs may be used as the final GPM uni-prediction candidates. As an example, N is equal to M.
d. In one example, after deriving a GPM uni-prediction candidate list, a combined bi-prediction list for partition 0 and partition 1 is constructed, then the bi-prediction list is reordered.
   i. In one example, if the number of GPM uni-prediction candidates is M, the number of combined bi-prediction candidates is M*(M−1).
e. Alternatively, the reordering method may be different for the GPM mode and other merge modes.

### 2.13. Adaptive Motion Candidate List

It is noted that the terminologies mentioned below are not limited to the specific ones defined in existing standards. Any variance of the coding tool is also applicable. For example, the term “GPM” is used to represent any coding tool that derive two sets of motion information and use the derived information and the splitting pattern to get the final prediction, e.g., TPM is also treated as GPM.

Note that the proposed methods may be applied to merge candidate list construction process for inter coded blocks (e.g., translational motion), affine coded blocks, or IBC coded blocks; or other motion candidate list construction process (e.g., normal AMVP list; affine AMVP list; IBC AMVP list).

W and H are the width and height of current block (e.g., luma block).

1. The reference samples of a template or sub-template (RT) for bi-directional prediction are derived by equal weighted averaging of the reference samples of the template or sub-template in reference list0 (RT₀) and the reference samples of the template or sub-template in reference list1 (RiT₁). One example is as follows:

$$RT ( x , y ) = ( {RT}_{0} ( x , y ) + {RT}_{1} ( x , y ) + 1 ) >> 1$$

2. The reference samples of a template or sub-template (RT) for bi-directional prediction are derived by weighted averaging of the reference samples of the template or sub-template in reference list0 (RT₀) and the reference samples of the template or sub-template in reference list1 (R T₁).
a. One example is as follows:

$$RT ( x , y ) = ( ( {2}^{N} - w ) * {RT}_{0} ( x , y ) + w * {RT}_{1} ( x , y ) + {2}^{N - 1} ) >> N ,$$

b. The weights may be determined by the BCW index or derived on-the-fly or pre-defined or by the weights used in weighted prediction.
c. In one example, the weight of the reference template in reference list0 such as (8−w) and the weight of the reference template in reference list1 such as (w) maybe decided by the BCW index of the merge candidate.
   i. In one example, BCW index is equal to 0, w is set equal to −2.
   ii. In one example, BCW index is equal to 1, w is set equal to 3.
   iii. In one example, BCW index is equal to 2, w is set equal to 4.
   iv. In one example, BCW index is equal to 3, w is set equal to 5.
   v. In one example, BCW index is equal to 4, w is set equal to 10.

3. It is proposed that the reference samples of the template may be derived with LIC method.
a. In one example, the LIC parameters for both left and above templates are the same as the LIC parameters of current block.
b. In one example, the LIC parameters for left template are derived as the LIC parameters of current block which uses its original motion vector plus a motion vector offset of (−Wt, 0) as the motion vector of current block.
c. In one example, the LIC parameters for above template are derived as the LIC parameters of current block which uses its original motion vector plus a motion vector offset of (0,-Ht) as the motion vector of current block.
d. Alternatively, furthermore, the above bullets may be applied if the Local Illumination Compensation (LIC) flag of a merge candidate is true.

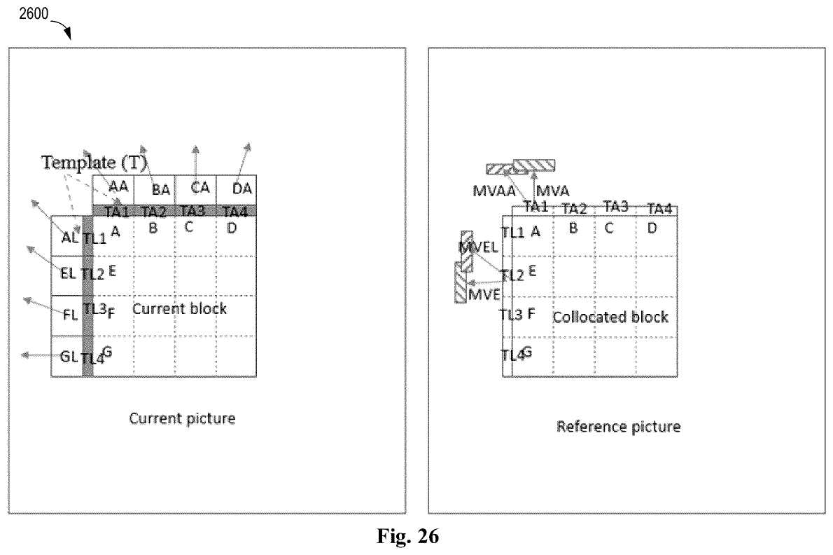

4. It is proposed that the reference samples of the template or sub-template may be derived with OBMC method. In the following discussion, a “template” may refer to a template or a sub-template.
a. In one example, to derive the reference samples of the above template, the motion information of the subblocks in the first row of current block and their above adjacent neighboring subblocks are used. And the reference samples of all the sub-templates constitute the reference samples of the above template. An example is shown in FIG. 26. FIG. 26 illustrates an example diagram 2600 showing template and reference samples of the template for block with OBMC.
b. In one example, to derive the reference samples of the left template, the motion information of the subblocks in the first column of current block and their left adjacent neighboring subblocks are used. And the reference samples of all the sub-templates constitute the reference samples of the left template. An example is shown in FIG. 26.
c. In one example, the subblock size is 4×4.
d. The reference samples of a sub-template based on motion vectors of a neighbouring subblock is denoted as P_{N}, with N indicating an index for the neighbouring above and left subblocks and the reference samples of a sub-template based on motion vectors of a subblock of current block is denoted as P_{C}. For P_{N} generated based on motion vectors of vertically (horizontally) neighbouring sub-block, samples in the same row (column) of P_{N} are added to Pc with a same weighting factor.
   i. The reference samples of a sub-template (P) may be derived as P=W_{N}*P_{N}+W_{c}*P_{c}.
   ii. In one example, the weighting factors {¼ , ⅛, 1/16, 1/32} are used for the {first, second, third, fourth} row (column) of P_{N} and the weighting factors {¾, ⅞, 15/16, 31/32} are used for the {first, second, third, fourth} row (column) of Pc if the height of the above template or the width of the left template is larger than or equal to 4.
   iii. In one example, the weighting factors {¼, ⅛} are used for the {first, second} row (column) of P_{N} and the weighting factors {¾, ⅞} are used for the {first, second} row (column) of Pc if the height of the above template or the width of the left template is larger than or equal to 2.
   iv. In one example, the weighting factor {¼} is used for the first row (column) of P_{N} and the weighting factor {¾} is used for the first row (column) of Pc if the height of the above template or the width of the left template is larger than or equal to 1.
   e. The above bullets may be applied if a merge candidate is assigned with OBMC enabled.
5. In one example, if a merge candidate uses multi-hypothesis prediction, the reference samples of the template may be derived with multi-hypothesis prediction method.
6. The template may comprise samples of specific color component(s).
   a. In one example, the template only comprises samples of the luma component.
   b. Alternatively, the template only comprises samples of any component such as Cb/Cr/R/G/B.

7. Whether to and/or how to reorder the motion candidates may depend on the category of the motion candidates.
a. In one example, only adjacent spatial and temporal motion candidates can be reordered.
b. In one example, only adjacent spatial, STMVP, and temporal motion candidates can be reordered.
c. In one example, only adjacent spatial, STMVP, temporal and non-adjacent spatial motion candidates can be reordered.
d. In one example, only adjacent spatial, STMVP, temporal, non-adjacent spatial and HMVP motion candidates can be reordered.
e. In one example, only adjacent spatial, STMVP, temporal, non-adjacent spatial, HMVP and pair-wise average motion candidates can be reordered.
f. In one example, only adjacent spatial, temporal, HMVP and pair-wise average motion candidates can be reordered.
g. In one example, only adjacent spatial, temporal, and HMVP motion candidates can be reordered.
h. In one example, only adjacent spatial motion candidates can be reordered.
i. In one example, the uni-prediction subblock based motion candidates are not reordered.
j. In one example, the SbTMVP candidate is not reordered.
k. In one example, the inherited affine motion candidates are not reordered.

1. In one example, the constructed affine motion candidates are not reordered.
m. In one example, the zero padding affine motion candidates are not reordered.
n. In one example, only the first N motion candidates can be reordered.
i. In one example, N is set equal to 5.

8. In one example, the motion candidates may be divided into subgroups. Whether to and/or how to reorder the motion candidates may depend on the subgroup of the motion candidates.
a. In one example, only the first subgroup can be reordered.
b. In one example, the last subgroup can not be reordered.
c. In one example, the last subgroup can not be reordered. But if the last subgroup also is the first subgroup, it can be reordered.
d. Different subgroups may be reordered separately.
e. Two candidates in different subgroups cannot be compared and/or reordered.
f. A first candidate in a first subgroup must be put ahead of a second candidate in a second subgroup after reordering if the first subgroup is ahead of a second subgroup.

9. In one example, the motion candidates which are not included in the reordering process may be treated in specified way.
a. In one example, for the candidates not to be reordered, they will be arranged in the merge candidate list according to the initial order.
b. In one example, candidates not to be reordered may be put behind the candidates to be reordered.
c. In one example, candidates not to be reordered may be put before the candidates to be reordered.

10. Whether to apply the adaptive merge candidate list reordering may depend on a message signaled in VPS/SPS/PPS/sequence header/picture header/slice header/CTU/CU/TU/PU. It may also be a region based on signaling. For example, the picture is partitioned into groups of CTU/CUs evenly or unevenly, and one flag is coded for each group to indicate whether merge candidate list reordering is applied or not.

### 2.14. Cost Function Utilized in Coding Data Refinement in Image/Video Coding

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

In the disclosure, the phrase “motion candidate” may represent a merge motion candidate in a regular/extended merge list indicated by a merge candidate index, or an AMVP motion candidate in regular/extended AMVP list indicated by an AMVP candidate index, or one AMVP motion candidate, or one merge motion candidate.

In the disclosure, a motion candidate is called to be “refined” if the motion information of the candidate is modified according to information signaled from the encoder or derived at the decoder. For example, a motion vector may be refined by DMVR, FRUC, TM merge, TM AMVP, TM GPM, TM CIIP, TM affine, MMVD, GMVD, affine MMVD, BDOF and so on.

In the disclosure, the phrase “coding data refinement” may represent a refinement process in order to derive or refine the signalled/decoded/derived prediction modes, prediction directions, or signalled/decoded/derived motion information, prediction and/or reconstruction samples for a block. In one example, the refinement process may include motion candidate reordering. In the following discussion, a “template-based-coded” block may refer to a block using a template matching based method in the coding/decoding process to derive or refine coded information, such as template-matching based motion derivation, template-matching based motion list reconstruction, LIC, sign prediction, template-matching based block vector (e.g., used in IBC mode) derivation, DIMD, template-matching based non-inter (e.g., intra) prediction, etc. The template-based-coded method may be combined with any other coding tools, such as MMVD, CIIP, GPM, FRUC, Affine, BDOF, DMVR, OBMC, etc. In yet another example, the “template-based-coded” block may also refer to a block which derives or refines its decoded information based on certain rules using neighboring reconstructed samples (adjacent or non-adjacent), e.g., the DIMD method in 2.27 and the TIMD method 2.29). In the following discussion, a “bilateral-based-coded” block may refer to a block using a bilateral matching based method in the coding/decoding process to derive or refine coded information, such as bilateral-matching based motion derivation, bilateral-matching based motion list reconstruction, and etc. The bilateral-based-coded method may be combined with any other coding tools, such as MMVD, CIIP, GPM, FRUC, Affine, DMVR, and etc.

W and H are the width and height of current block (e.g., luma block). W*H is the size of current block (e.g., luma block).

In the following discussion, Shift(x, s) is defined as

Shift(x, s)=(x+offset)>>s, wherein offset is an integer such as offset=0 or offset=1<<(s−1) or offset=(1<<(s−1))−1.

In another example, offset depends on x. For example, offset=(x<0 ? (1<<(s−1)): ((1<<(s−1) −1).

1. In addition to the error measurement, it is proposed to add a regulation item in the cost calculation process.
a) In one example, the cost is defined as: E+W*RI wherein the E represents the output of an error function, W is the weight applied to the regulation item denoted by RI.
   i. In one example, for processing the template-based-coded block/bilateral-based-coded block, the cost function is set to: E+W*RI wherein E may be SAD/MRSAD/SATD or others, RI is the estimated bits for motion vectors/motion vector differences, W is a weight, e.g., which may rely on QP/temporal layer etc. al.
   ii. Alternatively, the cost is defined as: w0*E+W1*RI wherein the E represents the output of an error function, W1 is the weight applied to the regulation item denoted by RI, w0 is the weight applied to the output of the error function.
      (i) Alternatively, furthermore, W1 may be set to 0.
b) In one example, the regulation item is multiplied by a weighted rate.
   i. In one example, the weight is derived on-the-fly.
   ii. In one example, the weight is set to lambda used in the full RDO process
   iii. In one example, the weight is set to a square root of the lambda used in the full RDO process.
c) In one example, the cost is calculated as E+Shift(W*RI, s), wherein s and W are integers.
   i. Alternatively, the cost is calculated as Shift((E<<s)+W*RI, s), wherein s and W are integers.

2. It is proposed to use an error function different from SAD/MR-SAD (mean removal sum of absolute difference) for processing a template-based-coded block/bilateral-based-coded block.
a) In one example, the error function may be
   i. SATD
   ii. MR-SATD
   iii. Gradient information
   iv. SSE/SSD
   v. MR-SSE/MR-SSD
   vi. Weighted SAD/weighted MR-SAD
   vii. Weighted SATD/weighted MR-SATD
   viii. Weighted SSD/weighted MR-SSD
   ix. Weighted SSE/weighted MR-SSE
b) Alternatively, furthermore, it is proposed to adaptively select the error function among different cost functions such as the above mentioned error functions and SAD/MR-SAD.
   i. The selection may be determined on-the-fly.

3. When using the MR-X (e.g., X being SATD, SAD, SSE) based error function (e.g., MR-SAD/MR-SATD etc. al), the following may further apply:
a) In one example, the mean may be calculated with all samples in a block to be compared taken into consideration.
b) In one example, the mean may be calculated with partial samples in a block to be compared taken into consideration.
c) In one example, the mean and the X function may depend on same samples in a block.
   i. In one example, the mean and X function may be calculated with all samples in the block.
   ii. In one example, the mean and X function may be calculated with partial samples in the block.
d) In one example, the mean and the X function may depend on at least one different samples in a block.
   i. In one example, the mean may be calculated with all samples while the X function may depend on partial samples in the block.
   ii. In one example, the mean may be calculated with partial samples while the X function may depend on all samples in the block.

4. The template/bilateral matching cost may be calculated by applying a cost factor to the error cost function.
a) In one example, it is proposed to favor the motion candidates ahead during the template/bilateral matching based reordering process.
   i. In one example, the motion candidate in the ith position is assigned with a smaller cost factor than the cost factor of the motion candidate in the (i+1)th position.
   ii. In one example, the motion candidates in the ith group (e.g. involve M motion candidates) are assigned with a smaller cost factor than the cost factor of the motion candidates in the (i+1)th group (e.g. involve N motion candidates).
      (i) In one example, M may be equal to N. For example, M=N=2.
      (ii) In one example, M may be not equal to N. For example, M=2, N=3.
b) In one example, it is proposed to favor the searching MVs closer to original MV during the template/bilateral matching based refinement process
   i. In one example, each search region is assigned with a cost factor, which may be determined by the distance (e.g. delta MV in integer pixel precision) between each searching MV in the search region and the starting MV.
      ii. In one example, each search region is assigned with a cost factor, which may be determined by the distance (e.g. delta MV in integer pixel precision) between the center searching MV in the search region and the starting MV.
      iii. In one example, each searching MV is assigned with a cost factor, which may be determined by the distance (e.g. delta MV in integer pixel precision) between each searching MV and the starting MV.

5. The above methods may be applied to any coding data refinement process, e.g., for a template-based-coded block, for a bilateral-based-coded block (e.g., DMVR in VVC).

6. The template matching cost measurement may be different for different template matching refinement methods.
a. In one example, the template matching refinement method may be template matching based motion candidate reordering.
b. In one example, the template matching refinement method may be template matching based motion derivation.
   i. In one example, the refinement method may be TM AMVP, TM merge, and/or FRUC.
c. In one example, the template matching refinement method may be template matching based motion refinement.
   ii. In one example, the refinement method may be TM GPM, TM CIIP, and/or TM affine.
d. In one example, the template matching refinement method may be template matching based block vector derivation.
e. In one example, the template matching refinement method may be template matching based intra mode derivation.
   iii. In one example, the refinement method may be DIMD and/or TIMD.
f. In one example, the template matching cost measure may be calculated based on the sum of absolute differences (SAD) between the current and reference templates.
g. In one example, the template matching cost measure may be calculated based on the mean-removal SAD between the current and reference templates.
h. In one example, SAD and mean-removal SAD (MR-SAD) might be selectively utilized according to the size of the current block.
   i. In one example, mean-removal SAD is used for the block with size larger than M and SAD is used for the block with size smaller than or equal to M.
      (i) In one example, M is 64.
   i. In one example, SAD and mean-removal SAD (MR-SAD) might be selectively utilized according to the LIC flag of the current block.
      i. In one example, the template matching cost measure may be SAD if the LIC flag of the current block is false.
      ii. In one example, the template matching cost measure may be MR-SAD if the LIC flag of the current block is true.
j. In one example, the template matching cost measure may be calculated based on the sum of absolute transformed differences (SATD) between the current and reference templates.
k. In one example, the template matching cost measure may be calculated based on the mean-removal SATD between the current and reference templates.
   1. In one example, SATD and mean-removal SATD (MR-SATD) might be selectively utilized according to the size of the current block.
   i. In one example, mean-removal SATD is used for the block with size larger than M and SATD is used for the block with size smaller than or equal to M.
      (i) In one example, M is 64.
m. In one example, SATD and mean-removal SATD (MR-SATD) might be selectively utilized according to the LIC flag of the current block.
   i. In one example, the template matching cost measure may be SATD if the LIC flag of the current block is false.
   ii. In one example, the template matching cost measure may be MR-SATD if the LIC flag of the current block is true.
n. In one example, the template matching cost measure may be calculated based on the sum of squared differences (SSD) between the current and reference templates.
o. In one example, the template matching cost measure may be calculated based on the mean-removal SSD between the current and reference templates.
p. In one example, SSD and mean-removal SSD (MR-SSD) might be selectively utilized according to the size of the current block.
   i. In one example, mean-removal SSD is used for the block with size larger than M and SSD is used for the block with size smaller than or equal to M.
      (i) In one example, M is 64.
q. In one example, the template matching cost measure may be the weighted SAD/weighted MR-SAD/selectively weighted MR-SAD and SAD/weighted SATD/weighted MR-SATD/selectively weighted MR-SATD and SATD/weighted SSD/weighted MR-SSD/selectively weighted MR-SSD and SSD between the current and reference templates.
   i. In one example, the weighted means applying different weights to each sample based on its row and column ind//ices in template block when calculating the distortion between the current and reference templates.
   ii. In one example, the weighted means applying different weights to each sample based on its positions in template block when calculating the distortion between the current and reference templates.
   iii. In one example, the weighted means applying different weights to each sample based on its distances to current block when calculating the distortion between the current and reference templates.
r. In one example, the template matching cost may be calculated as a form of tplCost=w1*mvDistanceCost+w2*distortionCost.
   i. In one example, distortionCost may be weighted SAD/weighted MR-SAD/weighted SATD/weighted MR-SATD/weighted SSD/weighted MR-SSD/SAD/MR-SAD/SATD/MR-SATD/SSD/MR-SSD between the current and reference templates.
   ii. In one example, mvDistanceCost may be the sum of absolute my differences of searching point and starting point in horizontal and vertical directions.
   iii. In one example, w1 and w2 may be pre-defined, or signaled or derived according to decoded information.
      (i) In one example, w1 is a weighting factor set to 4, w2 is a weighting factor set to 1
s. The cost may consider the continuity (Boundary_SAD) between reference template and reconstructed samples adjacently or non-adjacently neighboring to current template in addition to the SAD calculated in (f). For example, reconstructed samples left and/or above adjacently or non-adjacently neighboring to current template are considered.
   i. In one example, the cost may be calculated based on SAD and Boundary_SAD
      (i) In one example, the cost may be calculated as (SAD+w*Boundary_SAD). w may be pre-defined, or signaled or derived according to decoded information.

7. The bilateral matching cost measurement may be different for different bilateral matching refinement methods.
a) In one example, the bilateral matching refinement method may be bilateral matching based motion candidate reordering.
b) In one example, the bilateral matching refinement method may be bilateral matching based motion derivation.
   i. In one example, the refinement method may be BM merge and/or FRUC.
c) In one example, the bilateral matching refinement method may be bilateral matching based motion refinement.
   i. In one example, the refinement method may be BM GPM, BM CIIP, and/or BM affine.
d) In one example, the bilateral matching refinement method may be bilateral matching based block vector derivation.
e) In one example, the bilateral matching refinement method may be bilateral matching based intra mode derivation.
f) In one example, the bilateral matching cost measure may be calculated based on the sum of absolute differences (SAD) between the two reference blocks/subblocks.
g) In one example, the bilateral matching cost measure may be calculated based on the mean-removal SAD between the two reference blocks/subblocks.
h) In one example, SAD and mean-removal SAD (MR-SAD) might be selectively utilized according to the size of the current block/subblock.
   i. In one example, mean-removal SAD is used for the block/subblock with size larger than M and SAD is used for the block/subblock with size smaller than or equal to M.
      (i) In one example, M is 64.
i) In one example, SAD and mean-removal SAD (MR-SAD) might be selectively utilized according to the LIC flag of the current block.
   i. In one example, the bilateral matching cost measure may be SAD if the LIC flag of the current block is false.
   ii. In one example, the bilateral matching cost measure may be MR-SAD if the LIC flag of the current block is true.
j) In one example, the bilateral matching cost measure may be calculated based on the sum of absolute transformed differences (SATD) between the two reference blocks/subblocks.
k) In one example, the bilateral matching cost measure may be calculated based on the mean-removal SATD between the two reference blocks/subblocks.
1) In one example, SATD and mean-removal SATD (MR-SATD) might be selectively utilized according to the size of the current block/subblock.
   i. In one example, mean-removal SATD is used for the block/subblock with size larger than M and SATD is used for the block/subblock with size smaller than or equal to M.
      (i) In one example, M is 64.
m) In one example, SATD and mean-removal SATD (MR-SATD) might be selectively utilized according to the LIC flag of the current block.
   i. In one example, the bilateral matching cost measure may be SATD if the LIC flag of the current block is false.
   ii. In one example, the bilateral matching cost measure may be MR-SATD if the LIC flag of the current block is true.
n) In one example, the bilateral matching cost measure may be calculated based on the sum of squared differences (SSD) between the two reference blocks/subblocks.
o) In one example, the bilateral matching cost measure may be calculated based on the mean-removal SSD between the two reference blocks/subblocks.
p) In one example, SSD and mean-removal SSD (MR-SSD) might be selectively utilized according to the size of the current block/subblock.
   i. In one example, mean-removal SSD is used for the block/subblock with size larger than M and SSD is used for the block/subblock with size smaller than or equal to M.
      (i) In one example, M is 64.
q) In one example, SSD and mean-removal SSD (MR-SSD) might be selectively utilized according to the LIC flag of the current block.
   i. In one example, the bilateral matching cost measure may be SSD if the LIC flag of the current block is false.
   ii. In one example, the bilateral matching cost measure may be MR-SSD if the LIC flag of the current block is true.
r) In one example, the bilateral matching cost measure may be the weighted SAD/weighted MR-SAD/selectively weighted MR-SAD and SAD/weighted SATD/weighted MR-SATD/selectively weighted MR-SATD and SATD/weighted SSD/weighted MR-SSD/selectively weighted MR-SSD and SSD between the two reference blocks/subblocks.
   i. In one example, the weighted means applying different weights to each sample based on its row and column indices in reference block/subblock when calculating the distortion between the two reference blocks/subblocks.
   ii. In one example, the weighted means applying different weights to each sample based on its positions in reference block/subblock when calculating the distortion between the two reference blocks/subblocks.
   iii. In one example, the weighted means applying different weights to each sample based on its distances to center position of reference block/subblock when calculating the distortion between the two reference blocks/subblocks.
s) In one example, if MR-SAD/MR-SATD/MR-SSD is used for the bilateral matching cost measure, LIC may be not used when deriving the reference blocks/subblocks.
t) In one example, the bilateral matching cost may be calculated as a form of bilCost=w1*mvDistanceCost+w2*distortionCost.
   i. In one example, distortionCost may be weighted SAD/weighted MR-SAD/weighted SATD/weighted MR-SATD/weighted SSD/weighted MR-SSD/SAD/MR-SAD/SATD/MR-SATD/SSD/MR-SSD between the two reference blocks/subblocks.
   ii. In one example, mvDistanceCost may be the sum of absolute my differences of searching point and starting point in horizontal and vertical directions.
   iii. In one example, w1 and w2 may be pre-defined, or signaled or derived according to decoded information.
      (i) In one example, w1 is a weighting factor set to 4, w2 is a weighting factor set to 1.

8. The bilateral or template matching cost may be calculated based on prediction/reference samples which are modified by a function.
a) In one example, the prediction/reference samples may be filtered before being used to calculate the bilateral or template matching cost.
b) In one example, a prediction/reference sample S may be modified to be a*S+b before being used to calculate the bilateral or template matching cost.
c) In one example, the modification may depend on the coding mode of the block, such as whether the block is LIC-coded or BCW-coded.
   2.15. Usage of Multiple Cost Functions in Coding Data Refinement in Image/Video coding

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

In the disclosure, the phrase “motion candidate” may represent a merge motion candidate in a regular/extended merge list indicated by a merge candidate index, or an AMVP motion candidate in regular/extended AMVP list indicated by an AMVP candidate index, or one AMVP motion candidate, or one merge motion candidate.

In the disclosure, a motion candidate is called to be “refined” if the motion information of the candidate is modified according to information signaled from the encoder or derived at the decoder. For example, a motion vector may be refined by DMVR, FRUC, TM merge, TM AMVP, TM GPM, TM CIIP, TM affine, MMVD, GMVD, affine MMVD, BDOF and so on.

In the disclosure, the phrase “coding data refinement” may represent a refinement process in order to derive or refine the signalled/decoded/derived prediction modes, prediction directions, or signalled/decoded/derived motion information, prediction and/or reconstruction samples for a block. In one example, the refinement process may include motion candidate reordering. In the following discussion, a “template-based-coded” block may refer to a block using a template matching based method in the coding/decoding process to derive or refine coded information, such as template-matching based motion derivation, template-matching based motion list reconstruction, LIC, sign prediction, template-matching based block vector (e.g., used in IBC mode) derivation, DIMD, template-matching based non-inter (e.g., intra) prediction, etc. The template-based-coded method may be combined with any other coding tools, such as MMVD, CIIP, GPM, FRUC, Affine, BDOF, DMVR, OBMC, etc. In yet another example, the “template-based-coded” block may also refer to a block which derives or refines its decoded information based on certain rules using neighboring reconstructed samples (adjacent or non-adjacent), e.g., the DIMD method in 2.27 and the TIMD method 2.29). In the following discussion, a “bilateral-based-coded” block may refer to a block using a bilateral matching based method in the coding/decoding process to derive or refine coded information, such as bilateral-matching based motion derivation, bilateral-matching based motion list reconstruction, and etc. The bilateral-based-coded method may be combined with any other coding tools, such as MMVD, CIIP, GPM, FRUC, Affine, DMVR, and etc.

W and H are the width and height of current block (e.g., luma block). W*H is the size of current block (e.g., luma block).

1. The cost definition may rely on outputs of multiple errors functions (e.g., distortion measurement methods) regarding the error/difference of two samples/blocks to be evaluated in one coding data refinement process of a current block.
a) In one example, the error function may be:
   i. SAD
   ii. SATD
   iii. MR-SAD
   iv. MR-SATD
   v. Gradient information
   vi. SSE/SSD
   vii. MR-SSE/MR-SSD
   viii. Weighted SAD/weighted MR-SAD
   ix. Weighted SATD/weighted MR-SATD
   x. Weighted SSD/weighted MR-SSD
   xi. Weighted SSE/weighted MR-SSE
b) In one example, the error function may be performed in block level or sub-block level.
   i. Alternatively, furthermore, for two sub-blocks, the error function may be different.
   ii. Alternatively, furthermore, the final output of the evaluated error of a block may be based on the outputs of sub-blocks, e.g., sum of outputs of error functions applied to each sub-block.
2. When the cost definition relies on outputs of multiple functions, the following may further apply:
   a) In one example, the cost function may rely on a linear weighted sum of multiple error functions.
   b) In one example, the cost function may rely on a non-linear weighted sum of multiple error functions.
   c) In one example, the cost function may further rely on estimated bits for side information.
   d) In one example, the cost function may be defined as:

$$C = R + {\sum }_{i = 0}^{N - 1} {W}_{i} * {E}_{i}$$

wherein R denotes the estimated bits for side information, Wᵢ and Eᵢ represent the weight applied to the i-th error function and output of the i-th error function, respectively.

3. Multiple refinement processes may be applied to one block with at least more than two different cost functions applied to at least two refinement processes.
a) In one example, a first refinement process may be invoked with a first cost function. Based on the output of the first refinement process, a second cost function is further applied to the second refinement process.
b) The above methods may be applied to the template-based-coded blocks.

4. Whether to use multiple refinement process, and/or how to select one or multiple error function and/or how to define the cost function and/or which samples to be involved in the error function may depend on the decoded information of a current block and/or its neighboring (adjacent or non-adjacent) blocks.
a) In one example, how to select one or multiple error function and/or how to define the cost function may depend on the coding tool applied to current block and/or its neighboring blocks.
   i. In one example, the coding tool is the LIC.
      (i) In one example, SSD and mean-removal SSD (MR-SSD) might be selectively utilized according to the LIC flag of the current block.
         a) In one example, the template matching cost measure may be SSD if the LIC flag of the current block is false.
         b) In one example, the template matching cost measure may be MR-SSD if the LIC flag of the current block is true.
      (ii) In one example, if MR-SAD/MR-SATD/MR-SSD is used for the template matching cost measure, the linear function used in LIC process may be not used when deriving the reference template.
      (iii) In one example, if MR-SAD/MR-SATD/MR-SSD is used for the bilateral matching cost measure, the linear function used in LIC process may be not used when deriving the reference block.
b) In one example, it may depend on block dimension, temporal layer, low delay check flag, etc. al.
c) In one example, it may depend on whether the motion information of current and neighboring block is similar/identical.
d) In one example, it may depend on reference picture list and/or reference picture information.
   i. In one example, for list X, a first error function (e.g., SAD/SSE) may be used, and for list Y (Y=1-X), a second error function (e.g., MR-SAD/MR-SSE) may be used.
   ii. Alternatively, furthermore, the final cost may be based on the costs of each reference picture list.

5. The above methods may be applied to any coding data refinement process, e.g., for a template-based-coded block, for a bilateral-based-coded block (e.g., DMVR in VVC).

### 2.16. Samples Utilized in Coding Data Refinement for Image/Video Coding

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

In the disclosure, the phrase “motion candidate” may represent a merge motion candidate in a regular/extended merge list indicated by a merge candidate index, or an AMVP motion candidate in regular/extended AMVP list indicated by an AMVP candidate index, or one AMVP motion candidate, or one merge motion candidate.

In the disclosure, a motion candidate is called to be “refined” if the motion information of the candidate is modified according to information signaled from the encoder or derived at the decoder. For example, a motion vector may be refined by DMVR, FRUC, TM merge, TM AMVP, TM GPM, TM CIIP, TM affine, MMVD, GMVD, affine MMVD, BDOF and so on.

In the disclosure, the phrase “coding data refinement” may represent a refinement process in order to derive or refine the signalled/decoded/derived prediction modes, prediction directions, or signalled/decoded/derived motion information, prediction and/or reconstruction samples for a block. In one example, the refinement process may include motion candidate reordering. In the following discussion, a “template-based-coded” block may refer to a block using a template matching based method in the coding/decoding process to derive or refine coded information, such as template-matching based motion derivation, template-matching based motion list reconstruction, LIC, sign prediction, template-matching based block vector (e.g., used in IBC mode) derivation, DIMD, template-matching based non-inter (e.g., intra) prediction, etc. The template-based-coded method may be combined with any other coding tools, such as MMVD, CIIP, GPM, FRUC, Affine, BDOF, DMVR, OBMC, etc. In yet another example, the “template-based-coded” block may also refer to a block which derives or refines its decoded information based on certain rules using neighboring reconstructed samples (adjacent or non-adjacent), e.g., the DIMD method in 2.27 and the TIMD method 2.29). In the following discussion, a “bilateral-based-coded” block may refer to a block using a bilateral matching based method in the coding/decoding process to derive or refine coded information, such as bilateral-matching based motion derivation, bilateral-matching based motion list reconstruction, and etc. The bilateral-based-coded method may be combined with any other coding tools, such as MMVD, CIIP, GPM, FRUC, Affine, DMVR, and etc.

W and H are the width and height of current block (e.g., luma block). W*H is the size of current block (e.g., luma block).

1. The error/cost evaluation in the coding data refinement process may depend on both reference samples corresponding to current block (e.g., the reference blocks used in bilateral matching) and reference samples corresponding to a template of current block.
a) Alternatively, it may depend on both reference samples corresponding to current block and samples in a template of current block.
b) In one example, the template may be neighboring samples (adjacent or non-adjacent) of current block.

2. Multiple refinement processes may be applied to one block with different templates applied to at least two refinement processes.
a) In one example, a first refinement process may be invoked with a first template. Based on the output of the first refinement process, a second template is further utilized in the second refinement process.
b) In one example, the first template may contain more samples compared to the second template.
c) In one example, the first and second template may contain at least one different sample.
d) In one example, the first and second refinement process may use different cost/error functions.

3. Whether to use multiple refinement process, and/or how to select one or multiple error function and/or how to define the cost function and/or which samples to be involved in the error function may depend on the decoded information of a current block and/or neighboring (adjacent or non-adjacent) blocks.
a) In one example, how to select one or multiple error function and/or how to define the cost function may depend on the coding tool applied to current block and/or neighboring blocks.
   i. In one example, the coding tool is the LIC.
      (i) In one example, SSD and mean-removal SSD (MR-SSD) might be selectively utilized according to the LIC flag of the current block.
         a) In one example, the template matching cost measure may be SSD if the LIC flag of the current block is false.
         b) In one example, the template matching cost measure may be MR-SSD if the LIC flag of the current block is true.
      (ii) In one example, if MR-SAD/MR-SATD/MR-SSD is used for the template matching cost measure, the linear function used in LIC process may be not used when deriving the reference template.
      (iii) In one example, if MR-SAD/MR-SATD/MR-SSD is used for the bilateral matching cost measure, the linear function used in LIC process may be not used when deriving the reference block.
b) In one example, it may depend on block dimension (e.g., W, H), temporal layer, low delay check flag, etc. al.
c) In one example, it may depend on whether the motion information of current and neighboring block is similar/identical.
d) In one example, it may depend on reference picture list and/or reference picture information.
   i. In one example, for list X, a first error function (e.g., SAD/SSE) may be used, and for list Y (Y=1-X), a second error function (e.g., MR-SAD/MR-SSE) may be used.
   ii. Alternatively, furthermore, the final cost may be based on the costs of each reference picture list.

4. In one example, LIC may be enabled for reference list X and disabled for reference list Y.
a) In one example, the final prediction of current block may be weighted average of LIC prediction from reference List X and regular prediction from reference List Y.

5. The above methods may be applied to any coding data refinement process, e.g., for a template-based-coded block, for a bilateral-based-coded block (e.g., DMVR in VVC).

### 2.17. Adaptive Motion Candidate List

It is noted that the terminologies mentioned below are not limited to the specific ones defined in existing standards. Any variance of the coding tool is also applicable. For example, the term “GPM” is used to represent any coding tool that derive two sets of motion information and use the derived information and the splitting pattern to get the final prediction, e.g., TPM is also treated as GPM.

Note that the proposed methods may be applied to merge candidate list construction process for inter coded blocks (e.g., translational motion), affine coded blocks, TM coded blocks, or IBC coded blocks; or other motion candidate list construction process (e.g., normal AMVP list; affine AMVP list; IBC AMVP list; HMVP table).

The cost function excepting the template matching cost is also applicable for motion candidate reordering.

W and H are the width and height of current block (e.g., luma block).

1. The template/bilateral matching cost C may be calculated to be f(C) before it is used to be compared with another template matching cost.
a. In one example, f(C)=w*C, wherein w is denoted as a cost factor.
b. In one example, f(C)=w*C+u.
c. In one example, f(C)=Shift((w*C), s).
d. In one example, w and/or u and/or s are integers.
e. In one example, a first template matching cost for a first motion candidate may be multiplied by a cost factor before it is compared with a second template matching cost for a second motion candidate.
f. In one example, it is proposed the cost factor for a motion candidate may depend on the position of the candidate before reordering.
   i. In one example, the motion candidate at the i-th position may be assigned with a smaller cost factor than the cost factor of the motion candidate at the j-th position, wherein j>i, e.g. j=i+1.
      (i) In one example, the cost factor of the motion candidate at the i-th position is 4 and the cost factor of the motion candidate at the j-th position is 5.
      (ii) In one example, the cost factor of the motion candidate at the i-th position is 1 and the cost factor of the motion candidate at the j-th position is 5.
   ii. In one example, the motion candidate at the i-th position may be assigned with a larger cost factor than the cost factor of the motion candidate at the j-th position, wherein j>i, e.g. j=i+1.
   iii. In one example, the motion candidates in the p-th group (e.g. including M motion candidates) may be assigned with a smaller cost factor than the cost factor of the motion candidates in the q-th group (e.g. including N motion candidates), wherein q>p, e.g. q=p+l.
      (i) Alternatively, the motion candidates in the p-th group (e.g. including M motion candidates) may be assigned with a larger cost factor than the cost factor of the motion candidates in the q-th group (e.g. including N motion candidates), wherein q>p, e.g. q=p+1.
      (ii) In one example, M may be equal to N. For example, M=N=2.
      (iii) In one example, M may be not equal to N. For example, M=2, N=3.
      (iv) In one example, the cost factor of the motion candidates at the p-th group is 4 and the cost factor of the motion candidates at the q-th group is 5.
      (v) In one example, the cost factor of the motion candidates at the p-th group is 1 and the cost factor of the motion candidates at the q-th group is 5.
   iv. In one example, the cost factor may be not applied to subblock motion candidates.
   v. In one example, the cost factor may be not applied to affine motion candidates.
   vi. In one example, the cost factor may be not applied to SbTMVP motion candidates.
g. In one example, the cost factor of the motion candidates in one group/position may be adaptive.
   i. In one example, the cost factor of the motion candidates in one group/position may be dependent on the coding mode of neighbor coded blocks.
      (i) In one example, the cost factor of SbTMVP merge candidate may be dependent on the number of neighbor affine coded blocks.
      (ii) In one example, the neighbor coded blocks may include at least one of the five spatial neighbor blocks (shown in FIG. 4) and/or the temporal neighbor block(s) (shown in FIG. 7).
      (iii) In one example, the cost factor of SbTMVP merge candidate may be 0.2 when the number of spatial neighbor affine coded blocks (shown in FIG. 4) is 0; the cost factor of SbTMVP merge candidate may be 0.5 when the number of spatial neighbor affine coded blocks (shown in FIG. 4) is 1; the cost factor of SbTMVP merge candidate may be 0.8 when the number of spatial neighbor affine coded blocks (shown in FIG. 4) is 2; otherwise, the cost factor of SbTMVP merge candidate may be 1 (which means keeping unchanged).
      (iv) In one example, the cost factor of SbTMVP merge candidate may be 0.2 when the number of spatial neighbor affine coded blocks (shown in FIG. 4) is 0; the cost factor of SbTMVP merge candidate may be 0.5 when the number of spatial neighbor affine coded blocks (shown in FIG. 4) is 1; the cost factor of SbTMVP merge candidate may be 0.8 when the number of spatial neighbor affine coded blocks (shown in FIG. 4) is larger than or equal to 2.
      (v) In one example, the cost factor of SbTMVP merge candidate may be 2 when the number of spatial neighbor affine coded blocks (shown in FIG. 4) is 0; the cost factor of SbTMVP merge candidate may be 5 when the number of spatial neighbor affine coded blocks (shown in FIG. 4) is 1; the cost factor of SbTMVP merge candidate may be 8 when the number of spatial neighbor affine coded blocks (shown in FIG. 4) is 2; otherwise, the cost factor of SbTMVP merge candidate may be 10 (wherein the cost factor of affine merge candidates is 10).
      (vi) In one example, the cost factor of SbTMVP merge candidate may be 2 when the number of spatial neighbor affine coded blocks (shown in FIG. 4) is 0; the cost factor of SbTMVP merge candidate may be 5 when the number of spatial neighbor affine coded blocks (shown in FIG. 4) is 1; the cost factor of SbTMVP merge candidate may be 8 when the number of spatial neighbor affine coded blocks (shown in FIG. 4) is larger than or equal to 2 (wherein the cost factor of affine merge candidates is 10).

2. The subgroup size may be different for different coding modes.
a. The coding modes may include regular/subblock/TM merge modes.
   i. The subgroup size may be K1 (e.g., K1=5) for regular merge mode.
   ii. The subgroup size may be K2 (e.g., K2=3) for subblock merge mode.
   iii. The subgroup size may be K3 (e.g., K3=3) for TM merge mode.
b. The subgroup size may be larger than or equal to the maximum number of subblock merge candidates defined in sps/picture/slice header (which means reordering whole list together) for subblock merge mode.
c. The subgroup size may be larger than or equal to the maximum number of TM merge candidates defined in sps/picture/slice header (which means reordering whole list together) for TM merge mode.
d. The subgroup size for a coding mode may be dependent on the maximum number of motion candidates in the coding mode.
e. The subgroup size for subblock merge mode may be adaptive dependent on the number of neighbor affine coded blocks.
   i. In one example, the neighbor coded blocks may include at least one of the five spatial neighbor blocks (shown in FIG. 4) and/or the temporal neighbor block(s) (shown in FIG. 7).
   ii. In one example, the subgroup size for subblock merge mode may be 3 when the number of spatial neighbor affine coded blocks (shown in FIG. 4) is 0 or 1; the subgroup size for subblock merge mode may be 5 when the number of spatial neighbor affine coded blocks (shown in FIG. 4) is larger than 1;

3. The template size may be different for different coding modes.
a. The coding modes may include regular/subblock/TM merge modes.
   i. The template size may be K1 (e.g., K1=1) for regular merge mode.
   ii. The template size may be K2 (e.g., K2=1, 2, or 4) for subblock merge mode.
   iii. The template size may be K3 (e.g., K3=1) for TM merge mode.

4. Whether to and/or how to reorder the motion candidates may depend on the coding modes of neighbor coded blocks.
a. In one example, the neighbor coded blocks may include at least one of the five spatial neighbor blocks (shown in FIG. 4) and/or the temporal neighbor block(s) (shown in FIG. 7).
b. The regular merge candidates may be reordered when the number of spatial neighbor coded blocks with regular merge mode (shown in FIG. 4) is larger than or equal to K (e.g., K=1).
c. The subblock merge candidates may be reordered when the number of spatial neighbor coded blocks with subblock merge mode (shown in FIG. 4) is larger than or equal to K (e.g., K=1).
d. The affine merge candidates may be reordered when the number of spatial neighbor coded blocks with affine merge mode (shown in FIG. 4) is larger than or equal to K (e.g., K=1).
e. The SbTMVP merge candidates may be reordered when the number of spatial neighbor coded blocks with affine merge mode (shown in FIG. 4) is larger than or equal to K (e.g., K=1, 2, or 3).
f. The TM merge candidates may be reordered when the number of spatial neighbor coded blocks with TM merge mode (shown in FIG. 4) is larger than or equal to K (e.g., K=1).

5. The HMVP motion candidates in the HMVP table may be reordered based on template/bilateral matching etc. al.
a. In one example, a HMVP motion candidate is assigned with a cost, the HMVP candidates are adaptively reordered in a descending order of costs of HMVP candidates.
   i. In one example, the cost of a HMVP candidate may be a template matching cost.
b. In one example, HMVP motion candidates may be reordered before coding a block.
   i. In one example, HMVP motion candidates may be reordered before coding an inter-coded block.
c. In one example, HMVP motion candidates may be reordered in different ways depending on coding information of the current block and/or neighbouring blocks.

### General Claims

6. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

7. Whether to and/or how to apply the disclosed methods above may be signalled at PB/TB/CB/PU/TU/CU/VPDU/CTU/CTU row/slice/tile/sub-picture/other kinds of region contains more than one sample or pixel.

8. Whether to and/or how to apply the disclosed methods above may be dependent on coded information, such as coding mode, block size, colour format, single/dual tree partitioning, colour component, slice/picture type.

### 2.18. Adaptive GPM Candidate List

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM is also treated as GPM.

Note that the proposed methods may be applied to merge candidate list construction process for inter coded blocks (e.g., translational motion), affine coded blocks, TM coded blocks, GPM coded blocks, or IBC coded blocks; or other motion candidate list construction process (e.g., normal AMVP list; affine AMVP list; IBC AMVP list; HMVP table).

The cost function excepting the template matching cost is also applicable for motion candidate reordering.

Hereinafter, template is a set of reconstructed/prediction samples adjacently or non-adjacently neighboring to the current block. Reference samples of a template (i.e. reference template) are mapping of the template in a reference picture depend on a motion information of the current block. “above template” indicates a template constructed from a set of reconstructed/prediction samples above adjacently or non-adjacently neighboring to the current block and its reference template. “left template” indicates a template constructed from a set of reconstructed/prediction samples left adjacently or non-adjacently neighboring to the current block and its reference template. “above and left template” includes both above template and left template.

In the following, in one example, a GPM candidate list where GPM candidates are directly derived from regular merge list (before or without template matching based motion refinement) is called OGPMList; a refined GPM candidate list where GPM candidates are refined by a first refining method such as template matching using the above template is called AGPMList; a refined GPM candidate list where GPM candidates are refined by a second refining method such as template matching using the left template is called LGPMList; a refined GPM candidate list where GPM candidates are refined by a third refining method such as template matching using the left and above template is called LAGPMList.

W and H are the width and height of current block (e.g., luma block).

1. It is proposed that for a GPM coded block, the coded candidate index may be corresponding to a candidate with a different candidate index in the candidate list for GPM coded blocks.
a. Alternatively, furthermore, the candidate list constructed for the GPM coded block may be reordered before being used and the coded index is corresponding to the reordered candidate list.
b. Alternatively, furthermore, for a first type of GPM coded block, the candidate list may be reordered, and for a second type of GPM coded block, the candidate list may not be reordered.
   i. In one example, the first type is template-based GPM coded block.
   ii. In one example, the second type is the MMVD-based GPM coded block (e.g., GMVD).
c. Alternatively, furthermore, for a first type of GPM coded block, the candidate list may be reordered with a first rule, and for a second type of GPM coded block, the candidate list may be reordered with a second rule.
d. The reordering method for a GPM coded block may be the same as that for a non-GPM coded block.
   i. The reordering method for a GPM coded block may be different from that for a non-GPM coded block.

2. It is proposed that for a GPM coded block, the coded candidate index may be corresponding to a candidate from a refined candidate list for GPM coded blocks.
a. Alternatively, furthermore, the candidate list constructed for the GPM coded block may be refined firstly before being used and the coded index is corresponding to the refined candidate list.
b. Alternatively, furthermore, for a first type of GPM coded block, the candidate list may be refined, and for a second type of GPM coded block, the candidate list may not be refined.
   i. In one example, the first type is template-based GPM coded block.
   ii. In one example, the second type is the MMVD-based GPM coded block (e.g., GMVD).
c. Alternatively, furthermore, for a first type of GPM coded block, the candidate list may be refined with a first rule, and for a second type of GPM coded block, the candidate list may be refined with a second rule.
d. The refined method for a GPM coded block may be the same as that for a non-GPM coded block.
i. The refined method for a GPM coded block may be different from that for a non-GPM coded block.

3. In one example, the GPM candidates may be divided into subgroups. Whether to and/or how to reorder the GPM candidates may depend on the subgroup of the GPM candidates.
a. In one example, only the first subgroup can be reordered.
b. In one example, the last subgroup can not be reordered.
c. In one example, the last subgroup can not be reordered. But if the last subgroup also is the first subgroup, it can be reordered.
d. Different subgroups may be reordered separately.
e. Two candidates in different subgroups cannot be compared and/or reordered.
f. A first candidate in a first subgroup must be put ahead of a second candidate in a second subgroup after reordering if the first subgroup is ahead of a second subgroup.

4. In one example, the GPM candidates which are not included in the reordering process may be treated in specified way.
a. In one example, for the candidates not to be reordered, they will be arranged in the merge candidate list according to the initial order.
b. In one example, candidates not to be reordered may be put behind the candidates to be reordered.
c. In one example, candidates not to be reordered may be put before the candidates to be reordered.

5. A GPM candidate list to be reordered may refer to
Case 1: a first candidate list which is prepared for the two GPM partitions and is used to derive the individual GPM candidate lists for each GPM partitions.
   Case 2: a second GPM candidate list which is used for each GPM partition. Usually the second GPM candidate is derived from the first candidate list.
a. In one example, in case 1, the reordering method may be the same to that used for a regular merge candidate list.
b. In one example, in case 1, the template matching approach in the reordering method may be conducted in a bi-prediction way if the corresponding candidate is bi-predicted.
c. In one example, in case 2, the template matching approach in the reordering method cannot be conducted in a bi-prediction way.
d. In one example, in case 2, the reordering method may be the same for all GPM partitions.
e. In one example, in case 2, the reordering method may be different for different GPM partitions.

6. In above examples, the GPM coded block may be a GPM coded block with merge mode, a GPM coded block with AMVP mode.
a. Alternatively, furthermore, the merge candidate mentioned above may be replaced by an AMVP candidate.

### General Claims

7. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

8. Whether to and/or how to apply the disclosed methods above may be signalled at PB/TB/CB/PU/TU/CU/VPDU/CTU/CTU row/slice/tile/sub-picture/other kinds of region contains more than one sample or pixel.

9. Whether to and/or how to apply the disclosed methods above may be dependent on coded information, such as coding mode, block size, colour format, single/dual tree partitioning, colour component, slice/picture type.

### 2.19. Adaptive GPM Candidate List

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM is also treated as GPM.

Note that the proposed methods may be applied to merge candidate list construction process for inter coded blocks (e.g., translational motion), affine coded blocks, TM coded blocks, GPM coded blocks, or IBC coded blocks; or other motion candidate list construction process (e.g., normal AMVP list; affine AMVP list; IBC AMVP list; HMVP table).

The cost function excepting the template matching cost is also applicable for motion candidate reordering.

Hereinafter, template is a set of reconstructed/prediction samples adjacently or non-adjacently neighboring to the current block. Reference samples of a template (i.e. reference template) are mapping of the template in a reference picture depend on a motion information of the current block. “above template” indicates a template constructed from a set of reconstructed/prediction samples above adjacently or non-adjacently neighboring to the current block and its reference template. “left template” indicates a template constructed from a set of reconstructed/prediction samples left adjacently or non-adjacently neighboring to the current block and its reference template. “above and left template” includes both above template and left template.

In the following, in one example, a GPM candidate list where GPM candidates are directly derived from regular merge list (before or without template matching based motion refinement) is called OGPMList; a refined GPM candidate list where GPM candidates are refined by a first refining method such as template matching using the above template is called AGPMList; a refined GPM candidate list where GPM candidates are refined by a second refining method such as template matching using the left template is called LGPMList; a refined GPM candidate list where GPM candidates are refined by a third refining method such as template matching using the left and above template is called LAGPMList; Regarding the type of GPM candidates in the original GPM candidate list, the GPM candidates derived in the first step of GPM candidate list construction process in section 2.29 are called GPM-parity-based candidates; The GPM candidates derived in the second step of GPM candidate list construction process in section 2.29 are called GPM-anti-parity-based candidates; The GPM candidates derived in the third step of GPM candidate list construction process in section 2.29 are called GPM-filled candidates.

W and H are the width and height of current block (e.g., luma block).

1. In one example, if the coding mode is GPM, the merge candidates may be reordered.
a. In one example, the merge candidates in the OGPMList may be reordered.
   i. In one example, at least two merge candidates in OGPMList may be reordered.
   ii. In one example, at least one type of template may be used for OGPMList reordering.
   iii. Alternatively, the merge candidates in the OGPMList may NOT be reordered.
   iv. In one example, a first type of template may only comprise neighboring samples left to the current block.
   v. In one example, a second type of template may only comprise neighboring samples above to the current block.
   vi. In one example, a third type of template may comprise neighboring samples left and above to the current block.
   vii. The reordering process may be invoked after the parsing process but before the MV reconstruction process.
b. In one example, the merge candidates in the AGPMList may be reordered.
   i. In one example, at least two merge candidates in AGPMList may be reordered.
   ii. In one example, at least one type of template may be used for AGPMList reordering.
   iii. In one example, a first type of template may only comprise neighboring samples above to the current block.
   iv. In one example, a second type of template may comprise neighboring samples left and above to the current block.
c. In one example, the merge candidates in the LGPMList may be reordered.
   i. In one example, at least two merge candidates in LGPMList may be reordered.
   ii. In one example, at least one type of template may be used for LGPMList reordering.
   iii. In one example, a first type of template may only comprise neighboring samples left to the current block.
   iv. In one example, a second type of template may comprise neighboring samples left and above to the current block.
d. In one example, the merge candidates in the LAGPMList may be reordered.
   i. In one example, at least two merge candidates in LAGPMList may be reordered.
   ii. In one example, at least one type of template may be used for LAGPMList reordering.
   iii. In one example, a first type of the template may only comprise neighboring samples left to the current block.
   iv. In one example, a second type of the template may only comprise neighboring samples above to the current block.
   v. In one example, a third type of the template may comprise neighboring samples left and above to the current block.
e. In one example, whether to and/or how to reorder merge candidates in a GPM list may be dependent on the coding information.
   i. In one example, whether to reorder merge candidates in a GPM list may be dependent on whether a template matching based motion refinement is applied to a GPM partition or two GPM partitions (i.e. a GPM coded CU).
      (i) For example, if the motion of a GPM partition or two GPM partitions (i.e. a GPM coded CU) is NOT refined based on template matching (e.g., the template matching flag is equal to false), the corresponding GPM list may NOT be reordered.
         a) For example, if a GPM partition is coded using a merge candidate in OGPMList (e.g., no motion refinement is applied), then merge candidates in OGPMList may NOT be reordered.
      (ii) For example, if the motion of a GPM partition or two GPM partitions (i.e. a GPM coded CU) is refined based on template matching (e.g., the template matching flag is equal to true), the corresponding GPM list may be reordered.
         a) For example, if a GPM partition is coded using a merge candidate in AGPMList (e.g., template matching motion refinement method using above template is applied), then merge candidates in AGPMList may be reordered.
         b) For example, if a GPM partition is coded using a merge candidate in LGPMList (e.g., template matching motion refinement method using left template is applied), then merge candidates in LGPMList may be reordered.
         c) For example, if a GPM partition is coded using a merge candidate in LAGPMList (e.g., template matching motion refinement method using left and above template is applied), then merge candidates in LAGPMList may be reordered.
   ii. In one example, how to reorder merge candidates in a GPM list may be dependent on the GPM partition information (e.g., partition mode, partition angle, partition distance, etc.).
      (i) For example, above template may be used for the merge candidates reordering in case that the current GPM partition is split by a first partition angle (or partition mode, or partition distance, etc.).
      (ii) For example, left template may be used for the merge candidates reordering in case that the current GPM partition is split by a second partition angle (or partition mode, or partition distance, etc.).
      (iii) For example, left and above template may be used for the merge candidates reordering in case that the current GPM partition is split by a third partition angle (or partition mode, or partition distance, etc.).
      (iv) For example, a type of template may be specified corresponding to the first/second/third partition angle (or partition mode, or partition distance, etc.).
      (v) For example, at least one look-up table (i.e., mapping table) is used to map what specified partition angles (or partition modes, or partition distances, etc.) corresponding to what type of template (e.g., above template, left template, or above and left template).
f. In one example, the merge candidates in the OGPMList may be not reordered and the merge candidates in the AGPMList and/or LGPMList and/or LAGPMList may be reordered.

2. The merge candidates can be adaptively rearranged in the final GPM candidate list according to one or some criterions.
a. In one example, the GPM candidate list may be
   i. OGPMList
   ii. AGPMList
   iii. LGPMLIst
   iv. LAGPMList
b. The GPM candidates may be divided into several subgroups.
   i. For example, the number of GPM candidates (such as X=3 or 5 or any other integer values) in a subgroup may be pre-defined.
c. In one example, partial or full process of current GPM candidate list construction process is firstly invoked, followed by the reordering of candidates in the GPM list.
   i. Alternatively, candidates in a first subgroup may be reordered and they should be added before those candidates in a second subgroup wherein the first subgroup is added before the second subgroup.
   ii. The construction process may include a pruning method.
d. In one example, the merge candidates may be adaptively rearranged before retrieving the merge candidates.
   i. In one example, the procedure of arranging merge candidates adaptively may be processed before obtaining the merge candidate to be used in the motion compensation process.
e. The criterion may be based on template matching cost.
   i. In one example, the cost function between current template and reference template may be
      (i) SAD/MR-SAD
      (ii) SATD/MR-SATD
      (iii) SSD/MR-SSD
      (iv) SSE/MR-SSE
      (v) Weighted SAD/weighted MR-SAD
      (vi) Weighted SATD/weighted MR-SATD
      (vii) Weighted SSD/weighted MR-SSD
      (viii) Weighted SSE/weighted MR-SSE
      (ix) Gradient information

3. When deriving the two motions for two geometric partitions, the process may be
a. In one example, if TM is not applied to one partition, the motion can be derived according to the signalled merge index from the OGPMList/reordered OGPMList.
b. In one example, if TM is applied to one partition, the motion can be derived according to the signalled merge index from the AGPMList/reordered AGPMList or LGPMList/reordered LGPMLIst or LAGPMList/reordered LAGPMLIst dependent on partition angle and partition index.
   i. In one example, if partition angle is X (e.g., 0), for the first partition, AGPMList/reordered AGPMList will be used; for the second partition, LAGPMList/reordered LAGPMLIst will be used.
c. In one example, if TM is applied to one partition, the motion can be derived according to the signalled merge index from the AGPMList/reordered AGPMList.
d. In one example, if TM is applied to one partition, the motion can be derived according to the signalled merge index from the LGPMList/reordered LGPMLIst.
e. In one example, if TM is applied to one partition, the motion can be derived according to the signalled merge index from the LAGPMList/reordered LAGPMLIst.

4. Whether to and/or how to reorder the GPM candidates may depend on the category of the GPM candidates.
a. In one example, only GPM-parity-based candidates can be reordered.
b. In one example, only GPM-parity-based and GPM-anti-parity-based candidates can be reordered.
c. In one example, the GPM-filled candidates may not be reordered.
d. In one example, two candidates in different GPM lists cannot be compared and/or reordered.
e. In one example, only the first N GPM candidates can be reordered.
   i. In one example, N is set equal to 5.

5. In above examples, the GPM coded block may be a GPM coded block with merge mode, a GPM coded block with AMVP mode.
a. Alternatively, furthermore, the merge candidate mentioned above may be replaced by an AMVP candidate.

### General Claims

6. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

7. Whether to and/or how to apply the disclosed methods above may be signalled at PB/TB/CB/PU/TU/CU/VPDU/CTU/CTU row/slice/tile/sub-picture/other kinds of region containing more than one samples or pixels.

8. Whether to and/or how to apply the disclosed methods above may be dependent on coded information, such as coding mode, block size, GPM partition information, colour format, single/dual tree partitioning, colour component, slice/picture type.

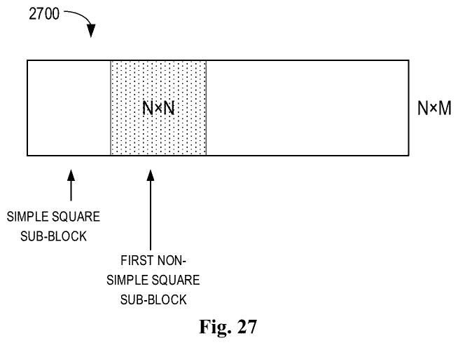

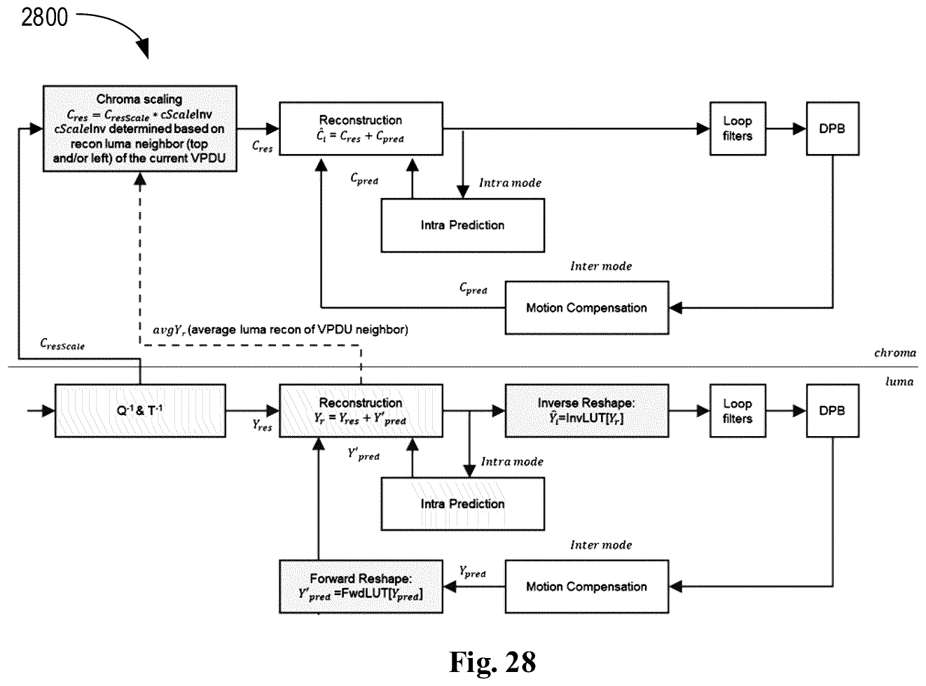

2.20. Hash Based Motion Estimation for Screen Content Coding The VTM reference software uses hash-based motion estimation to handle the sometimes large and irregular motion in screen content. For each reference picture, hash tables corresponding to 4×4 to 64×64 block sizes are generated using a bottom-up approach as follows:
For each 2×2 block, the block hash value is calculated directly from the original sample values (luma samples are used if 4:2:0 chroma format and both luma and chroma sample values are used if 4:4:4 chroma format). The cyclic redundancy check (CRC) value is used as the hash value.
For 4×4, 8×8, 16×16, 32×32 and 64×64 blocks, the hash value of the current block is the CRC value calculated from the CRC values of its four subblocks.
   To enable efficient search for matched blocks, the structure of inverted index is used, where hash values are used as to index into a table, and the table entries contain all the blocks with the same hash value as the corresponding table index. The blocks corresponding a given table index are stored as a linked list. Two CRC values, one 16-bit hash and the other 24-bit hash, are calculated for each block. The two hash values are calculated in a similar way but using different CRC truncated polynomials. The first 16-bit CRC value is used as the inverted index. The second 24-bit hash value is stored together with the blocks to resolve hash conflicts in the case more than one matching blocks are found. To reduce the length of the hash table, the hash values of all “simple” blocks (defined as a block with only one sample value in each row or column) are excluded from the hash table.
   In motion estimation, if the current block is a square block (except for 128×128 blocks), its hash values are calculated. Then, the encoder queries the corresponding hash table. If hash match is found, the matched block is used as the reference. If the current block is a rectangle block of size N×M (and without loss of generality assume M>N), it will be divided into several non-overlapping square subblocks of size N×N. FIG. 27 illustrates an example diagram 2700 showing motion estimation for rectangular block with hash values for square subblocks. The encoder will find the first non-simple square subblock and calculate its hash values. Encoder queries the hash values of this N×N square subblock on the hash table corresponding to N×N block size. The one or more matched reference blocks are considered reference block candidates. For each matched reference block candidate, encoder will continue to check whether the hash values of the remaining square subblocks (namely the white region that follows the first non-simple square subblock depicted in FIG. 27) are equal to those of the square subblocks adjacent to that reference block candidate. If the hash values of all square subblocks are matched, the reference block candidate will be regarded as a valid reference block.
   For inter coding, the hash-based motion search is performed before testing all coding modes. In addition, encoder will reuse the MVs of the hash mode as the starting point candidates in the normal motion estimation process. If the hash-based motion vector exists, which indicates that the block most likely contains screen content, fractional motion estimation is skipped.
   To accelerate the encoder, coding modes other than the skip and merge part of ETM_MERGE_SKIP, ETM_AFFINE, and ETM_MERGE_GPM modes and finer-granularity block splitting are skipped if all of the following conditions are satisfied:
Current block size is 64×64, 128×64 or 64×128.
An identical reference block is found in a reference picture.
The QP of reference picture is not larger than that of current picture.
   2.21. Luma Mapping with Chroma Scaling (LMCS)
   In VVC, a coding tool called the luma mapping with chroma scaling (LMCS) is added as a new processing block before the loop filters. LMCS has two main components: 1) in-loop mapping of the luma component based on adaptive piecewise linear models; 2) for the chroma components, luma-dependent chroma residual scaling is applied. FIG. 28 illustrates example luma mapping with chroma scaling architecture 2800. FIG. 28 shows the LMCS architecture from decoder's perspective. The light-blue shaded blocks in FIG. 28 indicate where the processing is applied in the mapped domain; and these include the inverse quantization, inverse transform, luma intra prediction and adding of the luma prediction together with the luma residual. The unshaded blocks in FIG. 28 indicate where the processing is applied in the original (i.e., non-mapped) domain; and these include loop filters such as deblocking, ALF, and SAO, motion compensated prediction, chroma intra prediction, adding of the chroma prediction together with the chroma residual, and storage of decoded pictures as reference pictures. The light-yellow shaded blocks in FIG. 28 are the new LMCS functional blocks, including forward and inverse mapping of the luma signal and a luma-dependent chroma scaling process. Like most other tools in VVC, LMCS can be enabled/disabled at the sequence level using an SPS flag.
   2.21.1 Luma Mapping with Piecewise Linear Model
   The in-loop mapping of the luma component adjusts the dynamic range of the input signal by redistributing the codewords across the dynamic range to improve compression efficiency. Luma mapping makes use of a forward mapping function, FwdMap, and a corresponding inverse mapping function, InvMap. The FwdMap function is signalled using a piecewise linear model with 16 equal pieces. InvMap function does not need to be signalled and is instead derived from the FwdMap function.
   The luma mapping model is signalled in the adaptation parameter set (APS) syntax structure with aps_params_type set equal to 1 (LMCS_APS). Up to 4 LMCS APS's can be used in a coded video sequence. Only 1 LMCS APS can be used for a picture. The luma mapping model is signalled using piecewise linear model. The piecewise linear model partitions the input signal's dynamic range into 16 equal pieces, and for each piece, its linear mapping parameters are expressed using the number of codewords assigned to that piece. Take 10-bit input as an example. Each of the 16 pieces will have 64 codewords assigned to it by default. The signalled number of codewords is used to calculate the scaling factor αnd adjust the mapping function accordingly for that piece. At the slice level, an LMCS enable flag is signalled to indicate if the LMCS process as depicted in FIG. 28 is applied to the current slice. If LMCS is enabled for the current slice, an aps_id is signalled in the slice header to identify the APS that carries the luma mapping parameters.
   Each i-th piece, i=0 . . . 15, of the FwdMap piecewise linear model is defined by two input pivot points InputPivot[ ] and two output (mapped) pivot points MappedPivot[ ].
   The InputPivot[ ] and MappedPivot[ ] are computed as follows (assuming 10-bit video):
1) OrgCW=64
2) For i=0:16, InputPivot[i]=i*OrgCW
3) For i=0:16, MappedPivot[i] is calculated as follows:

$$MappedPivot [ 0 ] = 0 ;$$

$$for ( i = 0 ; i < 16 ; i + + )$$

$$MappedPivot [ i + 1 ] = MappedPivot [ i ] + SignalledCW [ i ]$$

where SignalledCW[i] is the signalled number of codewords for the i-th piece.
As shown in FIG. 28, for an inter-coded block, motion compensated prediction is performed in the mapped domain. In other words, after the motion-compensated prediction block Y_{pred} is calculated based on the reference signals in the DPB, the FwdMap function is applied to map the luma prediction block in the original domain to the mapped domain, Y′_{pred}=FwdMap(Y_{pred}). For an intra-coded block, the FwdMap function is not applied because intra prediction is performed in the mapped domain. After reconstructed block Yᵣ is calculated, the InvMap function is applied to convert the reconstructed luma values in the mapped domain back to the reconstructed luma values in the original domain (Ŷᵢ=InvMap(Yᵣ)). The InvMap function is applied to both intra- and inter-coded luma blocks.
The luma mapping process (forward and/or inverse mapping) can be implemented using either look-up-tables (LUT) or using on-the-fly computation. If LUT is used, then FwdMapLUT and InvMapLUT can be pre-calculated and pre-stored for use at the tile group level, and forward and inverse mapping can be simply implemented as FwdMap(Y_{pred})=FwdMapLUT[Y_{pred}] and InvMap(Yᵣ)=InvMapLUT[Yᵣ], respectively. Alternatively, on-the-fly computation may be used. Take forward mapping function FwdMap as an example. In order to figure out the piece to which a luma sample belongs, the sample value is right shifted by 6 bits (which corresponds to 16 equal pieces).
Then, the linear model parameters for that piece are retrieved and applied on-the-fly to compute the mapped luma value. Let i be the piece index, a1, a2 be InputPivot[i] and InputPivot[i+1], respectively, and b1, b2 be MappedPivot[i] and MappedPivot[i+1], respectively. The FwdMap function is evaluated as follows:

$$FwdMap ( {Y}_{pred} ) = ( ( b 2 - b 1 ) / ( a 2 - a 1 ) ) * ( {Y}_{pred} - a 1 ) + b 1$$

The InvMap function can be computed on-the-fly in a similar manner. Generally, the pieces in the mapped domain are not equal sized, therefore the most straightforward inverse mapping process would require comparisons in order to figure out to which piece the current sample value belongs. Such comparisons increase decoder complexity. For this reason, VVC imposes a bistream constraint on the values of the output pivot points MappedPivot[i] as follows. Assume the range of the mapped domain (for 10-bit video, this range is [0, 1023]) is divided into 32 equal pieces. If MappedPivot[i] is not a multiple of 32, then MappedPivot[i+1] and MappedPivot[i] cannot belong to the same piece of the 32 equal-sized pieces, i.e. MappedPivot[i+1]>>(BitDepth_{Y}-5) shall not be equal to MappedPivot[i]>>(BitDepth_{Y}-5). Thanks to such bitstream constraint, the InvMap function can also be carried out using a simple right bit-shift by 5 bits (which corresponds 32 equal-sized pieces) in order to figure out the piece to which the sample value belongs.

### 2.21.2 Luma-Dependent Chroma Residual Scaling

Chroma residual scaling is designed to compensate for the interaction between the luma signal and its corresponding chroma signals. Whether chroma residual scaling is enabled or not is also signalled at the slice level. If luma mapping is enabled, an additional flag is signalled to indicate if luma-dependent chroma residual scaling is enabled or not. When luma mapping is not used, luma-dependent chroma residual scaling is disabled. Further, luma-dependent chroma residual scaling is always disabled for the chroma blocks whose area is less than or equal to 4.
Chroma residual scaling depends on the average value of top and/or left reconstructed neighbouring luma samples of the current VPDU. If the current CU is inter 128×128, inter 128×64 and inter 64×128, then the chroma residual scaling factor derived for the CU associated with the first VPDU is used for all chroma transform blocks in that CU. Denote avgYr as the average of the reconstructed neighbouring luma samples (see FIG. 28). The value of C_{ScaleInv} is computed in the following steps:
1) Find the index Y_{idx} of the piecewise linear model to which avgYr belongs based on the InvMap function.
2) C_{ScaleInv}=cScaleInv[Y_{Idx}], where cScaleInv[ ] is a 16-piece LUT pre-computed based on the value of SignalledCW[i] and a offset value signalled in APS for chroma residual scaling process.
   Unlike luma mapping, which is performed on the sample basis, C_{ScaleInv} is a constant value for the entire chroma block. With C_{ScaleInv}, chroma residual scaling is applied as follows:

$$Encoder side : {C}_{ResScale} = {C}_{Res} * {C}_{Scale} = {C}_{Res} / {C}_{ScaleInv}$$

$$Decoder side : {C}_{Res} = {C}_{ResScale} / {C}_{Scale} = {C}_{ResScale} * {C}_{ScaleInv}$$

### 2.21.3 Encoder-Side LMCS Parameter Estimation

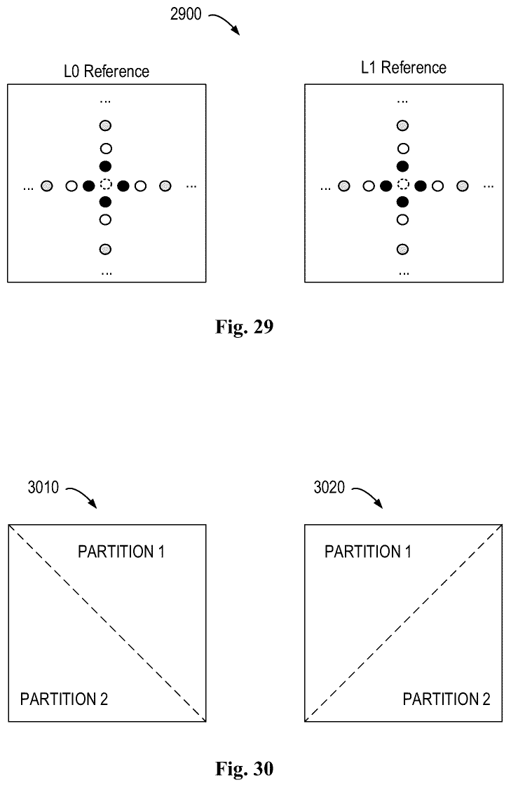

A non-normative reference implementation is provided in the VTM encoder to estimate the LMCS model parameters. Because VTM anchors handle SDR, HDR PQ and HDR HLG differently, the reference algorithm in VTM13 is designed differently for SDR, HDR PQ and HDR HLG sequences. For SDR and HDR HLG sequences, the encoder algorithm is based on local luma variance and optimized for PSNR metrics. For HDR PQ sequences, the encoder algorithm is based on luma values and optimized for wPSNR (weighted PSNR) metrics.
2.22. Merge Mode with MVD (MMVD) In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.
In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.
Distance index specifies motion magnitude information and indicate the pre-defined offset from the starting point. FIG. 29 illustrates a diagram 2900 of an example of MMVD search point. As shown in FIG. 29, an offset is added to either horizontal component or vertical component of a starting MV. The relation of distance index and pre-defined offset is specified in Table 2.

TABLE 2
The relation of distance index and pre-defined offset

| Distance IDX | 0 | 1 | 2 | 3 | 4 | 5 | 6 | 7 |
|---|---|---|---|---|---|---|---|---|
| Offset (in unit | ¼ | ½ | 1 | 2 | 4 | 8 | 16 | 32 |
| of luma sample) | | | | | | | | |

Direction index represents the direction of the MVD relative to the starting point. The direction index can represent of the four directions as shown in Table 3. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 3 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 3 specifies the sign of MV offset added to the list0 MV component of starting MV and the sign for the list1 MV has opposite value. Otherwise, if the difference of POC in list 1 is greater than list 0, the sign in Table 3 specifies the sign of MV offset added to the list1 MV component of starting MV and the sign for the list0 MV has opposite value.
The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 6. If the POC difference of L1 is greater than L0, the MVD for list 0 is scaled in the same way. If the starting MV is uni-predicted, the MVD is added to the available MV.
MMVD is also known as Ultimate Motion Vector Expression (UMVE).

TABLE 3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.23. Triangle Partition for Inter Prediction

In VVC, a triangle partition mode (TPM) is supported for inter prediction. The triangle partition mode is only applied to CUs that are 8×8 or larger. The triangle partition mode is signalled using a CU-level flag as one kind of merge mode, with other merge modes including the regular merge mode, the MMVD mode, the CIIP mode and the subblock merge mode.
When this mode is used, a CU is split evenly into two triangle-shaped partitions, using either the diagonal split or the anti-diagonal split (FIG. 30). In the example of triangle partition based inter prediction shown in FIG. 30, a CU 3010 is split using the diagonal split with triangleDir set to be equal to 0, and a CU 3020 is split using the anti-diagonal split with triangleDir set to be equal to 1. Each triangle partition in the CU is inter-predicted using its own motion; only uni-prediction is allowed for each partition, that is, each partition has one motion vector and one reference index. The uni-prediction motion constraint is applied to ensure that same as the conventional bi-prediction, only two motion compensated prediction are needed for each CU. The uni-prediction motion for each partition is derived using the process described in section 2.23.1.
If triangle partition mode is used for the current CU, then a flag indicating the direction of the triangle partition (diagonal or anti-diagonal), and two merge indices (one for each partition) are further signalled. The number of maximum TPM candidate size is signalled explicitly at slice level and specifies syntax binarization for TMP merge indices. After predicting each of the triangle partitions, the sample values along the diagonal or anti-diagonal edge are adjusted using a blending processing with adaptive weights. This is the prediction signal for the whole CU, and transform and quantization process will be applied to the whole CU as in other prediction modes. Finally, the motion field of a CU predicted using the triangle partition mode is stored as in 2.23.3.

The triangle partition mode is not used in combination with SBT, that is, when the signalled triangle mode is equal to 1, the cu_sbt_flag is inferred to be 0 without signalling.

### 2.23.1 Uni-Prediction Candidate List Construction

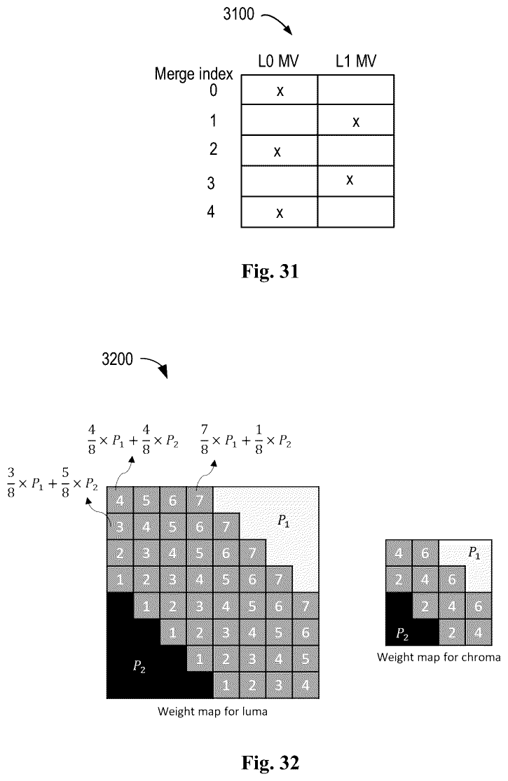

The uni-prediction candidate list is derived directly from the merge candidate list constructed according to the extended merge prediction process in section 2.1. Denote n as the index of the uni-prediction motion in the triangle uni-prediction candidate list. The LX motion vector of the n-th extended merge candidate, with X equal to the parity of n, is used as the n-th uni-prediction motion vector for triangle partition mode. FIG. 31 illustrates a diagram 3100 of uni-prediction MV selection for triangle partition mode. These motion vectors are marked with “x” in FIG. 31. In case a corresponding LX motion vector of the n-the extended merge candidate does not exist, the L(1-X) motion vector of the same candidate is used instead as the uni-prediction motion vector for triangle partition mode.

### 2.23.2 Blending Along the Triangle Partition Edge

After predicting each triangle partition using its own motion, blending is applied to the two prediction signals to derive samples around the diagonal or anti-diagonal edge. FIG. 32 illustrates a diagram 3200 of weights used in the blending process. The following weights are used in the blending process:
,fra ⅞, 6/8, ⅝, 4/8, ⅜, 2/8, 1/81 for luma and { 6/8, 4/8, 2/8} for chroma, as shown in FIG. 32.

### 2.23.3 Motion Field Storage

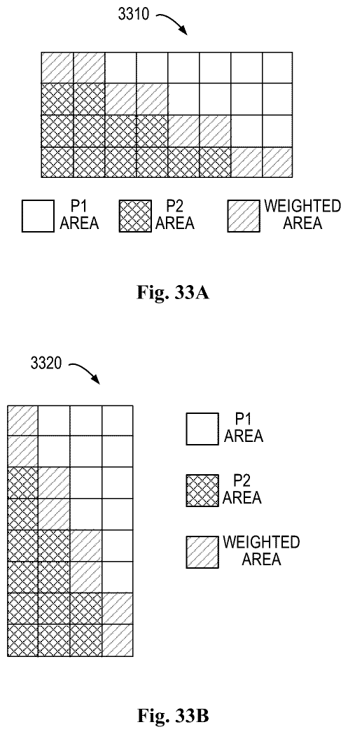

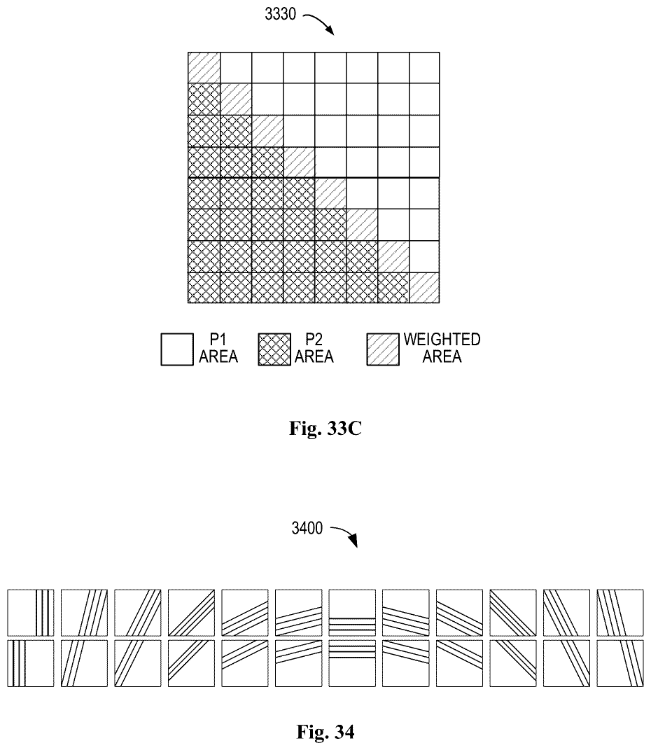

FIGS. 33A-33C illustrate three example MV storage areas for triangleDir equal to 0, where FIG. 33A shows a 32×16 block 3310, FIG. 33B shows a 16×32 block 3320, and FIG. 33C shows a 32×32 block 3330. The motion vectors (Mv1 and Mv2 in FIGS. 33A-33C) of the triangular prediction units are stored in 4×4 grids. For each 4×4 grid, either uni-prediction or bi-prediction motion vector is stored depending on the position of the 4×4 grid in the CU. As shown in FIGS. 33A-33C, uni-prediction motion vector, either Mv1 or Mv2, is stored for the 4×4 grid located in the non-weighted area (that is, not located at the diagonal edge). On the other hand, a bi-prediction motion vector is stored for the 4×4 grid located in the weighted area. The bi-prediction motion vector is derived from Mv1 and Mv2 according to the following rules:
1) If Mv1 and Mv2 are from different reference picture lists (one from L0 and the other from L1), then Mv1 and Mv2 are simply combined to form the bi-prediction motion vector.
2) Otherwise, if Mv1 and Mv2 are from the same list, only uni-prediction motion Mv2 is stored.
   2.23.4 Motion Vector Storing Process for Triangle Merge Mode (Alternative description)

The variables numSbX and numSbY specifying the number of 4×4 blocks in the current coding block in horizontal and vertical direction are set equal to numSbX=cbWidth>>2 and numSbY=cbHeight>>2.

Where cbWidth and cbHeight specifying the width and the height of the current coding block in luma samples,
The variable minSb is set equal to min(numSbX, numSbY)-1.
The variable cbRatio is derived as follows:

$$cbRatio = ( cbWidth > cbHeight ) ? ( cbWidth / cbHeight ) : ( cbHeight / cbWidth )$$

For each 4×4 subblock at subblock index (xSbIdx, ySbIdx) with xSbIdx=0..numSbX −1, and ySbIdx=0..numSbY −1, the following applies:
The variables xIdx and yIdx are derived as follows:

$$\begin{matrix}xIdx = ( cbWidth > cbHeight ) ? ( xSbIdx / cbRatio ) : xSbIdx \\ yIdx = ( cbWidth > cbHeight ) ? ySbIdx : ( ySbIdx / cbRatio )\end{matrix}$$

The variable sType is derived as follows:
   If triangleDir is equal to 0, the following applies:

$$sType = ( xIdx == yIdx ) ? 2 : ( ( xIdx > yIdx ) ? 0 : 1 )$$

Otherwise (triangleDir is equal to 1), the following applies:

$$sType = ( xIDx + yIdx == minSb ) ? 2 : ( ( xIdx + yIdx < minSb ) ? 0 : 1 )$$

where triangleDir specifies the partition direction.
As shown in FIGS. 33A-33C, sType equal to 0 corresponds to P1 area; sType equal to 1 corresponds to P2 area; sType equal to 2 corresponds to the weighted area.
The motion information of P1 area is denoted as (Mv1,refIdx1); the motion information of P2 area is denoted as (Mv2,refIdx2).
Depending on the value of sType, the following assignments are made:
   If sType is equal to 0, the motion information of the 4×4 subblock is (Mv1,refldx1).
   If sType is equal to 1, the motion information of the 4×4 subblock is (Mv2,refJdx2).
   Otherwise (sType is equal to 2), the following applies:
      1) If Mv1 and Mv2 are from different reference picture lists (one from L0 and the other from L1), then Mv1 and Mv2 are simply combined to form the bi-prediction motion vector.
      2) Otherwise, if Mv1 and Mv2 are from the same list, only uni-prediction motion Mv2 is stored.

### 2.24. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w× h=2^{m}×2ⁿ with m, n ϵ{3···6} excluding 8×64 and 64×8.
FIG. 34 illustrates a diagram 3400 of examples of the GPM splits grouped by identical angles. When this mode is used, a CU is split into two parts by a geometrically located straight line (FIG. 34). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in section 2.24.1.
If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 2.24.2. This is the prediction signal for the whole CU, and transform and quantization process will be applied to the whole CU as in other prediction modes. Finally, the motion field of a CU predicted using the geometric partition modes is stored as in section 2.24.3.

### 2.24.1 Uni-Prediction Candidate List Construction

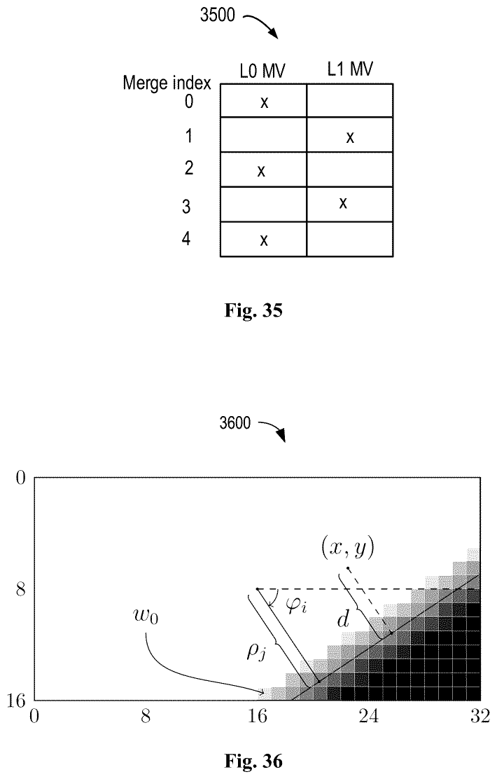

The uni-prediction candidate list is derived directly from the merge candidate list constructed according to the extended merge prediction process in 3.4.1. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. FIG. 35 illustrates a diagram 3500 of uni-prediction MV selection for geometric partitioning mode. These motion vectors are marked with “x” in FIG. 35. In case a corresponding LX motion vector of the n-the extended merge candidate does not exist, the L(1-X) motion vector of the same candidate is used instead as the uni-prediction motion vector for geometric partitioning mode.
2.24.2 Blending along the geometric partitioning edge
After predicting each part of a geometric partition using its own motion, blending is applied to the two prediction signals to derive samples around geometric partition edge. The blending weight for each position of the CU are derived based on the distance between individual position and the partition edge.
The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 1 )$$

$${ρ}_{j} = {ρ}_{x , j} cos ( {φ}_{i} ) + {ρ}_{y , j} sin ( {φ}_{i} ) \qquad ( 2 - 2 )$$

$${ρ}_{x , j} \{ \begin{matrix}0 & i \% 16 = 8 or ( i \% 16 \neq 0 and h \geq w ) \\ \pm ( j \times w ) >> 2 & otherwise\end{matrix} \qquad ( 2 - 3 )$$

$${ρ}_{y , j} \{ \begin{matrix}\pm ( j \times w ) >> 2 & i \% 16 = 8 or ( i \% 16 \neq 0 and h \geq w ) \\ 0 & otherwise\end{matrix} \qquad ( 2 - 4 )$$

where i,j are the indices for angle and offset of a geometric partition, which depend on the signaled geometric partition index. The sign of p_{x,j} and p_{y,j} depend on angle index i.
The weights for each part of a geometric partition are derived as following:

$$wIdxL ( x , y ) = partIdx ? 32 + d ( x , y ) : 32 - d ( x , y ) \qquad ( 2 - 5 )$$

$${w}_{0} ( x , y ) = \frac{Clip 3 ( 0 , 8 , ( wIdxL ( x , y ) + 4 ) >> 3 )}{8} \qquad ( 2 - 6 )$$

$${w}_{1} ( x , y ) = 1 - {w}_{0} ( x , y ) \qquad ( 2 - 7 )$$

The partIdx depends on the angle index i. FIG. 36 illustrates a diagram 3600 of exemplified generation of a bending weight w_0 using geometric partitioning mode. One example of weigh w₀ is illustrated in FIG. 36.

### 2.24.3 Motion Field Storage for Geometric Partitioning Mode

Mv1 from the first part of the geometric partition, Mv2 from the second part of the geometric partition and a combined My of Mv1 and Mv2 are stored in the motion filed of a geometric partitioning mode coded CU.
The stored motion vector type for each individual position in the motion filed are determined as:

$$sType = abs ( motionIdx ) < 32 ? 2 : motionIdx \leq 0 ? ( 1 - partIdx ) : partIdx ) \qquad ( 2 - 8 )$$

where motionIdx is equal to d(4×+2, 4y+2), which is recalculated from equation (2-1). The partidx depends on the angle index i.
If sType is equal to 0 or 1, Mv1 or Mv2 are stored in the corresponding motion field, otherwise if sType is equal to 2, a combined My from Mv1 and Mv2 are stored. The combined My are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### 2.25. Combined Inter and Intra Prediction (CIIP)

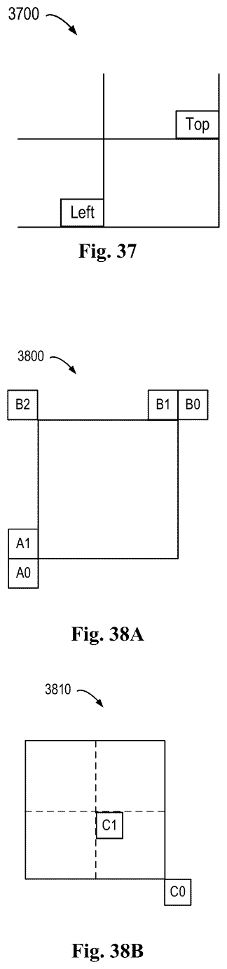

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pinter is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in a diagram 3700 in FIG. 37) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.
   The CIIP prediction is formed as follows:

$${P}_{CIIP} = ( ( 4 - wt ) * {P}_{inter} + wt * {P}_{intra} + 2 ) >> 2$$

### 2.26. Decoder Side Intra Mode Derivation (DIMD)

When DIMD is applied, two intra modes are derived from the reconstructed neighbor samples, and those two predictors are combined with the planar mode predictor with the weights derived from the gradients.
Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 2.27. IBC Motion Candidates

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

For an IBC coded block, a block vector (BV) is used to indicate the displacement from the current block to a reference block, which is already reconstructed inside the current picture.

W and H are the width and height of current block (e.g., luma block).

The non-adjacent spatial candidates of current coding block are adjacent spatial candidates of a virtual block in the ith search round (as shown in FIG. 9). The width and height of the virtual block for the ith search round are calculated by: newWidth=ix2×gridX+W, newHeight=ix2×gridY+H. Obviously, the virtual block is the current block if the search round i is 0.

In the following, a BV predictor also is a BV candidate. The skip mode also is the merge mode.

The BV candidates can be divided into several groups according to some criterions. Each group is called a subgroup. For example, we can take adjacent spatial and temporal BV candidates as a first subgroup and take the remaining BV candidates as a second subgroup; In another example, we can also take the first N (N>2) BV candidates as a first subgroup, take the following M (M>2) BV candidates as a second subgroup, and take the remaining BV candidates as a third subgroup.

On usage of a BV candidate

1. A BV candidate (e.g. BV searching point or BV predictor) is disallowed to be used in the coding/decoding process of a block if it is invalid.
a. In one example, only if a BV candidate is valid, it may be used in the coding/decoding process of a block.
   i. For example, only if a BV candidate is valid, it may be used for BV search or BV prediction.
b. In one example, whether to use a BV candidate in the coding/decoding process of a block may be dependent on a validation check of the BV candidate.
   i. In one example, before inserting a new BV candidate into a BV candidate list, a validation check of the BV candidate needs to be performed.
c. Only if a BV candidate is valid, it may be inserted into an IBC candidate list.
   i. In one example, the IBC candidate list may be the IBC merge candidate list.
   ii. In one example, the IBC candidate list may be the IBC AMVP candidate list.
   iii. In one example, the IBC candidate list may be the IBC template matching candidate list.
   iv. In one example, the IBC candidate list may be the intra template matching candidate list.
d. Only if a BV candidate is valid, it may be used for hash-based search for IBC.
e. Only if a BV candidate is valid, it may be used for block matching based local search for IBC.
f. Only if a BV candidate is valid, it may be used for intra template matching.
g. Alternatively, furthermore, the above mentioned BV candidates may be those from specific neighboring blocks (e.g., adjacent or non-adjacent) or HMVP tables or some virtual candidates generated from these BV candidates.
h. Alternatively, furthermore, the above mentioned BV candidates may exclude some default candidates (e.g., the default zero vectors).
i. Alternatively, furthermore, when a BV candidate is marked as invalid, a virtual candidate derived from the invalid BV candidate may be used instead.
   i. In one example, the virtual candidate may be derived by adding an offset to the invalid BV candidate.
   ii. In one example, the virtual candidate may be derived by applying a clipping function to the invalid BV candidate.

### On Validation Check of a BV Candidate

2. In one example, a BV candidate may be determined to be valid when it meets one of or a combination of at least one of the following conditions.
a. The corresponding reference block is already reconstructed inside the current picture.
b. The corresponding reference block is located in the same CTU row as current block.
c. The corresponding reference block is located in the same tile/subpicture as current block.
d. The corresponding reference block is located in the same slice as current block.
e. The BV candidate satisfies the block vector constraints (e.g. which is described in 2.4.2 and 2.4.3).
f. The BV candidate satisfies the IBC virtual buffer conditions (e.g. which is described in 2.4.4).

3. In one example, a BV candidate may be determined to be invalid when it violates one of or a combination of at least one of the conditions in bullet 2.

### On BV Candidate List

4. A BV candidate may be derived/obtained from a non-adjacent block.
a. In one example, the distances between non-adjacent spatial candidates and current coding block may be based on the width and height of current coding block (e.g. FIG. 9 or FIG. 10, gridX=W, gridY=H).
   i. Alternatively, the distances between non-adjacent spatial candidates and current coding block may be multiple of a constant value.
      (i) For example, the multiplication factor is dependent on the search round index (e.g. the multiplication factor is i for the ith search round) and gridX=M, gridY=N (M and N are constant values).
b. In one example, the non-adjacent spatial candidates may be inserted after the TMVP candidate.
   i. Alternatively, the non-adjacent spatial candidates may be inserted after the adjacent spatial candidates and before TMVP candidate.

5. A BV candidate may come from a spatial neighboring block, a temporal neighboring block, HMVP, pairwise, and/or STMVP candidates. FIGS. 38A-38B illustrates example candidate positions for spatial candidate and temporal candidate.
a. In one example, the spatial candidates may consist of adjacent and/or non-adjacent spatial candidates.
   i. In one example, the adjacent spatial candidates may consist of left and/or above and/or above-right and/or bottom-left and/or above-left spatial candidates (an example of candidate positions for spatial candidate is shown in a diagram 3800 of FIG. 38A).
b. In one example, for the TMVP candidate, the position for the temporal candidate is selected between candidates C0 and C1, as depicted in a diagram 3810 of FIG. 38B. If CU at position C0 is not available, is intra coded, is outside of the current row of CTUs or its BV is invalid for current block, position C1 is used. Otherwise, position C0 is used in the derivation of the TMVP candidate.
   i. Alternatively, for the TMVP candidate, both candidates C0 and C1, as depicted in FIG. 38B, can be used.
      (i) For example, the order is C0->C1.
      (ii) Alternatively, the order is C1->C0.
c. In one example, for the pairwise candidate, pairwise average candidates are generated by averaging predefined pairs of candidates in the existing BV candidate list, and the predefined pairs are defined as {(0, 1), (0, 2), (1, 2), (0, 3), (1, 3), (2, 3)}, where the numbers denote the BV candidate indices to the BV candidate list.
   i. In one example, the number of pairwise candidates is P. P is an integer from 0 to 6.
   ii. In one example, the pairwise candidates may be inserted after HMVP.
d. In one example, for the STMVP candidate, it is generated by averaging predefined E spatial BV candidates and predefined G temporal BV candidates.
   i. In one example, E is less than or equal to the number of spatial candidates (F) inserted into the current BV candidate list before STMVP.
   ii. In one example, the predefined E spatial BV candidates may be the first E spatial BV candidates among the F spatial candidates inserted into the current BV candidate list before STMVP.
      (i) Alternatively, the predefined E spatial BV candidates may be the selected E spatial BV candidates among the F spatial candidates inserted into the current BV candidate list before STMVP.
   iii. In one example, E is 2, G is 1.
   iv. In one example, STMVP may be inserted before the above-left spatial BV candidate.
   v. In one example, STMVP may be inserted after the pairwise candidate.
e. In one example, the BV candidate inserting order is adjacent spatial->HMVP ->pairwise.
f. In one example, the BV candidate inserting order is adjacent spatial->temporal->HMVP ->pairwise.
g. In one example, the BV candidate inserting order is adjacent spatial->temporal->non-adjacent spatial->HMVP->pairwise.
h. In one example, the BV candidate inserting order is adjacent spatial->non-adjacent spatial->HMVP->pairwise.
i. In one example, the BV candidate inserting order is adjacent spatial (STMVP is inserted before the above-left spatial BV candidate)->temporal->non-adjacent spatial->HMVP ->pairwise.

6. A BV candidate list may also consist of clipped BV candidates.
a. In one example, if a BV candidate is invalid from the sense of the 3^{rd} bullet, it may be converted to a valid BV following a given rule and then inserted into the BV candidate list.
   i. In one example, a BV candidate may be converted to the nearest valid BV candidate.
   ii. In one example, a BV candidate may be converted to the nearest valid BV candidate from a predefined BV candidate set.
b. In one example, if a non-zero BV candidate is invalid, it may be clipped to the nearest valid BV and then inserted into the BV candidate list.
c. In one example, if a non-zero BV candidate is invalid, it may be clipped to the nearest valid BV from a predefined BV candidate set and then inserted into the BV candidate list.
   i. In one example, the predefined BV candidate set may consist of (−m*W, 0), (0, −n*H), (−m*H, 0), (0, −n*W). m and n are positive values.
d. In one example, the clipped BV candidates may be inserted after the non-clipped BV candidates.

7. The BV candidate list can be used as IBC merge/AMVP candidate list.
a. Alternatively, the BV candidate list can be used to derive IBC merge/AMVP candidate list.
   i. In one example, for IBC merge mode, the first R entries of the BV candidate list will be used to construct the IBC merge candidate list; for IBC AMVP mode, the first S entries of the BV candidate list will be used to construct the IBC AMVP candidate list.
      (i) In one example, R is 6, S is 2.

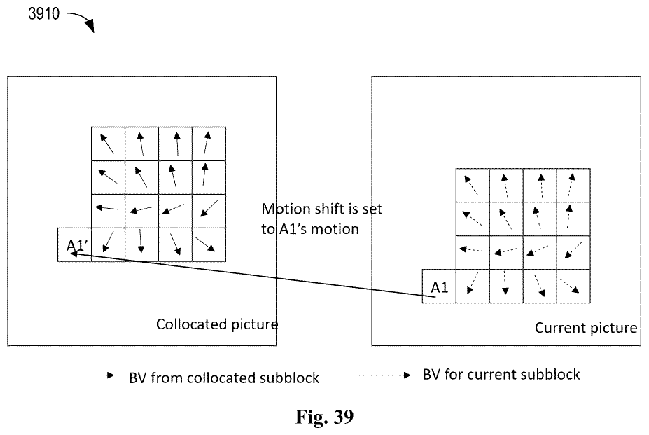

8. In one example, subblock-based temporal block vector prediction (SbTBVP) may be supported as a BV candidate or a BV prediction mode.
a. Similar to the SbTMVP, SbTBVP uses the BV motion field in the collocated picture to improve block vector prediction and IBC merge mode for CUs in the current picture. The same collocated picture used by TMVP is used for SbTBVP.
b. In one example, SbTBVP applies a motion shift before fetching the temporal BV information from the collocated picture, where the motion shift is obtained from the motion vector from one of the spatial neighboring blocks of the current CU (an example is shown in FIG. 39). FIG. 39 illustrates a diagram 391400 of deriving sub-CU by motion field from the corresponding collocated sub-CUs by applying a motion shift from spatial neighbor.
   i. In one example, if A1 has a motion vector that uses the collocated picture as its reference picture, this motion vector is selected to be the motion shift to be applied. If no such motion is identified, then the motion shift is set to (0, 0).
   ii. In one example, other spatial candidate positions (e.g. A0, B0, B1, B2) can be used to derive the motion shift.
      (i) In one example, the checking order may be A1->B1->B0->A0->B2.
      (ii) In one example, the checking order may be B1->A1->B0->A0->B2.
      (iii) In one example, the checking order may be A0->A1->B0->B1->B2.
c. In one example, after deriving the motion shift, for each sub-CU, the BV information of its corresponding block (the smallest motion grid that covers the center sample) in the collocated picture is used to derive the BV information for the sub-CU (The example in FIG. 39) assumes the motion shift set to block A1's motion).
   On reordering of BV candidate list

9. An initial BV candidate list may be firstly derived, followed by a reordering/refined process. And the reordered/refined list is utilized in the coding/decoding process of a block.

10. The BV candidates can be adaptively rearranged in the final BV candidate list according to one or some criterions.
a. In one example, partial or full process of current BV candidate list construction process is firstly invoked, followed by the reordering of candidates in the list.
   i. Alternatively, candidates in a first subgroup may be reordered and they should be added before those candidates in a second subgroup wherein the first subgroup is added before the second subgroup.
b. In one example, the criterion may be based on template matching cost.
   i. In one example, the cost function between current template and reference template may be
      (i) SAD/MR-SAD
      (ii) SATD/MR-SATD
      (iii) SSD/MR-SSD
      (iv) SSE/MR-SSE
      (v) Weighted SAD/weighted MR-SAD
      (vi) Weighted SATD/weighted MR-SATD
      (vii) Weighted SSD/weighted MR-SSD
      (viii) Weighted SSE/weighted MR-SSE
      (ix) Gradient information
   ii. In one example, the current template and reference template may consist of samples in the mapped domain if LMCS is enabled.
      (i) Alternatively, the current template and reference template may consist of samples in the original domain.
   iii. In one example, BV candidates in each subgroup may be reordered ascendingly according to cost values based on template matching.
   iv. In one example, if only above template is available for current block, the template matching reorder can only use the above template.
   v. In one example, if only left template is available for current block, the template matching reorder can only use the left template.
   vi. In one example, if both above and left templates are available for current block, the template matching reorder can use the left template, the above template, or both above and left templates.
   vii. In one example, if the reference template is outside the current picture, the corresponding BV candidate can still be reordered.
      (i) In one example, if the reference template is outside the current picture, it can be padded from the nearest samples inside the current picture.
      viii. In one example, the reference template should be already reconstructed inside the current picture.
      (i) In one example, if the reference template is not reconstructed or outside the current picture, the corresponding BV candidate may be not reordered.
c. In one example, whether to and/or how to reorder the BV candidates may depend on the category of the BV candidates.
d. In one example, the BV candidates to be reordered can be the BV candidates in the final BV candidate list.
   i. Alternatively, the BV candidates to be reordered can be partial/all the adjacent spatial BV candidates even it may not be included in the final BV candidate list.
   ii. Alternatively, the BV candidates to be reordered can be partial/all the non-adjacent spatial BV candidates even it may not be included in the final BV candidate list.
   iii. Alternatively, the BV candidates to be reordered can be partial/all the HMVP BV candidates even it may not be included in the final BV candidate list.
   iv. Alternatively, the BV candidates to be reordered can be partial/all the pairwise average BV candidates even it may not be included in the final BV candidate list.
   v. Alternatively, the BV candidates to be reordered can be partial/all the STMVP BV candidates even it may not be included in the final BV candidate list.

11. In one example, the cost disclosed in bullet 10 may be derived for a first BV candidate, which may be or may not be put into a BV candidate list.
a. In one example, whether to put the first BV candidate into the BV candidate list may depend on the cost derived for the first BV candidate.
b. In one example, whether to put the first BV candidate into the BV candidate list may depend on a comparison between a first cost derived for the first BV candidate and a second cost derived for a second BV candidate, which may be or may not be put into a BV candidate list.

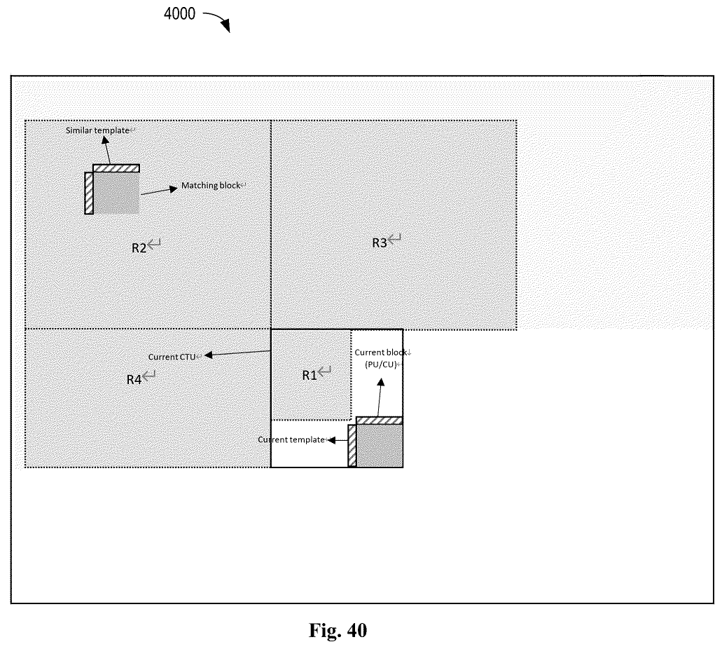

12. In one example, for the intra TMP, the L-shaped template can be replaced with the above and left templates which excluding the above-left part (an example is shown in FIG. 40). FIG. 40 illustrates a diagram 4000 for intra template matching.
a. In one example, if only above template is available for current block, the intra TMP can only use the above template.
b. In one example, if only left template is available for current block, the intra TMP can only use the left template.
c. In one example, if both above and left templates are available for current block, the intra TMP can use the left template, the above template, or both above and left templates.

### 2.28. Multi-Hypothesis Prediction (MHP)

In the multi-hypothesis inter prediction mode (JVET-M0425), one or more additional motion-compensated prediction signals are signaled, in addition to the conventional bi prediction signal. The resulting overall prediction signal is obtained by sample-wise weighted superposition. With the bi prediction signal P_{bi} and the first additional inter prediction signal/hypothesis h₃, the resulting prediction signal P₃ is obtained as follows:

$${p}_{3} = ( 1 - α ) {p}_{bi} + α {h}_{3}$$

The weighting factor α is specified by the new syntax element add_hyp_weight_idx, according to the following mapping:

| add_hyp_weight_idx | α |
|---|---|
| 0 | 1/4 |
| 1 | −⅛ |
| 1 | −⅛ |

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1}$$

The resulting overall prediction signal is obtained as the last pₙ (i.e., the pₙ having the largest index n). Within this EE, up to two additional prediction signals can be used (i.e., n is limited to 2).

The motion parameters of each additional prediction hypothesis can be signaled either explicitly by specifying the reference index, the motion vector predictor index, and the motion vector difference, or implicitly by specifying a merge index. A separate multi-hypothesis merge flag distinguishes between these two signalling modes.

For inter AMVP mode, MHP is only applied if non-equal weight in BCW is selected in bi-prediction mode.

Combination of MHP and BDOF is possible, however the BDOF is only applied to the bi-prediction signal part of the prediction signal (i.e., the ordinary first two hypotheses).

### 2.29. JVET-M0425: Multi-Hypothesis Inter Prediction

In the multi-hypothesis inter prediction mode, one or more additional prediction signals are signaled, in addition to the conventional uni/bi prediction signal. The resulting overall prediction signal is obtained by sample-wise weighted superposition. With the uni/bi prediction signal P_{uni/bi} and the first additional inter prediction signal/hypothesis h₃, the resulting prediction signal P₃ is obtained as follows:

$${p}_{3} = ( 1 - α ) {p}_{uni / bi} + α {h}_{3}$$

The weighting factor α is specified by the new syntax element add_hyp_weight_idx, according to the following mapping:

| add_hyp_weight_idx | α |
|---|---|
| 0 | ¼ |
| 1 | −⅛ |

Note that for the additional prediction signals, in the tests CE10.1.2.a, CE10.1.2.b, and CE10.1.2.d, the concept of prediction list0/list1 is abolished, and instead one combined list is used. This combined list is generated by alternatingly inserting reference frames from list0 and list1 with increasing reference index, omitting reference frames which have already been inserted, such that double entries are avoided. In test CE10.1.2.c, only 2 different reference pictures can be used within each PU, and therefore it is indicated by one flag which reference frame is used.

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1}$$

The resulting overall prediction signal is obtained as the last pₙ (i.e., the pₙ having the largest index n). Within this CE, up to two additional prediction signals can be used (i.e., n is limited to 2). Note that due to the iterative accumulation approach, the number of required PU sample buffers for storing intermediate prediction signals is not increased relative to bi-prediction (i.e., two buffers are sufficient).

### 2.29.1 Multi-Hypothesis Motion Estimation

First, the inter modes with no explicitly signaled additional inter prediction parameters are tested. For the best two of these modes (i.e., having lowest Hadamard RD cost), additional inter prediction hypotheses are searched. For that purpose, for all combinations of the following parameters, a motion estimation with a restricted search range of 16 is performed:
Weighting factor α
Reference frame for the additional prediction hypothesis

For determining the best combination of these two parameters, a simplified RD cost using Hadamard distortion measure and approximated bit rate is used. The chosen parameter combination is then used to compute a more accurate RD cost, using forward transform and quantization, which is compared against the so-far best found coding mode for the current block.

2.29.2 Interaction with Other Coding Tools
2.29.2.1. Normal merge mode (non-MMVD, non-sub-block)
Additional prediction signals can be explicitly signaled, but not in SKIP mode.
Additional prediction signals can also be inherited from spatially neighboring blocks as part of the merging candidate, but this is limited to
   neighboring blocks within the current CTU, or
   neighboring blocks from the left CTU
Additional prediction signals cannot be inherited from the top CTU or from a temporally co-located block.
All explicitly signaled additional prediction signals use the same AMVP candidate list which is generated for the first explicitly signaled additional prediction signal, so there has to be done.
   one merging candidate list construction process
   one AMVP candidate list construction process
The total of explicitly signaled and inherited (merged) additional prediction signals is limited to be less than or equal to 2.

### 2.29.2.2. MMVD

Additional prediction signals can be explicitly signaled, but not in MMVD SKIP mode.
There is no inheritance/merging of additional prediction signals from merging candidates.
All explicitly signaled additional prediction signals use the same AMVP candidate list which is generated for the first explicitly signaled additional prediction signal, so there has to be done
   one MMVD list construction process
   one AMVP candidate list construction process

### 2.29.2.3. Sub-Block Merge Mode

Additional prediction signals can be explicitly signaled, but not in SKIP mode.
There is no inheritance/merging of additional prediction signals from merging candidates.
All explicitly signaled additional prediction signals use the same AMVP candidate list which is generated for the first explicitly signaled additional prediction signal, so there has to be done
   one sub-block merging candidate list construction process
   one AMVP candidate list construction process

### 2.29.2.4. Non-Affine AMVP Mode

Additional prediction signals can be explicitly signaled in case of bi-prediction.
Only two AMVP candidate lists have to be constructed (for the first two, i.e. non-additional prediction signals).
For the additional prediction signals, one of the two AMVP candidate lists is used:
   If the POC of the reference picture of the additional prediction signal equals the POC of the used list1 reference picture, the list1 AMVP candidate list is used.
   Otherwise the list0 AMVP candidate list is used.
      2.29.2.5. Affine AMVP mode
Additional (translational) prediction signals can be explicitly signaled in case of bi-prediction.
Two affine AMVP candidate lists have to be constructed (for the first two, i.e. non-additional prediction signals).
For the additional prediction signals, one of the two AMVP candidate lists is used:
   If the POC of the reference picture of the additional prediction signal equals the POC of the used list1 reference picture, the list1 AMVP candidate list is used.
   Otherwise the list0 AMVP candidate list is used.
The affine LT my predictor is used as the my predictor for the additional prediction signal.

### 2.29.2.6. BIO

Multi-hypothesis inter prediction cannot be used together with BIO within one PU:
If there are additional prediction signals, BIO is disabled for the current PU.

### 2.29.2.7. Combined Intra/Inter

Multi-hypothesis inter prediction cannot be used together with combined intra/inter within one PU:
If combined intra/inter is selected with a merging candidate that has additional prediction signals, those additional prediction signals are not inherited/merged.
Additional prediction signals cannot be explicitly signaled in combined intra/inter mode.

### 2.29.2.8. Triangular Mode

Multi-hypothesis inter prediction cannot be used together with triangular mode within one PU:
If triangular mode is selected with a merging candidate that has additional prediction signals, those additional prediction signals are not inherited/merged.
Additional prediction signals cannot be explicitly signaled in triangular mode.

### 2.30. Overlapped Block Motion Compensation

Overlapped Block Motion Compensation (OBMC) has previously been used in H.263. In the JEM, unlike in H.263, OBMC can be switched on and off using syntax at the CU level. When OBMC is used in the JEM, the OBMC is performed for all motion compensation (MC) block boundaries except the right and bottom boundaries of a CU. Moreover, it is applied for both the luma and chroma components. In the JEM, a MC block is corresponding to a coding block. When a CU is coded with sub-CU mode (includes sub-CU merge, affine and FRUC mode), each sub-block of the CU is a MC block. To process CU boundaries in a uniform fashion, OBMC is performed at sub-block level for all MC block boundaries, where sub-block size is set equal to 4×4, as illustrated in FIG. 41, which illustrates a diagram 4100 of sub-blocks where OBMC applies.

When OBMC applies to the current sub-block, besides current motion vectors, motion vectors of four connected neighbouring sub-blocks, if available and are not identical to the current motion vector, are also used to derive prediction block for the current sub-block. These multiple prediction blocks based on multiple motion vectors are combined to generate the final prediction signal of the current sub-block.

Prediction block based on motion vectors of a neighbouring sub-block is denoted as P_{N}, with N indicating an index for the neighbouring above, below, left and right sub-blocks and prediction block based on motion vectors of the current sub-block is denoted as P_{C}. When P_{N} is based on the motion information of a neighbouring sub-block that contains the same motion information to the current sub-block, the OBMC is not performed from P_{N}. Otherwise, every sample of P_{N} is added to the same sample in P_{C}, i.e., four rows/columns of P_{N} are added to P_{C}. The weighting factors {¼, ⅛, 1/16, 1/32} are used for P_{N} and the weighting factors {¾, ⅞, 15/16, 31/32} are used for P_{C}. The exception are small MC blocks, (i.e., when height or width of the coding block is equal to 4 or a CU is coded with sub-CU mode), for which only two rows/columns of P_{N} are added to P_{C}. In this case weighting factors {¼, 1/81 are used for P_{N} and weighting factors {¾, ⅞} are used for P_{C}. For P_{N} generated based on motion vectors of vertically (horizontally) neighbouring sub-block, samples in the same row (column) of P_{N} are added to Pc with a same weighting factor.

In the JEM, for a CU with size less than or equal to 256 luma samples, a CU level flag is signalled to indicate whether OBMC is applied or not for the current CU. For the CUs with size larger than 256 luma samples or not coded with AMVP mode, OBMC is applied by default. At the encoder, when OBMC is applied for a CU, its impact is taken into account during the motion estimation stage. The prediction signal formed by OBMC using motion information of the top neighbouring block and the left neighbouring block is used to compensate the top and left boundaries of the original signal of the current CU, and then the normal motion estimation process is applied.

2.31. GPM with MMVD

A geometry partition mode (GPM) with MMVD (called GPM_MMVD) was proposed to further improve the coding efficiency of the GPM mode in the VVC. Specifically, in those schemes, additional MV differences (MVDs) are further applied on top of the existing GPM merge candidates to improve the precision of the MVs used by the two GPM partitions. Moreover, to reduce the signaling overhead, the MVDs are signaled in the same manner as the merge mode with MVD (MMVD) in the VVC.

Specifically, two flags are signaled to separately indicate whether additional MVD is applied to each GPM partition. When the flag of one GPM partition is true, its corresponding MVD is signaled in the same way as the MMVD, i.e., one distance index plus one direction index. To enable more MV combinations, the merge indices of two GPM partitions are allowed to be the same when the MVDs that are applied to the two partitions are not identical. Additionally, an MV pruning procedure is introduced to construct the GPM merge candidate list when GPM with MMVD is applied.

Additionally, two different sets of MVDs are supported for the GPM which are selected according to one indication flag at picture header. When the flag is equal to 0, the existing MVD set used by the MMVD, which includes 8 distances {¼-pel, ½-pel, 1-pel, 2-pel, 4-pel, 8-pel, 16-pel, 32-pel} and 4 horizontal/vertical directions, are supported for the GPM CUs in the current picture; otherwise, another MVD set, which include 9 distance {¼-pel, ½-pel, 1-pel, 2-pel, 3-pel, 4-pel, 6-pel, 8-pel, 16-pel} and 8 directions (4 horizontal/vertical directions plus 4 diagonal directions), are applied.

2.32. Geometric Partitioning Mode (GPM) with Template Matching (TM)

Template matching is applied to GPM. The method is called GPM_TM. When GPM mode is enabled for a CU, a CU-level flag is signaled to indicate whether TM is applied to both geometric partitions. Motion information for each geometric partition is refined using TM. When TM is chosen, a template is constructed using left, above or left and above neighboring samples according to partition angle, as shown in Table 4. The motion is then refined by minimizing the difference between the current template and the template in the reference picture using the same search pattern of merge mode with half-pel interpolation filter disabled.

TABLE 4
Template for the 1st and 2nd geometric partitions, where A represents using above samples,
L represents using left samples, and L + A represents using both left and above samples.

| Partition angle | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

A GPM candidate list is constructed as follows:

1. Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates.

2. Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates.

3. Zero MV candidates are padded until the GPM candidate list is full.

The GPM-MMVD and GPM-TM are exclusively enabled to one GPM CU. This is done by firstly signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

### 2.33. Affine Motion Compensated Prediction

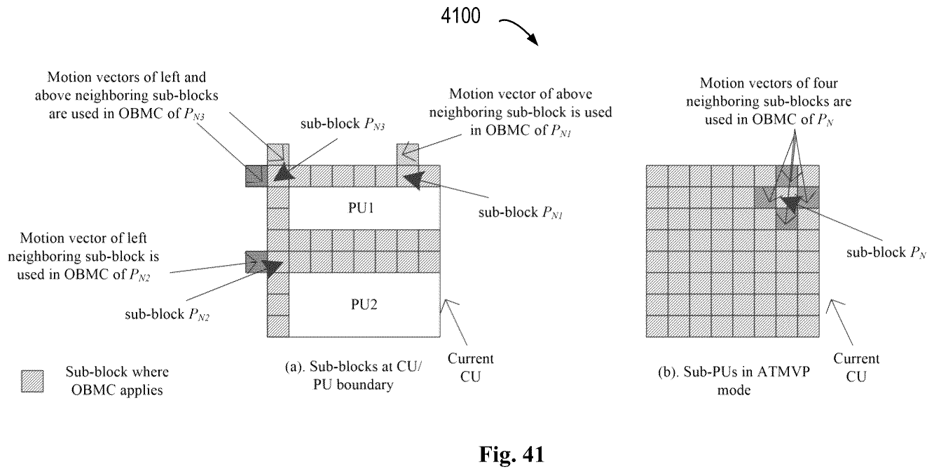

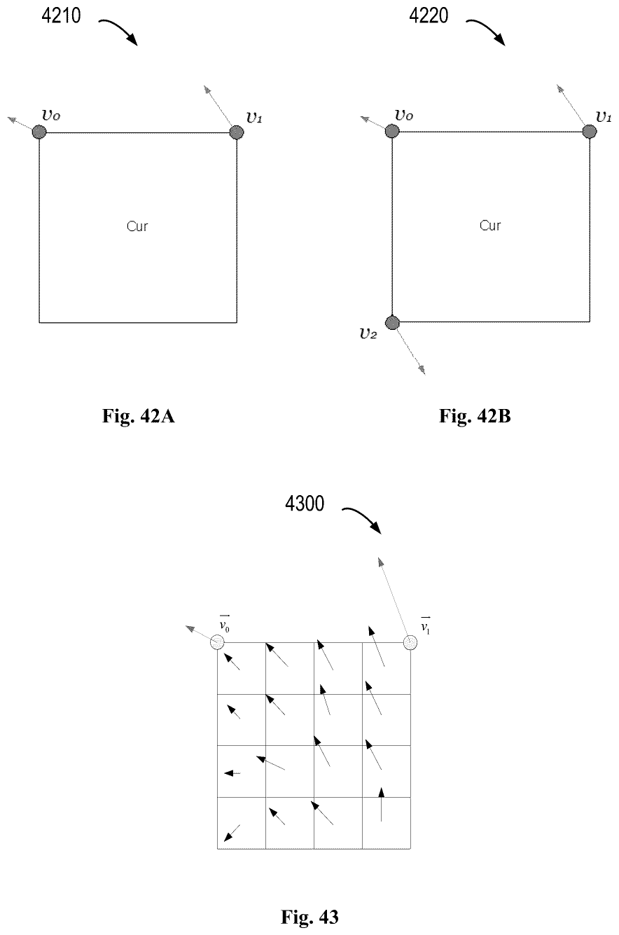

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. As shown FIGS. 42A and 42B, which illustrate examples 4210 and 4220 of control point based affine motion model, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix}$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix}$$

Where (mv₀ₓ, mv_{0y}) is motion vector of the top-left corner control point, (mv₁x, mvₗy) is motion vector of the top-right corner control point, and (mv₂ₓ, mv_{2y}) is motion vector of the bottom-left corner control point.

In order to simplify the motion compensation prediction, block based affine transform prediction is applied. To derive motion vector of each 4×4 luma subblock, the motion vector of the center sample of each subblock, as shown in FIG. 43 (illustrates a diagram 4300 of an affine MVF per subblock), is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

### 2.33.1 Affine Merge Prediction

AF_MERGE mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU. The following three types of CPVM candidate are used to form the affine merge candidate list:
Inherited affine merge candidates that extrapolated from the CPMVs of the neighbour CUs
Constructed affine merge candidates CPMVPs that are derived using the translational MVs of the neighbour CUs
Zero MVs

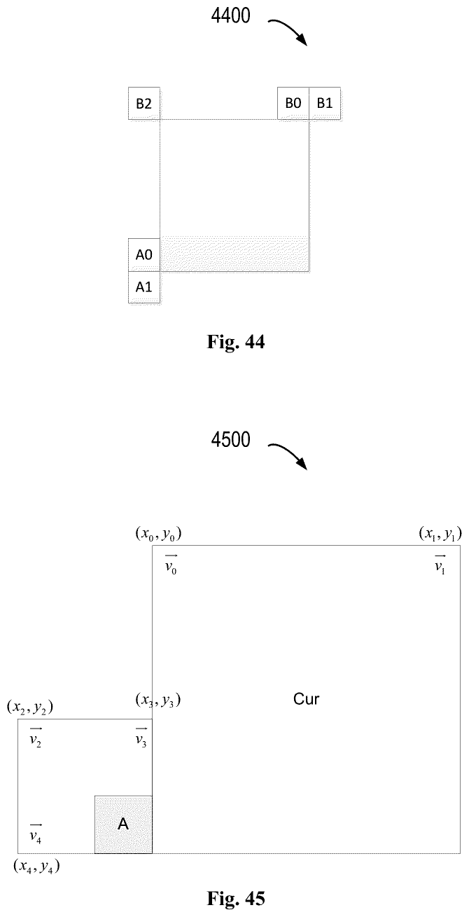

In VVC, there are maximum two inherited affine candidates, which are derived from affine motion model of the neighboring blocks, one from left neighboring CUs and one from above neighboring CUs. The candidate blocks are shown in FIG. 44, which illustrates a diagram 4400 of locations of inherited affine motion predictors. For the left predictor, the scan order is AG->A1, and for the above predictor, the scan order is B0->B1->B2. Only the first inherited candidate from each side is selected. No pruning check is performed between two inherited candidates. When a neighboring affine CU is identified, its control point motion vectors are used to derive the CPMVP candidate in the affine merge list of the current CU. As shown in FIG. 45 (which illustrates a diagram 4500 of control point motion vector inheritance), if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

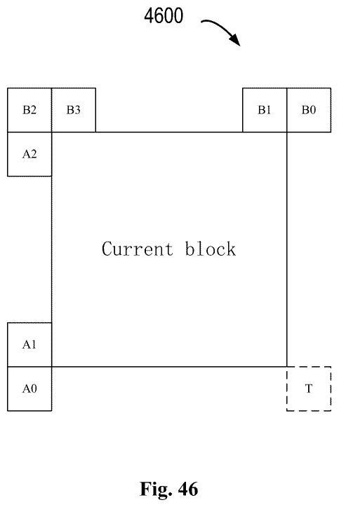

Constructed affine candidate means the candidate is constructed by combining the neighbor translational motion information of each control point. The motion information for the control points is derived from the specified spatial neighbors and temporal neighbor shown in FIG. 46, which illustrates a diagram 4600 of locations of candidates position for constructed affine merge mode. CPMVₖ (k=1, 2, 3, 4) represents the k-th control point. For CPMV₁, the B2->B3->A2 blocks are checked and the MV of the first available block is used. For CPMV2, the B1->B0 blocks are checked and for CPMV3, the A1->A0 blocks are checked. For TMVP is used as CPMV4 if it's available.

After MVs of four control points are attained, affine merge candidates are constructed based on those motion information. The following combinations of control point MVs are used to construct in order:

### {CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### 2.33.2 Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighboring CUs
Zero MVs

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

Constructed AMVP candidate is derived from the specified spatial neighbors shown in FIG. 46. The same checking order is used as done in affine merge candidate construction. In addition, reference picture index of the neighboring block is also checked. The first block in the checking order that is inter coded and has the same reference picture as in current CUs is used. There is only one When the current CU is coded with 4-parameter affine mode, and mv₀ and my₁ are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

If affine AMVP list candidates is still less than 2 after valid inherited affine AMVP candidates and constructed AMVP candidate are inserted, mv₀, my₁ and mV₂ will be added, in order, as the translational MVs to predict all control point MVs of the current CU, when available. Finally, zero MVs are used to fill the affine AMVP list if it is still not full.

### 2.33.3 Affine Motion Information Storage

In VVC, the CPMVs of affine CUs are stored in a separate buffer. The stored CPMVs are only used to generate the inherited CPMVPs in affine merge mode and affine AMVP mode for the lately coded CUs. The subblock MVs derived from CPMVs are used for motion compensation, MV derivation of merge/AMVP list of translational MVs and deblocking.

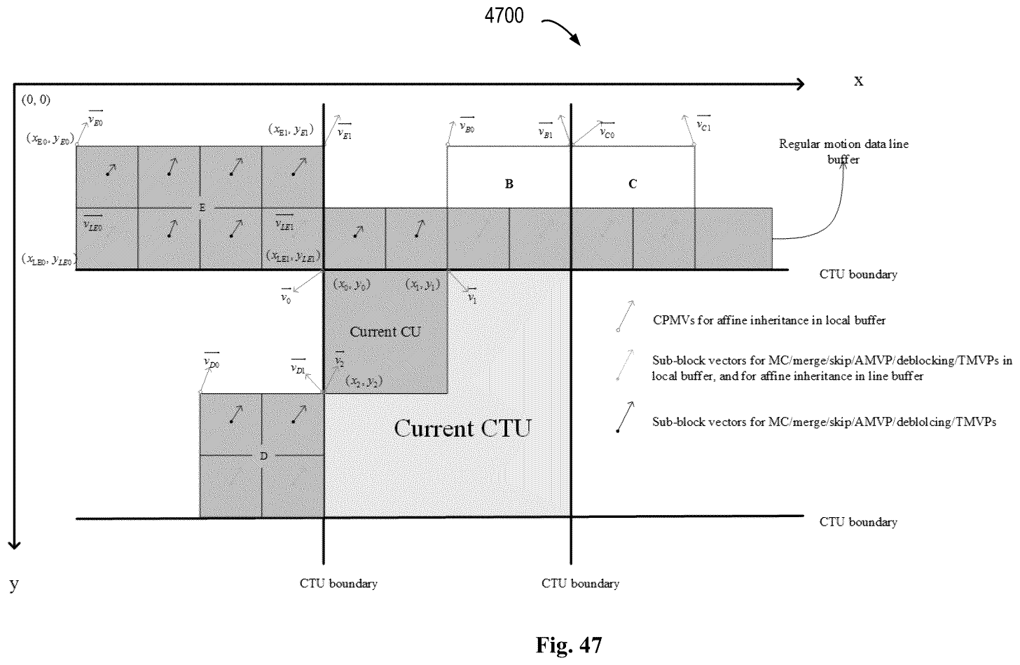

To avoid the picture line buffer for the additional CPMVs, affine motion data inheritance from the CUs from above CTU is treated differently to the inheritance from the normal neighboring CUs. If the candidate CU for affine motion data inheritance is in the above CTU line, the bottom-left and bottom-right subblock MVs in the line buffer instead of the CPMVs are used for the affine MVP derivation. In this way, the CPMVs are only stored in local buffer. If the candidate CU is 6-parameter affine coded, the affine model is degraded to 4-parameter model. As shown in FIG. 47 (which illustrates a diagram 4700 of motion vector usage for proposed combined method), along the top CTU boundary, the bottom-left and bottom right subblock motion vectors of a CU are used for affine inheritance of the CUs in bottom CTUs.

2.33.4 Prediction Refinement with Optical Flow for Affine Mode

Subblock based affine motion compensation can save memory access bandwidth and reduce computation complexity compared to pixel based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps: Step 1) The subblock-based affine motion compensation is performed to generate subblock prediction I(i,j).

Step2) The spatial gradients gₓ(i,j) and g_{y}(i,j) of the subblock prediction are calculated at each sample location using a 3-tap filter [−1, 0, 1]. The gradient calculation is exactly the same as gradient calculation in BDOF.

$$\begin{matrix}{g}_{x} ( i , j ) = ( I ( i + 1 , j ) ≫ shift 1 ) - ( I ( i - 1 , j ) ≫ shift 1 ) \\ {g}_{y} ( i , j ) = ( I ( i , j + 1 ) ≫ shift 1 ) - ( I ( i , j - 1 ) ≫ shift 1 )\end{matrix}$$

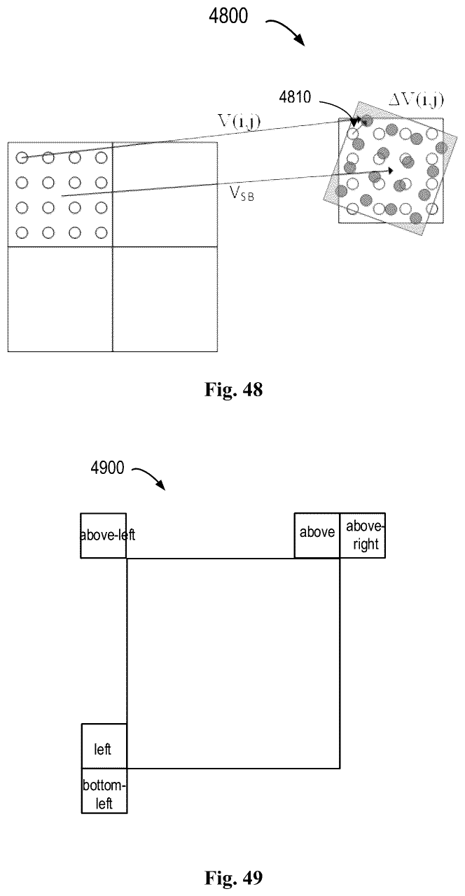

shift1 is used to control the gradient's precision. The subblock (i.e., 4×4) prediction is extended by one sample on each side for the gradient calculation. To avoid additional memory bandwidth and additional interpolation computation, those extended samples on the extended borders are copied from the nearest integer pixel position in the reference picture.
Step 3) The luma prediction refinement is calculated by the following optical flow equation.

$$Δ I ( i , j ) = {g}_{x} ( i , j ) * Δ {v}_{x} ( i , j ) + {g}_{y} ( i , j ) * Δ {v}_{y} ( i , j )$$

where the Δv(i,j) is the difference between sample MV computed for sample location (i,j), denoted by v(i,j), and the subblock MV of the subblock to which sample (i,j) belongs, as shown in FIG. 48 (which illustrates a diagram 4800 of subblock MV VSB and pixel Δv(i,j) with arrow 4810). The Δv(i,j) is quantized in the unit of 1/32 luam sample precision.

Since the affine model parameters and the sample location relative to the subblock center are not changed from subblock to subblock, Δv(i,j) can be calculated for the first subblock, and reused for other subblocks in the same CU. Let dx(i,j) and dy(i,j) be the horizontal and vertical offset from the sample location (i,j) to the center of the subblock (x_{SB},Y_{SB}), Δv(x,y) can be derived by the following equation,

$$\begin{matrix}\{ \begin{matrix}dx ( i , j ) = i - {x}_{S B} \\ dy ( i , j ) = j - {y}_{S B}\end{matrix} \\ \{ \begin{matrix}Δ {v}_{x} ( i , j ) = C * d x ( i , j ) + D * d y ( i , j ) \\ Δ {v}_{y} ( i , j ) = E * d x ( i , j ) + F * d y ( i , j )\end{matrix}\end{matrix}$$

In order to keep accuracy, the enter of the subblock (x_{SB},Y_{SB}) is calculated as ((W_{SB}− 1)/2, (H_{SB}− 1)/2), where W_{SB} and H_{SB} are the subblock width and height, respectively. For 4-parameter affine model,

$$\{ \begin{matrix}C = F = \frac{{v}_{1 x} - {v}_{0 x}}{w} \\ E = - D = \frac{{v}_{1 y} - {v}_{0 y}}{w}\end{matrix}$$

For 6-parameter affine model,

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix}$$

where (v₀ₓ, v_{0y}), (v₁ₓ, v_{1y}), (v₂x, v₂y) are the top-left, top-right and bottom-left control point motion vectors, w and h are the width and height of the CU.
Step 4) Finally, the luma prediction refinement Δ1(i, j) is added to the subblock prediction I(i, j). The final prediction I′ is generated as the following equation.

$${I}^{′} ( i , j ) = I ( i , j ) + Δ I ( i , j )$$

PROF is not be applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.

A fast encoding method is applied to reduce the encoding complexity of affine motion estimation with PROF. PROF is not applied at affine motion estimation stage in following two situations: a) if this CU is not the root block and its parent block does not select the affine mode as its best mode, PROF is not applied since the possibility for current CU to select the affine mode as best mode is low; b) if the magnitude of four affine parameters (C, D, E, F) are all smaller than a predefined threshold and the current picture is not a low delay picture, PROF is not applied because the improvement introduced by PROF is small for this case. In this way, the affine motion estimation with PROF can be accelerated.

### 2.34. Affine MMVD

In affine MMVD, an affine merge candidate (which is called, base affine merge candidate) is selected, the MVs of the control points are further refined by the signalled MVD information.

The MVD information for the MVs of all the control points are the same in one prediction direction.

When the starting MVs is bi-prediction MVs with the two MVs point to the different sides of the current picture (i.e. the POC of one reference is larger than the POC of the current picture, and the POC of the other reference is smaller than the POC of the current picture), the MV offset added to the list0 MV component of starting MV and the MV offset for the list1 MV has opposite value; otherwise, when the starting MVs is bi-prediction MVs with both lists point to the same side of the current picture (i.e. POCs of two references are both larger than the POC of the current picture, or are both smaller than the POC of the current picture), the MV offset added to the list0 MV component of starting MV and the MV offset for the list1 MV are the same.

### 2.35. IBC Mode Extension

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

For an IBC coded block, a block vector (BV) is used to indicate the displacement from the current block to a reference block, which is already reconstructed inside the current picture.

W and H are the width and height of current block (e.g., luma block).

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM may be also treated as GPM.

In the following, Mv1 and Mv2 are the motion vectors from the first part and the second part of the triangle or geometric partition.

1. In one example, the IBC merge mode with block vector differences (MBVD) may be used.
a. In MBVD, a BV may be derived based on an IBC merge candidate which may be further refined by the signaled BVDs information.
b. In one example, the BVDs information may include one or multiple IBC merge candidate indices, one or multiple indications (such as indices) to specify motion magnitude(s), and one or multiple indications (such as indices) for indication of motion direction(s).
   i. In MBVD mode, at least one from the candidates in the IBC merge list is selected to be used as BV basis. At least one MBVD candidate index is signaled to specify which candidate(s) is (are) used among the IBC merge candidates.
      (i) In one example, a MBVD candidate index is signaled to specify which one is used among the first N IBC merge candidates.
         a) In one example, N is set to 2.
         b) In one example, the candidate index may be binarized as a truncated code, with the maximum value equal to N-1.
      (ii) In one example, the IBC merge candidates may be reordered before being used.
   ii. In one example, a distance index specifies motion magnitude information and indicates the pre-defined offset from the starting point.
   (i) An offset may be added to either horizontal component or vertical component of a starting BV.
      (ii) An offset may be added to both horizontal component and vertical component of a starting BV.
      (iii) In one example, the distance set may be {1-pel, 2-pel, 4-pel, 8-pel, 16-pel, 32-pel}.
      (iv) In one example, the distance set may be {1-pel, 2-pel, 4-pel, 8-pel, 16-pel, 32-pel, 64-pel, 128-pel}.
      (v) In one example, the distance set may be {1-pel, 2-pel, 3-pel, 4-pel, 6-pel, 8-pel, 16-pel}.
      (vi) In one example, the distance set may be {1-pel, 2-pel, 3-pel, 4-pel, 6-pel, 8-pel, 16-pel, 32-pel, 64-pel}.
      (vii) In one example, the relation of distance index and pre-defined offset is specified in Table 5.
      (viii) In one example, the relation of distance index and pre-defined offset is specified in Table 6.
      (ix) In one example, the relation of distance index and pre-defined offset is specified in Table 7.
      (x) In one example, the relation of distance index and pre-defined offset is specified in Table 8.
      (xi) In one example, the relation of distance index and pre-defined offset may be signaled from encoder to decoder at sequence/picture/slice/CTU/CU level.
      (xii) The index may be binarized with unary coding, truncated unary coding, exponential-Golomb code, truncated exponential-Golomb code, fixed length code or any other binarization method.
   iii. In one example, a direction index represents the direction of the BVD relative to the starting point. The direction index can represent of the M BVD directions.
      (i) In one example, M is set to 4.
         a) In one example, 4 horizontal/vertical directions may be used.
         b) In one example, 4 diagonal directions may be used.
         c) In one example, the relation of direction index and pre-defined direction is specified in Table 9. For direction index of 0, (offset, 0) is the BVD; for direction index of 1, (−offset, 0) is the BVD; for direction index of 2, (0, offset) is the BVD; for direction index of 3, (0,-offset) is the BVD.
         d) In one example, the relation of direction index and pre-defined direction is specified in Table 10. For direction index of 0, (offset, offset) is the BVD; for direction index of 1, (offset,-offset) is the BVD; for direction index of 2, (−offset, offset) is the BVD; for direction index of 3, (−offset, −offset) is the BVD.
      (ii) In one example, M is set to 8.
         a) In one example, 4 horizontal/vertical directions plus 4 diagonal directions may be used.
         b) In one example, the relation of direction index and pre-defined direction is specified in Table 11.
      (iii) The index may be binarized with unary coding, truncated unary coding, exponential-Golomb code, truncated exponential-Golomb code, fixed length code or any other binarization method.
   iv. In one example, the number of distances and/or directions for MBVD of a block may be decided by
      (i) The resolution of a picture.
      (ii) The configuration of the coding process.
      (iii) The BVDs of the neighboring blocks of the block.
         a) In one example, the above and left neighboring blocks (depicted in FIG. 49 which shows a diagram 4900 of the adjacent spatial neighboring blocks used) may be used.
         b) In one example, the adjacent spatial neighboring blocks including left and/or above and/or above-right and/or bottom-left and/or above-left spatial neighboring blocks (an example is shown in FIG. 49) may be used.
      (iv) Alternatively, the number of distances and/or directions for MBVD may be signaled from encoder to decoder at sequence/picture/slice/CTU/CU level.
c. In one example, the candidates/directions/magnitudes in MBVD which may produce a BV out of the valid range of BV may be excluded from the candidate/directions/magnitudes set to be selected or signaled.
   i. Alternatively, a BV generated in MBVD may be clipped to be in the valid range.
   ii. Alternatively, a BV generated in MBVD must be in the valid range in a conformance bitstream.

TABLE 5
The relation of distance index and pre-defined offset

| Distance IDX | 0 | 1 | 2 | 3 | 4 | 5 |
|---|---|---|---|---|---|---|
| Offset (in unit | 1 | 2 | 4 | 8 | 16 | 32 |
| of luma sample) | | | | | | |

TABLE 6
The relation of distance index and pre-defined offset

| Distance IDX | 0 | 1 | 2 | 3 | 4 | 5 | 6 | 7 |
|---|---|---|---|---|---|---|---|---|
| Offset (in unit | 1 | 2 | 4 | 8 | 16 | 32 | 64 | 128 |
| of luma sample) | | | | | | | | |

TABLE 7
The relation of distance index and pre-defined offset

| Distance IDX | 0 | 1 | 2 | 3 | 4 | 5 | 6 |
|---|---|---|---|---|---|---|---|
| Offset (in unit | 1 | 2 | 3 | 4 | 6 | 8 | 16 |
| of luma sample) | | | | | | | |

TABLE 8
The relation of distance index and pre-defined offset

| Distance IDX | 0 | 1 | 2 | 3 | 4 | 5 | 6 | 7 | 8 |
|---|---|---|---|---|---|---|---|---|---|
| Offset (in unit | 1 | 2 | 3 | 4 | 6 | 8 | 16 | 32 | 64 |
| of luma sample) | | | | | | | | | |

TABLE 9
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

TABLE 10
Sign of BV offset specified by direction index

| Direction IDX | 00 | 01 | 10 | 11 |
|---|---|---|---|---|
| x-axis | + | + | − | − |
| y-axis | + | − | + | − |

TABLE 11
Sign of BV offset specified by direction index

| Direction IDX | 000 | 001 | 010 | 011 | 100 | 101 | 110 | 111 |
|---|---|---|---|---|---|---|---|---|
| x-axis | + | − | N/A | N/A | + | + | − | − |
| y-axis | N/A | N/A | + | − | + | − | + | − |

2. In one example, a new CIIP prediction mode (called CIIP_N) combines at least one IBC prediction signal and at least one prediction signal, generated by a second prediction method.
a. The second prediction method may be intra-prediction or inter-prediction.
b. The second prediction signal and IBC prediction signal may be combined by weighted averaging.
   i. The CIIP_N prediction is formed as

$${P}_{CIIP\_N} = ( ( {2}^{N} - w t ) * {P}_{IBC} + w t * {P}_{s e c} + offset ) ≫ N$$

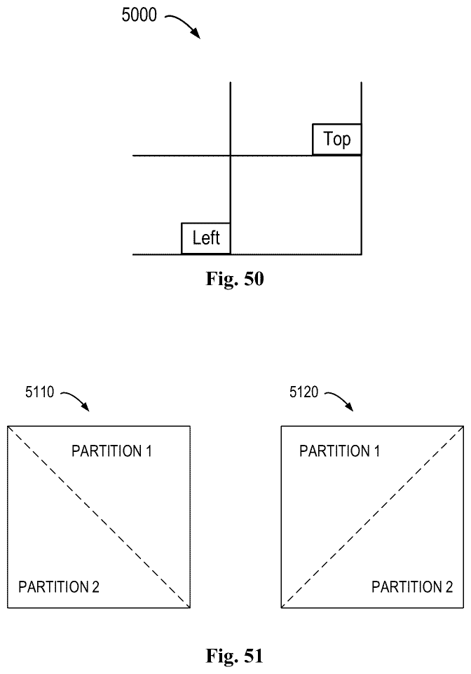

ii. In one example, offset is an integer such as 2^{N}>1.
iii. In one example, N=2.
iv. In one example, the weight value may be predefined.
   (i) In one example, wt is set to 2.
   v. In one example, the weight value may be position-dependent for each sample.
      (i) For example, for some positions wt=2^{N}.
      (ii) For example, for some positions, wt=0.
   vi. In one example, the weight value may be signaled from encoder to decoder.
c. The IBC prediction signal in the CIIP_N mode P_{IBC} may be derived using the same IBC prediction process applied to regular IBC merge mode.
d. The second prediction signal PSe_{C} may be derived following the regular intra prediction process, and the combined mode is named as CIIP_N1.
   i. In one example, the intra prediction mode may be the planar mode.
   ii. In one example, the intra prediction mode may be the intra prediction mode which is implicitly derived by DIMD method.
   iii. In one example, the intra prediction mode may be the intra prediction mode which is implicitly derived by TIMD method.
   iv. In one example, the weight value may be calculated depending on the coding modes of the neighbouring blocks.
      (i) In one example, the weight value may be calculated depending on the coding modes of the top and left neighbouring blocks (depicted in FIG. 50 which shows a diagram 5000 of top and left neighboring blocks used in CIIP_N1 and CIIP_N2 weight derivation) as follows:
      If the top neighbor is available and intra coded, then set isIntraTop to 1, otherwise set isIntraTop to 0;
      If the left neighbor is available and intra coded, then set isIntraLeft to 1, otherwise set isIntraLeft to 0;
      If (isIntraLeft+isIntraTop) is equal to 2, then wt is set to 3;
      Otherwise, if (isIntraLeft+isIntraTop) is equal to 1, then wt is set to 2;
      Otherwise, set wt to 1.
e. The second prediction signal P_{sec} may be derived using the same inter prediction process applied to regular merge mode, and the combined mode is named as CIIP_N2.
   i. In one example, the weight value may be calculated depending on the coding modes of the neighbouring blocks.
      (i) In one example, the weight value may be calculated depending on the coding modes of the top and left neighbouring blocks (depicted in FIG. 50) as follows:
      If the top neighbor is available and IBC coded, then set isIBCTop to 1, otherwise set isIBCTop to 0;
      If the left neighbor is available and IBC coded, then set isIBCLeft to 1, otherwise set isIBCLeft to 0;
      If (isIBCLeft+isIBCTop) is equal to 2, then wt is set to 1;
      Otherwise, if (isIBCLeft+isIBCTop) is equal to 1, then wt is set to 2;
      Otherwise, set wt to 3.
f. In CIIP_N mode, one from the candidates in the IBC merge list is selected to be used for IBC prediction. An IBC candidate index may be signaled to specify which one is used among the IBC merge candidates.
   i. In one example, an IBC candidate index is signaled to specify which one is used among the first N IBC merge candidates.
      (i) In one example, N is set to 4.
      (ii) In one example, N is set to the valid number of IBC merge candidates in the IBC merge list.
      (iii) In one example, N may be signaled from encoder to decoder.
      (iv) In one example, N is set to number of full RD for IBC merge.
      (v) In one example, N is set to number of full RD for IBC merge plus an integer.
      (vi) In one example, the IBC merge candidates may be reordered before being used.
   ii. In one example, an IBC candidate index is signaled to specify which one is used among the first N IBC merge candidates in the ascending order of SATD-cost values.
      (i) In one example, N is set to 4.
      (ii) In one example, N is set to the valid number of IBC merge candidates in the IBC merge list.
      (iii) In one example, N may be signaled from encoder to decoder.
      (iv) In one example, N is set to number of full RD for IBC merge.
      (v) In one example, N is set to number of full RD for IBC merge plus an integer.
      (vi) In one example, the IBC merge candidates may be reordered before calculating the SATD-cost.
g. In CIIP_N2 mode, one from the candidates in the regular merge list is selected to be used for inter prediction. A merge candidate index may be signaled to specify which one is used among the regular merge candidates.
   i. In one example, a merge candidate index is signaled to specify which one is used among the first N regular merge candidates.
      (i) In one example, N is set to 4.
      (ii) In one example, N is set to the valid number of regular merge candidates in the regular merge list.
      (iii) In one example, N may be signaled from encoder to decoder.
      (iv) In one example, N is set to number of full RD for inter merge.
      (v) In one example, N is set to number of full RD for inter merge plus an integer.
      (vi) In one example, the regular merge candidates may be reordered before being used.
   ii. In one example, a merge candidate index is signaled to specify which one is used among the first N regular merge candidates in the ascending order of SATD-cost values.
      (i) In one example, N is set to 4.
      (ii) In one example, N is set to the valid number of regular merge candidates in the regular merge list.
      (iii) In one example, N may be signaled from encoder to decoder.
      (iv) In one example, N is set to number of full RD for inter merge.
      (v) In one example, N is set to number of full RD for inter merge plus an integer.
      (vi) In one example, the regular merge candidates may be reordered before calculating the SATD-cost.
h. In one example, whether to and/or how to use the CIIP_N mode may be dependent on the coding information such as block dimensions/QP/neighboring block mode, etc.
   i. In one example, when a block is coded in IBC merge mode, if the block contains at least P luma samples (that is, block width times block height is equal to or larger than P), an additional flag is signaled to indicate if the CIIP_N mode is applied to the current block.
      (i) In one example, P is set to 64.
   ii. In one example, when a block is coded in IBC merge mode, if both block width and block height are less than Q luma samples, an additional flag is signaled to indicate if the CIIP_N mode is applied to the current block.
      (i) In one example, Q is set to 128.
      (ii) In one example, Q is set to 64.
   iii. In one example, the above two conditions may be used together.
i. In one example, whether to and/or how to use the CIIP_N2 mode may be dependent on the coding information such as block dimensions/QP/neighboring block mode, etc.
   i. In one example, when a block is coded in regular merge mode, if the block contains at least P luma samples (that is, block width times block height is equal to or larger than P), an additional flag is signaled to indicate if the CIIP_N2 mode is applied to the current block.
      (i) In one example, P is set to 64.
   ii. In one example, when a block is coded in regular merge mode, if both block width and block height are less than Q luma samples, an additional flag is signaled to indicate if the CIIP_N2 mode is applied to the current block.
      (i) In one example, Q is set to 128.
      (ii) In one example, Q is set to 64.
   i. In one example, the above two conditions may be used together.

3. In one example, a triangle partition mode may be supported for IBC prediction (called TPM_IBC).
a. When this mode is used, a block is split evenly into two triangle-shaped partitions, using either the diagonal split or the anti-diagonal split (for example, FIG. 51 illustrates an example of triangle partition based IBC prediction). In FIG. 51, a block 5110 is split using the diagonal split, and a block 5220 is split using anti-diagonal split.
b. Each triangle partition in the block is IBC-predicted using its own motion.
c. The uni-prediction motion for each partition is derived from a uni-prediction IBC candidate list.
   i. In one example, the uni-prediction IBC candidate list is derived directly from partial or full of an IBC merge candidate list.
   ii. In one example, the uni-prediction IBC candidate list may be reordered before being used.
d. After predicting each of the triangle partitions, the sample values along the diagonal or anti-diagonal edge may be adjusted using a blending processing with adaptive weights.
   i. In one example, the weights may be adaptively decided by the distances between a sample and the splitting line.
      (i) An example is shown in section 2.23.2.
   ii. Alternatively, the sample values along the diagonal or anti-diagonal edge may not be adjusted using a blending processing. Instead, a sample along the diagonal or anti-diagonal edge can only be predicted by one of the two predictions.
e. For motion field storage of TPM_IBC, if sType is equal to 0 or 1, Mv1 or Mv2 are stored in the corresponding motion field, otherwise if sType is equal to 2, Mv2 is stored.
   i. In one example, the sType calculation is the same as that for inter TPM.
f. For signaling of TPM_IBC, the following applies:
   i. The TPM_IBC mode is signaled using a CU-level flag as one kind of IBC merge mode.
   ii. If TPM_IBC mode is used for the current CU, then a flag indicating the direction of the triangle partition (diagonal or anti-diagonal), and two merge indices (one for each partition) are further signaled.
iii. If TPM_IBC mode is used for the current CU, then a triangle partition index indicating the partition mode of the triangle partition, and two merge indices (one for each partition) are further signalled.

4. In one example, a geometric partitioning mode may be supported for IBC prediction (called GPM_IBC).
a. When this mode is used, a block is split into two parts by a geometrically located straight line (e.g., FIG. 34). The location of the splitting line is mathematically derived from the angle and offset parameters of a specific partition.
b. Each part of a geometric partition in the block is IBC-predicted using its own motion.
c. The uni-prediction motion for each partition is derived from a uni-prediction IBC candidate list.
   i. In one example, the uni-prediction IBC candidate list is derived directly from partial or full of an IBC merge candidate list.
   ii. In one example, the uni-prediction IBC candidate list may be reordered before being used.
d. After predicting each of part of the geometric partition, the sample values along the geometric partition edge may be adjusted using a blending processing with adaptive weights.
   i. In one example, the weights may be adaptively decided by the distances between a sample and the splitting line.
      (i) An example is shown in section 2.24.2.
   ii. Alternatively, the sample values along geometric partition edge may not be adjusted using a blending processing. Instead, a sample along the geometric partition edge can only be predicted by one of the two predictions.
e. For motion field storage of GPM_IBC, if sType is equal to 0 or 1, Mv1 or Mv2 are stored in the corresponding motion field, otherwise if sType is equal to 2, Mv2 is stored.
   i. In one example, the sType calculation is the same as that for inter GPM.
f. For signaling of GPM_IBC, the following applies:
   i. The GPM_IBC mode is signaled using a CU-level flag as one kind of IBC merge mode.
   ii. If GPM_IBC mode is used for the current CU, then a geometric partition index indicating the partition mode of the geometric partition (angle and offset), and two merge indices (one for each partition) are further signalled.

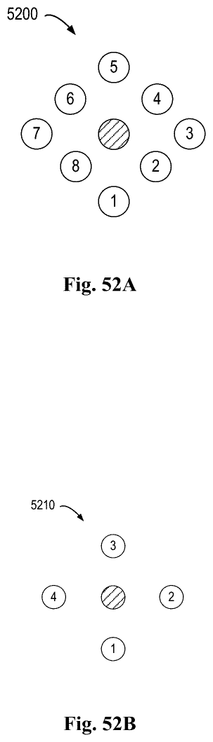

5. In one example, TM_AMVP for IBC (called TM_AMVP_IBC) is supported.
a. In TM_AMVP_IBC mode, K IBC MVP candidates are determined based on template matching to pick up the one which reaches the first K minimum difference between current block template and reference block template from the IBC AMVP list.
   i. A selected set of start-point candidates consists of the K IBC MVP candidates.
b. TM may perform only for the selected set of start-point candidates for MV refinement.
   i. TM refines a start-point candidate, starting from full-pel MVD precision (or 4-pel for 4-pel AMVR mode) within a search range.
      (i) In one example, refine it within a [−8, +8]-pel search range by using iterative diamond search. M search rounds will be used until the center searching point has the minimum matching cost for a diamond search pattern as shown in FIG. 52A. FIG. 52A illustrates an example 5200 of search pattern.
         a) In one example, M is MAX_UINT.
         b) In one example, M is 375.
   ii. The selected start-point candidate may be further refined by using cross search with full-pel MVD precision (or 4-pel for 4-pel AMVR mode).
      (i) In one example, one search round is used for cross search pattern as shown in FIG. 52B. FIG. 52B illustrates an example 5210 of search pattern.
c. In one example, TM_AMVP_IBC may generate K refined IBC AMVP candidates, and one of them may be selected and the selection may be signaled from encoder to decoder.
   i. In one example, K=1, and no selection information is signaled.
   ii. In one example, if at least one refined IBC AMVP candidates by template matching are available, they are used as the TM_AMVP_IBC candidates. Otherwise, the first K existing IBC AMVP candidates without refinement are used.
   iii. In one example, the selected refined IBC AMVP candidate is used as the starting point for block matching based local search of IBC mode.
d. Alternatively, the derived BV by TM_IBC is used as the starting point for block matching based local search of IBC mode.
e. For example, when IBC AMVR is enabled, the refined IBC AMVP candidate in one MVD precision may be reused in another MVD precisions.
   i. In one example, the refined IBC AMVP candidate in full-pel MVD precision may be reused in 4-pel MVD precisions.

6. In one example, TM_merge for IBC (called TM_merge_IBC) is supported.
a. In TM_merge_IBC mode, K IBC merge candidates are determined based on template matching to pick up the one which reaches the first K minimum difference between current block template and reference block template from the IBC merge list.
   i. A selected set of start-point candidates consists of the K IBC merge candidates.
b. TM may perform only for the selected set of start-point candidates for MV refinement.
   i. TM refines a start-point candidate, starting from full-pel MVD precision (or 4-pel for 4-pel AMVR mode) within a search range.
      (i) In one example, refine it within a [−8, +8]-pel search range by using iterative diamond search. M search rounds will be used until the center searching point has the minimum matching cost for a diamond search pattern as shown in FIG. 44A.
         a) In one example, M is MAX_UINT.
         b) In one example, M is 375.
   ii. The selected start-point candidate may be further refined by using cross search with full-pel MVD precision (or 4-pel for 4-pel AMVR mode).
      (i) In one example, one search round is used for cross search pattern as shown in FIG. 52B.
c. In one example, TM_merge_IBC may generate K refined IBC merge candidates, and one of them may be selected and the selection may be signaled from encoder to decoder.
   i. In one example, K=1, and no selection information is signaled.
   ii. In one example, if at least one refined IBC merge candidates by template matching are available, they are used as the TM_merge_IBC candidates. Otherwise, TM_merge_IBC mode is invalid.
   iii. In one example, the best TM refined IBC merge candidate is selected by a criterion.
      (i) In one example, the criterion is RD decision.
d. Alternatively, TM performs for each IBC merge candidate for MV refinement. And then the best TM refined IBC merge candidate is selected by a criterion.
   i. In one example, the criterion is RD decision.

### 3. Problems

The current design of IBC mode can be further improved.

More IBC based modes can be supported to improve the coding efficiency of IBC mode.

### 4. Detailed Description

The detailed inventions below should be considered as examples to explain general concepts. These inventions should not be interpreted in a narrow way. Furthermore, these inventions can be combined in any manner.

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

For an IBC coded block, a block vector (BV) is used to indicate the displacement from the current block to a reference block, which is already reconstructed inside the current picture.

W and H are the width and height of current block (e.g., luma block).

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM may be also treated as GPM.

In the following, Mv1 and Mv2 are the motion vectors from the first part and the second part of the triangle or geometric partition.

Non-translational IBC mode

It is proposed to utilize affine motion model to predict a current block from the reconstructed samples/pixels within the same picture.

1. In one example, affine motion compensated prediction is supported for IBC mode (called Affine_IBC).
a. The affine motion field of the block may be described by motion information of two control points (4-parameter affine model) or three control points (6-parameter affine model).
b. There may be two affine motion IBC prediction modes: affine IBC merge mode and affine IBC AMVP mode.
   i. In one example, the affine IBC merge mode may be performed similar as the affine merge mode.
   ii. In one example, the affine IBC AMVP mode may be performed similar as the affine AMVP mode.
c. In one example, a BV for a pixel or for a sub-block derived from an affine model may be rounded or clipped to the integer precision.
d. In one example, a BV prediction of a control point inherited from a neighbouring block or derived from an affine model may be rounded or clipped to the integer precision.
e. The prediction refinement with optical flow for affine_IBC mode may be also supported.
   i. In one example, the prediction refinement with optical flow for affine_IBC mode may be performed similar as prediction refinement with optical flow for affine mode.
f. The proposed Affine_IBC mode could be a merge mode wherein no BV difference (BVD) is coded.
   i. Alternatively, it could be an inter mode wherein indication of a BVD may be coded.
   ii. Alternatively, it could be a merge mode wherein indications of BVDs within an affine BVD candidate list may be coded/derived, such as index of a BVD is coded.

2. The block vectors of the control points used in the Affine_IBC mode may be derived according to BV(s) derived from an affine BV candidate list and BVD(s) selected from a given affine BVD candidate list.
a. In one example, the Affine_IBC with MBVD (called Affine_IBC_MBVD) may be supported.
b. In Affine_IBC_MBVD, an affine IBC merge candidate (which is called, base affine IBC merge candidate) is selected, the BVs of the control points may be further refined by indications of the BVD information.
c. The BVD information for the BVs of all the control points may be the same.
   i. Alternatively, the BVD information for the BVs of at least two control points may be different.
d. In one example, a BV for a pixel or for a sub-block derived from an affine model may be rounded or clipped to the integer precision.
e. In one example, a BV prediction of a control point inherited from a neighbouring block or derived from an affine model may be rounded or clipped to the integer precision.
f. The BVD information for the BVs of the control points in the Affine_IBC_MBVD mode may be different from that utilized for the translational MBVD methods.
g. The affine BVD candidate list may only include integer BVD candidates.
   On joint usage of template matching and IBC

3. In one example, the derived BV by TM_IBC is used as the base candidates for MBVD (called TM_IBC_MBVD).
a. In TM_IBC_MBVD, a BV may be derived based on TM_IBC which may be further refined by the signaled BVDs information.
b. In one example, the BVDs may be signaled in the same manner as MBVD.
c. In one example, the BVDs may be signaled in the same manner as the non-merge IBC mode.
d. In one example, a syntax element may be signaled to indicate whether the derived BV by TM_IBC is further refined by MBVD.
   i. For example, the syntax element is signaled only if TM_IBC mode is applied.

4. In one example, the derived BV by TM_IBC may be used as a BV prediction candidate for non-merge IBC mode (a.k.a IBC AMVP mode).
a. In one example, the derived BV by TM_IBC may be the only candidate for non-merge IBC mode when it is available.
b. In one example, the derived BV by TM_IBC may be the k-th (e.g. the first) candidate for non-merge IBC mode when it is available.
c. In one example, a syntax element may be signaled to indicate whether the derived BV by TM_IBC may be used as a BV prediction candidate for non-merge IBC mode.
   i. For example, the syntax element is signaled only if TM_IBC mode is applied.

### On Multi-Hypothesis IBC

5. In one example, multi-hypothesis IBC prediction mode (called MHP_IBC) is supported, wherein one or more additional motion-compensated prediction signals are signaled/derived, different from the conventional way wherein only uni-prediction signal is used.
a. The resulting overall prediction signal is obtained by sample-wise weighted superposition.
   i. The resulting overall prediction signal is accumulated iteratively with each additional prediction signal as follows:

$${p}_{n + 1} = ( 1 - {α}_{n + 1} ) {p}_{n} + {α}_{n + 1} {h}_{n + 1}$$

ii. The resulting overall prediction signal is obtained as the last pₙ (i.e., the pₙ having the largest index n).
   (i) In one example, two additional prediction signals may be used (i.e., n is 2)
   (ii) In one example, one additional prediction signals may be used (i.e., n is 1)
iii. In one example, the weighting factor α may be predefined.
   (i) In one example, a is set to ½.
iv. In one example, the weighting factor α may be selected from a predefined set.
   (i) In one example, the predefined set is {½, ¼}.
   (ii) In one example, the predefined set is {¼, −⅛}.
   (iii) In one example, the predefined set is {½, ¼, −⅛}.
   (iv) In one example, the weighting factor α is specified by an index.
   (v) In one example, for determining the best weighting factor α, a simplified RD cost using Hadamard distortion measure and approximated bit rate is used.
v. In one example, the weighting factor α may be position-dependent for each sample.
   (i) For example, for some positions, α=1.
   (ii) For example, for some positions, α=0.
   (iii) For example, for some positions, α=½.
vi. In one example, the weighting factor α may be signaled from encoder to decoder.
b. The motion parameters of each additional prediction hypothesis can be signaled either explicitly by specifying the block vector predictor index, and the block vector difference, or implicitly by specifying a merge index.
   i. In one example, a separate multi-hypothesis IBC merge flag distinguishes between these two signalling modes.
   ii. For the explicitly signaled method, multi-hypothesis motion estimation is performed.
      (i) For the best two of IBC modes (i.e., having lowest Hadamard RD cost), additional IBC prediction hypotheses are searched. For that purpose, for each weighting factor, a motion estimation with a restricted search range of R is performed.
         a) In one example, R is set to 16.
      (ii) For determining the best weighting factor, a simplified RD cost using Hadamard distortion measure and approximated bit rate is used.
c. For normal IBC merge mode (non-MBVD, non-sub-block IBC merge), additional prediction signals can be explicitly signaled or implicitly inherited.
   i. In one example, all explicitly signaled additional prediction signals may use the same IBC AMVP candidate list which is generated for the first explicitly signaled additional prediction signal.
   ii. In one example, additional prediction signals may be explicitly signaled, but not in IBC SKIP mode.
   iii. In one example, additional prediction signals may be implicitly inherited, but not in IBC SKIP mode.
d. For MBVD mode, additional prediction signals can be explicitly signaled or implicitly inherited.
   i. In one example, additional prediction signals can be explicitly signaled, but not in MBVD SKIP mode.
   ii. In one example, additional prediction signals can be implicitly inherited, but not in MBVD SKIP mode
      (i) Alternatively, there is no inheritance/merging of additional prediction signals from merging candidates.
   iii. In one example, all explicitly signaled additional prediction signals may use the same AMVP candidate list which is generated for the first explicitly signaled additional prediction signal.
e. For sub-block IBC merge mode, additional prediction signals can be explicitly signaled or implicitly inherited.
   i. In one example, additional prediction signals can be explicitly signaled, but not in sub-block IBC SKIP mode.
   ii. In one example, additional prediction signals can be implicitly inherited, but not in sub-block IBC SKIP mode.
      (i) Alternatively, there is no inheritance/merging of additional prediction signals from merging candidates.
   iii. In one example, all explicitly signaled additional prediction signals may use the same AMVP candidate list which is generated for the first explicitly signaled additional prediction signal.
f. For non-affine IBC AMVP mode, additional prediction signals may be explicitly signaled or implicitly inherited.
   i. In one example, additional prediction signals can be explicitly signaled.
   ii. In one example, only one IBC AMVP candidate list may have to be constructed (for the first one, i.e. non-additional prediction signal).
   iii. In one example, for the additional prediction signals, the above IBC AMVP candidate list may be reused.
g. For affine IBC AMVP mode, additional prediction signals may be explicitly signaled or implicitly inherited.
   i. In one example, additional prediction signals can be explicitly signaled.
   ii. In one example, additional prediction signals may only support translational prediction signals.
   iii. In one example, one affine IBC AMVP candidate list have to be constructed (for the first one, i.e. non-additional prediction signal).
   iv. In one example, for the additional prediction signals, the above affine IBC AMVP candidate list may be reused.
   v. In one example, the affine IBC top left my predictor may be used as the my predictor for the additional translational prediction signal.
      (i) Alternatively, the affine IBC top right or bottom left my predictor may be used as the my predictor for the additional translational prediction signal.
h. Multi-hypothesis IBC prediction may not be used together with combined IBC and inter mode or combined intra and IBC mode within one PU.
   i. In one example, if combined IBC and inter mode is selected with an IBC merging candidate that has additional prediction signals, those additional prediction signals may not be inherited/merged.
   ii. In one example, if combined intra and IBC mode is selected with an IBC merging candidate that has additional prediction signals, those additional prediction signals may not be inherited/merged.
   iii. In one example, additional prediction signals may not be explicitly signaled in combined IBC and inter mode.
   iv. In one example, additional prediction signals may not be explicitly signaled in combined intra and IBC mode.
i. Multi-hypothesis IBC prediction may not be used together with TPM_IBC or GPM_IBC within one PU.
   i. In one example, if TPM_IBC mode is selected with an IBC merging candidate that has additional prediction signals, those additional prediction signals may not be inherited/merged.
   ii. In one example, if GPM_IBC mode is selected with an IBC merging candidate that has additional prediction signals, those additional prediction signals may not be inherited/merged.
   iii. In one example, additional prediction signals may not be explicitly signaled in TPM_IBC mode.
   iv. In one example, additional prediction signals may not be explicitly signaled in GPM_IBC mode.
      On joint usage of OBMC and IBC

6. In one example, OBMC may be applied for IBC mode.
a. In one example, for CU-boundary OBMC and/or subblock-boundary OBMC, the motion type of current block and the neighboring block used for OBMC may be the same.
   i. In one example, the motion type may be IBC.
   ii. In one example, the motion type may be regular inter.
b. In one example, for CU-boundary OBMC and/or subblock-boundary OBMC, the motion type of current block and the neighboring block used for OBMC may be different.
   i. In one example, one motion type may be IBC and the other motion type may be regular inter.
c. Alternatively, furthermore, when and/or how to apply OBMC for IBC coded blocks may be different from those for non-IBC coded blocks.
   i. In one example, the setting of weights may be different.
      On extension of GPM IBC

It is proposed that BV derived from a candidate list for an IBC coded block with geometry/triangle partitions may be further refined before being used to derive the prediction signal.

7. In one example, a GPM_IBC with MBVD is supported for IBC mode (called GPM_IBC_MBVD).
a. In one example, additional BV differences (BVDs) may be further applied on top of the existing GPM_IBC merge candidates.
b. In one example, the BVDs may be signaled in the same manner as MBVD.
c. In one example, two flags may be signaled to separately indicate whether additional BVD is applied to each GPM_IBC partition.
   i. Alternatively, one single flag may be signaled to jointly control whether additional BVD is applied to each GPM_IBC partition.
   ii. When the flag of one GPM_IBC partition is true, its corresponding BVD may be signaled in the same way as the MBVD, i.e., one distance index plus one direction index.
d. In one example, the merge indices of two GPM_IBC partitions may be allowed to be the same when the BVDs that are applied to the two partitions are not identical.
e. In one example, an BV pruning procedure may be introduced to construct the GPM_IBC merge candidate list when GPM_IBC with MBVD is applied.
   i. In one example, the pruning procedure may be based on a threshold.
      (i) In one example, if the differences of the horizontal and the vertical components for two BVs are both smaller than a threshold, one of them may be removed from the GPM_IBC list.
         a) Alternatively, if the horizontal and the vertical components for two BVs are both the same, one of them may be removed from the GPM_IBC list.
      (ii) In one example, the threshold may be decided by current block size.
         a) Alternatively, the threshold may be predefined.
f. In one example, a distance index specifies motion magnitude information and indicates the pre-defined offset from the starting point.
   i. An offset may be added to either horizontal component or vertical component of starting MV.
   ii. An offset may be added to both horizontal component and vertical component of starting MV.
   iii. In one example, the distance set may be {1-pel, 2-pel, 4-pel, 8-pel, 16-pel, 32-pel}.
   iv. In one example, the distance set may be {1-pel, 2-pel, 4-pel, 8-pel, 16-pel, 32-pel, 64-pel, 128-pel}.
   v. In one example, the distance set may be {1-pel, 2-pel, 3-pel, 4-pel, 6-pel, 8-pel, 16-pel}.
   vi. In one example, the distance set may be {1-pel, 2-pel, 3-pel, 4-pel, 6-pel, 8-pel, 16-pel, 32-pel, 64-pel}.
g. In one example, a direction index represents the direction of the BVD relative to the starting point. The direction index can represent of the M BVD directions.
   i. In one example, M is set to 4.
      (i) In one example, 4 horizontal/vertical directions may be used.
      (ii) In one example, 4 diagonal directions may be used.
   ii. In one example, M is set to 8.
      (i) In one example, 4 horizontal/vertical directions plus 4 diagonal directions may be used.

8. In one example, a GPM_IBC with template matching (TM) is supported for IBC mode (called GPM_IBC_TM).
a. In one example, when GPM_IBC mode is enabled for a CU, a CU-level flag may be signaled to indicate whether TM is applied to both geometric partitions.
   i. Alternatively, when GPM_IBC mode is enabled for a CU, two CU-level flags may be signaled to indicate whether TM is applied to each geometric partition.
b. In one example, motion information for a geometric partition may be refined using TM.
   i. In one example, if only above template is available for current block, the GPM_IBC_TM mode can only use the above template.
   ii. In one example, if only left template is available for current block, the GPM_IBC_TM mode can only use the left template.
   iii. In one example, if both above and left templates are available for current block, the GPM_IBC_TM mode can use the left template, the above template, or both above and left templates.
   iv. When TM is chosen, a template may be constructed using left, above or left and above neighboring samples according to partition angle.
      (i) One example is shown in Table 4.
   v. In one example, the motion may be refined by minimizing the difference between the current template and the reference template in the current picture using the same search pattern of TM merge mode.
c. In one example, the GPM_IBC_MBVD and GPM_IBC_TM may be exclusively enabled to one GPM_IBC block.

The embodiments of the present disclosure are related to IBC mode extension. As used herein, the term “block” may represent a coding tree block (CTB), a coding tree unit (CTU), a coding block (CB), a coding unit (CU), a prediction unit (PU), a transform unit (TU), a prediction block (PB), a transform block (TB), or a video processing unit comprising a plurality of samples or pixels. A block may be rectangular or non-rectangular.

For an intra block copy (IBC) coded block, a block vector (BV) may be used to indicate a displacement from the current block and a reference block, which is reconstructed inside the current picture.

Wand H are the width and height of current block (e.g., luma block).

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM may be also treated as GPM.

In the following, Mv1 and Mv2 are the motion vectors from the first part and the second part of the triangle or geometric partition.

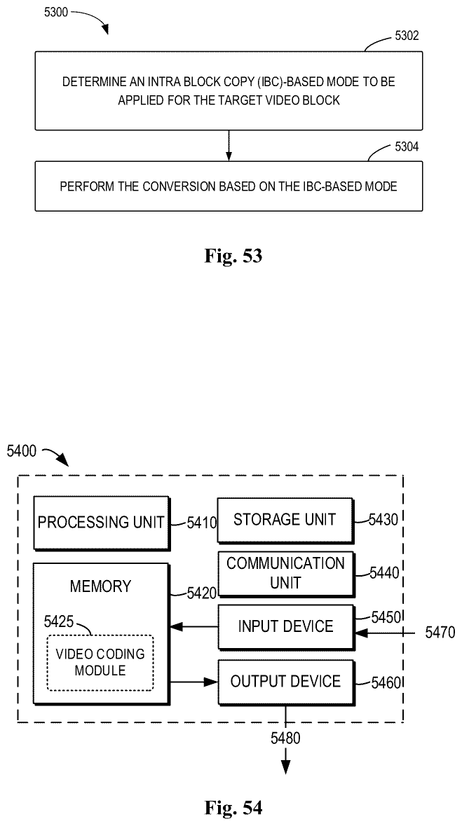

FIG. 53 illustrates a flowchart of a method 5300 for video processing in accordance with some embodiments of the present disclosure. The method 5300 may be implemented during a conversion between a target video block of a video and a bitstream of the video.

As shown in FIG. 53, at block 5302, during a conversion between a target video block of a video and a bitstream of the video, an intra block copy (IBC)-based mode is determined to be applied for the target video block. A target video block may be comprised in a target picture of the video. A target video block may sometimes be referred to a current block or a current video block, which may be of various sizes. As used herein, “motion information” may also be referred to as motion data. In embodiments of the present disclosure, the IBC-based mode being based on at least one of the following: an IBC mode based on affine motion compensated prediction, an affine IBC MBVD, an TM_IBC, wherein a derived BV by the TM_IBC is used as base candidates for the MBVD, an intra template matching for IBC mode (TM_IBC), wherein a derived block vector (BV) by the TM_IBC is used as BV prediction candidate for IBC non-merge mode, an IBC prediction mode based on multi-hypothesis, an IBC mode based on OBMC, an IBC mode based on geometric partitioning with the MBVD, or an IBC mode based on geometric partitioning with TM; and generating the bitstream based on the IBC-based mode.

At block 5304, the conversion is performed based on the IBC-based mode.

In the IBC-based mode, at least IBC related operations may be performed. In some embodiments, in the IBC-based mode, prediction samples may be at least derived from blocks of sample values of a same video region as determined by block vectors. Additionally, other principles, operations, and/or implementations may be further applied in each of the IBC-based modes proposed in the present disclosure. Some implementations related to respective IBC-based modes will be further discussed in the following.

In some embodiments, the conversion includes encoding the target video block into the bitstream. In such embodiments, the method of the present disclosure may be implemented at an encoder. In some embodiments, the conversion includes decoding the target video block from the bitstream. In such embodiments, the method of the present disclosure may be implemented at a decoder. In some embodiments, a bitstream of the video is generated based on a result of the multi-hypothesis prediction process. The bitstream may be stored in a non-transitory computer-readable recording medium.

According to embodiments of the present disclosure, it is proposed that more IBC-based modes are supported and corresponding implementations in respective IBC-based modes are provided. In this way, IBC coding may be further improved, and thus, the coding efficiency of IBC mode may be improved.

Implementations of the present disclosure can be described in view of the following clauses, the features of which can be combined in any reasonable manner.

For example, the IBC-based mode may refer to non-translational IBC mode. It is proposed to utilize affine motion model to predict a current block from the reconstructed samples or pixels within the same picture.

In some embodiments, if the IBC mode based on affine motion compensated prediction, which may also be called as an Affine_IBC, is to be applied, an affine motion field of the target video block is described by motion information of two control points, e.g., 4-parameter affine model or three control points, e.g., 6-parameter affine model.

In some embodiments, there may be two affine motion IBC prediction modes, namely affine IBC merge mode and affine IBC AMVP mode. In some embodiments, the affine IBC merge mode may be performed similar as the affine merge mode. In some other embodiments, the affine IBC AMVP mode may be performed similar as the affine AMVP mode.

In some embodiments, a BV for a pixel or for a sub-block derived from an affine model may be rounded or clipped to the integer precision. In some embodiments, a BV prediction of a control point inherited from a neighbouring block or derived from an affine model may be rounded or clipped to the integer precision.

In some embodiments, the prediction refinement with optical flow may be also supported for the affine_IBC mode. In some embodiments, the prediction refinement with optical flow for the affine_IBC mode may be performed similar as prediction refinement with optical flow for affine mode.

In some embodiments, the proposed Affine_IBC mode could be a merge mode wherein no BVD is coded. Alternatively, the Affine_IBC mode could be an inter mode wherein an indication of a BVD may be coded. Alternatively, the Affine_IBC mode could be a merge mode wherein indications of BVDs within an affine BVD candidate list may be coded or derived, such as index of a BVD is coded.

In some embodiments, the BVs of the control points used in the Affine_IBC mode may be derived according to the BV(s) derived from an affine BV candidate list and the BVD(s) selected from a given affine BVD candidate list.

In some embodiments, if the affine IBC with MBVD, which may also be called as Affine_IBC_MBVD, is to be applied, an affine IBC merge candidate is selected, the BVs of the control points may be further refined by the indications of the BVD information.. The affine IBC merge candidate may also be called as base affine IBC merge candidate.

In some embodiments, the BVD information for the BVs of all the control points may be the same. In some other embodiments, the BVD information for the BVs of at least two control points may be different.

In some embodiments, a BV for a pixel or for a sub-block derived from an affine model may be rounded or clipped to the integer precision.

In some embodiments, a BV prediction of a control point inherited from a neighbouring block or derived from an affine model may be rounded or clipped to the integer precision.

In some embodiments, the BVD information for the BVs of the control points in the Affine_IBC_MBVD mode may be different from that utilized for the translational MBVD methods.

In some embodiments, the affine BVD candidate list may only include integer BVD candidates.

On joint usage of template matching and IBC, in some embodiments, if derived BV by TM_IBC is used as the base candidates for MBVD, which may also be called as TM_IBC_MBVD, a BV may be derived based on TM_IBC which may be further refined by the signaled BVDs information. In some embodiments, the BVDs may be indicated in the same manner as MBVD. In some other embodiments, the BVDs may be signaled in the same manner as the non-merge IBC mode.

In some embodiments, a syntax element may be signaled to indicate whether the derived BV by TM_IBC is further refined by MBVD. For example, the syntax element is signaled only if TM_IBC mode is applied.

In some embodiments, the derived BV by TM_IBC may be used as a BV prediction candidate for non-merge IBC mode (which may also be called as IBC AMVP mode). In some examples, the derived BV by TM_IBC may be the only candidate for non-merge IBC mode when it is available. In some other examples, the derived BV by TM_IBC may be the k-th candidate (e.g., the first candidate) for non-merge IBC mode when it is available.

In some embodiments, a syntax element may be signaled to indicate whether the derived BV by TM_IBC may be used as a BV prediction candidate for non-merge IBC mode. For example, the syntax element is signaled only if TM_IBC mode is applied.

On multi-hypothesis IBC, in some embodiments, if the multi-hypothesis IBC prediction mode, which may also be called as MHP_IBC is to be applied, one or more additional motion-compensated prediction signals are signaled/derived, different from the conventional way wherein only uni-prediction signal is used.

In some embodiments, the resulting overall prediction signal is obtained by sample-wise weighted superposition. In some embodiments, the resulting overall prediction signal is accumulated iteratively with each additional prediction signal as follows:

$${p}_{n + 1} = ( 1 - {α}_{n + 1} ) {p}_{n} + {α}_{n + 1} {h}_{n + 1}$$

In some embodiments, the resulting overall prediction signal is obtained as the last pₙ. That is, the pₙ having the largest index n. In some embodiments, two additional prediction signals may be used, i.e., n is 2. In some other embodiments, one additional prediction signals may be used, i.e., n is 1.

In some embodiments, the weighting factor for sample-wise weighted superposition a may be predefined. For example, a is set to ½.

In some embodiments, the weighting factor α may be selected from a predefined set. In some embodiments, the predefined set may be {½, ¼}, {¼, −⅛}, or {½, ¼, −⅛}.

In some embodiments, the weighting factor α may be specified by an index.

In some embodiments, for determining the best weighting factor α, a simplified RD cost using Hadamard distortion measure and approximated bit rate is used.

In some embodiments, the weighting factor α may be position-dependent for each sample. For example, for some positions, a may equal to 1. As another option, for some positions, a may equal to 0. Alternatively, for some positions, a may equal to ½.

In some embodiments, if the MHP_IBC is to be applied, the motion parameters of each additional prediction hypothesis can be indicated either explicitly by specifying the block vector predictor index and the block vector difference, which may also be called as a first indicating mode, or implicitly by specifying a merge index, which may also be called as a second indicating mode.

In some embodiments, the first indicating mode and the second indicating mode are distinguished with each other by a separate multi-hypothesis IBC merge flag. In some embodiments, the multi-hypothesis motion estimation is performed in the first indicating mode.

In some embodiments, additional IBC prediction hypotheses are searched for a predefined number of IBC modes, i.e., IBC modes having a Hadamard RD cost lower than a threshold Hadamard RD cost. For example, two best of IBC modes may be searched, i.e., having lowest Hadamard RD cost. For that purpose, for each weighting factor, a motion estimation with a restricted search range of R is performed. For example, R is set to 16.

In some embodiments, for determining the best weighting factor, a simplified RD cost using Hadamard distortion measure and approximated bit rate is used.

In some embodiments, if the MHP_IBC is to be applied, additional prediction signals can be explicitly signaled or implicitly inherited for a normal IBC merge mode, which may be referred to as a non-MBVD or a non-sub-block IBC merge. In some embodiments, all explicitly signaled additional prediction signals may use the same IBC AMVP candidate list which is generated for the first explicitly signaled additional prediction signal. In some embodiments, additional prediction signals may be explicitly signaled, but not in IBC SKIP mode. In some other embodiments, additional prediction signals may be implicitly inherited, but not in IBC SKIP mode.

In some embodiments, if the MHP_IBC is to be applied, additional prediction signals can be explicitly signaled or implicitly inherited for MBVD mode. In some embodiments, additional prediction signals can be explicitly signaled, but not in MBVD SKIP mode. In some other embodiments, additional prediction signals can be implicitly inherited, but not in MBVD SKIP mode. Alternatively, there is no inheritance/merging of additional prediction signals from merging candidates. In some embodiments, all explicitly signaled additional prediction signals may use the same AMVP candidate list which is generated for the first explicitly signaled additional prediction signal.

In some embodiments, if the MHP_IBC is to be applied, the additional prediction signals can be explicitly signaled or implicitly inherited for sub-block IBC merge mode. In some embodiments, the additional prediction signals can be explicitly signaled, but not in sub-block IBC SKIP mode. In some other embodiments, the additional prediction signals can be implicitly inherited, but not in sub-block IBC SKIP mode. Alternatively, there is no inheritance/merging of additional prediction signals from merging candidates. In some embodiments, all explicitly signaled additional prediction signals may use the same AMVP candidate list which is generated for the first explicitly signaled additional prediction signal.

In some embodiments, if the MHP_IBC is to be applied, the additional prediction signals may be explicitly signaled or implicitly inherited for non-affine IBC AMVP mode. In some embodiments, additional prediction signals can be explicitly signaled. In some embodiments, only one IBC AMVP candidate list may have to be constructed, for example, for the first additional prediction signal, i.e., a non-additional prediction signal. In some embodiments, for the additional prediction signals, the above IBC AMVP candidate list may be reused.

In some embodiments, if the MHP_IBC is to be applied, the additional prediction signals may be explicitly signaled or implicitly inherited for affine IBC AMVP mode. For example, the additional prediction signals can be explicitly signaled. In some embodiments, additional prediction signals may only support translational prediction signals.

In this case, one affine IBC AMVP candidate list may have to be constructed, for example, for the first additional prediction signal, i.e., a non-additional prediction signal. For the additional prediction signals, the above affine IBC AMVP candidate list may be reused. In some embodiments, the affine IBC top left my predictor may be used as the my predictor for the additional translational prediction signal. Alternatively, the affine IBC top right or bottom left my predictor may be used as the my predictor for the additional translational prediction signal.

In some embodiments, if the MHP_IBC is to be applied, multi-hypothesis IBC prediction may not be used together with combined IBC and inter mode or combined intra and IBC mode within one prediction unit (PU).

In some embodiments, if combined IBC and inter mode is selected with an IBC merging candidate that has additional prediction signals, those additional prediction signals may not be inherited/merged. In some embodiments, if combined intra and IBC mode is selected with an IBC merging candidate that has additional prediction signals, those additional prediction signals may not be inherited/merged.

In some embodiments, additional prediction signals may not be explicitly signaled in combined IBC and inter mode. In some embodiments, additional prediction signals may not be explicitly signaled in combined intra and IBC mode.

In some embodiments, if the MHP_IBC is to be applied, multi-hypothesis IBC prediction may not be used together with TPM_IBC or GPM_IBC within one PU.

In some embodiments, if TPM_IBC mode is selected with an IBC merging candidate that has additional prediction signals, those additional prediction signals may not be inherited/merged. In some embodiments, if GPM_IBC mode is selected with an IBC merging candidate that has additional prediction signals, those additional prediction signals may not be inherited/merged.

In some embodiments, additional prediction signals may not be explicitly signaled in TPM_IBC mode. In some embodiments, additional prediction signals may not be explicitly signaled in GPM_IBC mode.

On joint usage of OBMC and IBC, in some embodiments, if an IBC mode based on OBMC is to be applied, the motion type of current block and the neighboring block used for OBMC may be the same for at least one of CU-boundary OBMC or subblock-boundary OBMC. In some embodiments, the motion type may be IBC. In some other embodiments, the motion type may be regular inter.

In some embodiments, if an IBC mode based on OBMC is to be applied, the motion type of current block and the neighboring block used for OBMC may be different for at least one of CU-boundary OBMC or subblock-boundary OBMC. In some embodiments, one motion type may be IBC and the other motion type may be regular inter.

In some embodiments, furthermore, when and/or how to apply OBMC for IBC coded blocks may be different from those for non-IBC coded blocks. For example, the setting of weights may be different.

On extension of GPM IBC, it is proposed that BV derived from a candidate list for an IBC coded block with geometry/triangle partitions may be further refined before being used to derive the prediction signal.

In some embodiments, if an IBC mode based on geometric partitioning with the MBVD, which may also be called as GPM_IBC_MBVD, is to be applied, additional BV differences (BVDs) may be further applied on top of the existing GPM_IBC merge candidates.

In some embodiments, the BVDs may be signaled in the same manner as MBVD. In some embodiments, two flags may be signaled to separately indicate whether additional BVD is applied to each GPM_IBC partition. Alternatively, one single flag may be signaled to jointly control whether additional BVD is applied to each GPM_IBC partition. In this case, when the flag of one GPM_IBC partition is true, its corresponding BVD may be signaled in the same way as the MBVD, i.e., one distance index plus one direction index.

In some embodiments, the merge indices of two GPM_IBC partitions may be allowed to be the same when the BVDs that are applied to the two partitions are not identical.

In some embodiments, if the GPM_IBC_MBVD is to be applied, an BV pruning procedure may be introduced to construct the GPM_IBC merge candidate list when GPM_IBC with MBVD is applied.

In some embodiments, the pruning procedure may be based on a threshold. For example, if the differences of the horizontal and the vertical components for two BVs are both smaller than a threshold, one of them may be removed from the GPM_IBC list. Alternatively, if the horizontal and the vertical components for two BVs are both the same, one of them may be removed from the GPM_IBC list.

In some embodiments, the threshold may be decided by current block size. Alternatively, the threshold may be predefined.

In some embodiments, if the GPM_IBC_MBVD is to be applied, a distance index may specify motion magnitude information and indicate the pre-defined offset from the starting point. In some embodiments, an offset may be added to either horizontal component or vertical component of starting MV. In some other embodiments, an offset may be added to both horizontal component and vertical component of starting MV.

In some embodiments, the distance set may be {1-pel, 2-pel, 4-pel, 8-pel, 16-pel, 32-pel}. In some other embodiments, the distance set may be {1-pel, 2-pel, 4-pel, 8-pel, 16-pel, 32-pel, 64-pel, 128-pel}. In some other embodiments, the distance set may be {1-pel, 2-pel, 3-pel, 4-pel, 6-pel, 8-pel, 16-pel}. In some other embodiments, the distance set may be {1-pel, 2-pel, 3-pel, 4-pel, 6-pel, 8-pel, 16-pel, 32-pel, 64-pel}.

In some embodiments, if the GPM_IBC_MBVD is to be applied, a direction index represents the direction of the BVD relative to the starting point. For example, the direction index can represent of the M BVD directions.

As an example, M is set to 4. In this case, 4 horizontal directions or 4 vertical directions may be used. Alternatively, 4 diagonal directions may be used.

As another example, M is set to 8. In this case, 4 horizontal directions plus 4 diagonal directions may be used. Alternatively, 4 vertical directions plus 4 diagonal directions may be used.

In some embodiments, if an IBC mode based on geometric partitioning with template matching (TM), which may also be called as GPM_IBC_TM, is to be applied, when GPM_IBC mode is enabled for a CU, a CU-level flag may be signaled to indicate whether TM is applied to both geometric partitions. Alternatively, when GPM_IBC mode is enabled for a CU, two CU-level flags may be signaled to indicate whether TM is applied to each geometric partition.

In some embodiments, if the GPM_IBC_TM is to be applied, motion information for a geometric partition may be refined using TM. As an option, if only above template is available for current block, the GPM_IBC_TM mode can only use the above template. As another option, if only left template is available for current block, the GPM_IBC_TM mode can only use the left template. Alternatively, if both above and left templates are available for current block, the GPM_IBC_TM mode can use the left template, the above template, or both above and left templates.

In some embodiments, when TM is chosen, a template may be constructed using left, above or left and above neighboring samples according to partition angle. For example, one example is shown in Table 4.

In some embodiments, the motion may be refined by minimizing the difference between the current template and the reference template in the current picture using the same search pattern of TM merge mode.

In some embodiments, the GPM_IBC_MBVD and GPM_IBC_TM may be exclusively enabled to one GPM_IBC block.

According to embodiments of the present disclosure, it is proposed that more IBC-based modes are supported and corresponding implementations in respective IBC-based modes are provided. In this way, IBC coding may be further improved, and thus, the coding efficiency of IBC mode may be improved.

Implementations of the present disclosure can be described in view of the following clauses, the features of which can be combined in any reasonable manner.

Clause 1. A method for video processing, comprising: determining, during a conversion between a target video block of a video and a bitstream of the video, an intra block copy (IBC)-based mode to be applied for the target video block, the IBC-based mode being based on at least one of the following: an IBC mode based on affine motion compensated prediction (Affine_IBC), an affine IBC merge mode with block vector differences (MBVD), an intra template matching for IBC mode (TM_IBC), wherein a derived block vector (BV) by the TM_IBC is used as base candidates for the MBVD, an intra template matching for IBC mode (TM_IBC), wherein a derived block vector (BV) by the TM_IBC is used as BV prediction candidate for IBC non-merge mode, an IBC prediction mode based on multi-hypothesis, an IBC mode based on overlapped block motion compensation (OBMC), an IBC mode based on geometric partitioning with the MBVD, or an IBC mode based on geometric partitioning with template matching (TM); and performing the conversion based on the IBC-based mode.

Clause 2. The method of clause 1, wherein an affine motion model is utilized to predict the target video block from the reconstructed samples or pixels within the same picture.

Clause 3. The method of clause 1 or 2, wherein Affine_IBC mode is to be applied, and wherein an affine motion field of the target video block is described by motion information of two control points or three control points.

Clause 4. The method of clause 3, wherein the affine motion field of the target video block is described by the motion information of 4 parameter affine model or 6 parameter affine model.

Clause 5. The method of any of clauses 1-4, wherein the Affine_IBC mode comprises an affine IBC merge mode and affine IBC advanced motion vector prediction (AMVP) mode.

Clause 6. The method of clause 5, wherein the affine IBC merge mode is performed similar as an affine merge mode.

Clause 7. The method of clause 6, wherein the affine IBC AMVP mode is performed similar as an affine AMVP mode.

Clause 8. The method of clause 1, wherein a BV for a pixel of the target video block or for a sub-block of the target video block derived from an affine model is rounded or clipped to the integer precision.

Clause 9. The method of clause 1, wherein a BV prediction of a control point inherited from a neighbouring video block of the target video block or derived from an affine model is rounded or clipped to the integer precision.

Clause 10. The method of clause 1, wherein a prediction refinement with optical flow is used for the IBC mode based on affine motion compensated prediction.

Clause 11. The method of clause 10, wherein the prediction refinement with optical flow for the IBC mode based on affine motion compensated prediction is performed similar as a prediction refinement with optical flow for an affine mode.

Clause 12. The method of clause 1, wherein the Affine_IBC mode is a merge mode wherein no BV difference (BVD) is coded.

Clause 13. The method of clause 1, wherein the Affine_IBC mode is an inter mode wherein an indication of a BV difference (BVD) is coded.

Clause 14. The method of clause 1, wherein the Affine_IBC mode is a merge mode wherein indications of BV differences (BVDs) within an affine BVD candidate list are coded or derived.

Clause 15. The method of clause 14, wherein an index of a BVD is coded.

Clause 16. The method of clause 1, wherein block vectors of control points used in the Affine_IBC mode may be derived according to one or more BVs derived from an affine BV candidate list and one or more BV differences (BVDs) selected from a given affine BVD candidate list.

Clause 17. The method of clause 16, wherein the affine IBC MBVD mode is to be applied, and wherein an affine IBC merge candidate is selected, and BVs of control points are further refined by indicated block vector difference (BVD) information.

Clause 18. The method of clause 17, wherein the BVD information for the BVs of all control points are the same or different.

Clause 19. The method of clause 17, wherein the BVD information for the BVs of at least two control points are different.

Clause 20. The method of clause 17, wherein a BV for a pixel of the target video block or for a sub-block of the target video block derived from an affine model is rounded or clipped to an integer precision.

Clause 21. The method of clause 17, wherein a BV prediction of a control point inherited from a neighbouring block of the target video block or derived from an affine model is rounded or clipped to the integer precision.

Clause 22. The method of clause 17, wherein the BVD information for the BVs of control points in the Affine_IBC_MBVD mode is different from that utilized for a translational MBVD methods.

Clause 23 The method of clause 17, wherein the affine BVD candidate list only includes integer BVD candidates.

Clause 24. The method of clause 1, wherein if the derived BV by the TM_IBC is used as the base candidates for the MBVD, the BV is further refined by indicated block vector difference (BVD) information.

Clause 25. The method of clause 24, wherein BVDs are indicated in a same manner as MBVD.

Clause 26. The method of clause 24, wherein the BVDs are signaled in the same manner as the IBC non-merge mode.

Clause 27. The method of clause 24, wherein a syntax element indicates whether the derived BV by the TM_IBC is further refined by the MBVD.

Clause 28. The method of clause 27, wherein the syntax element is indicated only if the TM_IBC mode is applied.

Clause 29. The method of clause 1, wherein the derived BV by the TM_IBC is the only candidate for the IBC non-merge mode if the derived BV is available.

Clause 30. The method of clause 1, wherein the derived BV by the TM_IBC is the k-th candidate for the IBC non-merge mode if the derived BV is available.

Clause 31. The method of clause 30, wherein the k-th candidate is the first candidate.

Clause 32. The method of clause 1, wherein a syntax element indicates whether the derived BV by the TM_IBC is used as a BV prediction candidate for the IBC non-merge mode.

Clause 33. The method of clause 32, wherein the syntax element is indicated only if the TM_IBC mode is applied.

Clause 34. The method of clause 1, wherein the IBC prediction mode based on multi-hypothesis is to be applied, and wherein one or more additional prediction signals for motion-compensating are indicated, in addition to a conventional uni-prediction signal.

Clause 35. The method of clause 1, wherein the one or more additional prediction signals for motion-compensating are indicated or derived and different from that in a case where only uni-prediction signal is used.

Clause 36. The method of clause 34, wherein a resulting overall prediction signal is derived by a sample-wise weighted superposition.

Clause 37. The method of clause 36, wherein the resulting overall prediction signal is accumulated iteratively with each additional prediction signal as pₙ+i=(1−αₙ+₁)pₙ+αₙ+₁hₙ+₁.

Clause 38. The method of clause 36, wherein resulting overall prediction signal is derived as the last weighted prediction signal having the largest index (n+1).

Clause 39. The method of clause 38, wherein one or two additional prediction signals are used.

Clause 40. The method of clause 36, wherein a weighting factor for the sample-wise weighted superposition is predefined.

Clause 41. The method of clause 40, wherein the weighting factor is set to ½.

Clause 42. The method of clause 36, wherein a weighting factor for the sample-wise weighted superposition is selected from a predefined set.

Clause 43. The method of clause 42, wherein the predefined set comprises one of {½, ¼}, {¼, −⅛}, or {½, ¼, −⅛}.

Clause 44. The method of clause 42, wherein the weighting factor is specified by an index.

Clause 45. The method of clause 42, wherein a simplified Rate Distortion (RD) cost using Hadamard distortion measure and approximated bit rate is used for determining the best weighting factor.

Clause 46. The method of clause 36, wherein a weighting factor for the sample-wise weighted superposition is position-dependent for each sample.

Clause 47. The method of clause 46, wherein the weighting factor is set to 1, 0, or ½.

Clause 48. The method of clause 36, wherein a weighting factor for the sample-wise weighted superposition is indicated from encoder to decoder.

Clause 49. The method of clause 34, wherein motion parameters of each additional prediction hypothesis are indicated by a first indicating mode in which the motion parameters of each additional prediction hypothesis are indicated explicitly by specifying a block vector predictor index and a block vector difference, or a second indicating mode in which the motion parameters of each additional prediction hypothesis are indicated implicitly by specifying a merge index.

Clause 50. The method of clause 49, wherein the first indicating mode and the second indicating mode are distinguished with each other by a separate multi-hypothesis IBC merge flag.

Clause 51. The method of clause 49, wherein multi-hypothesis motion estimation is performed in the first indicating mode.

Clause 52. The method of clause 51, wherein additional IBC prediction hypotheses are searched for a predefined number (N) of IBC modes having first N lowest Hadamard Rate Distortion (RD) costs.

Clause 53. he method of clause 51, wherein the additional IBC prediction hypotheses are searched for two of IBC modes having first two lowest Hadamard RD costs.

Clause 54. The method of clause 51, wherein a motion estimation with a restricted search range is performed for the searching.

Clause 55. The method of clause 54, wherein the restricted search range is set to 16.

Clause 56. The method of clause 51, wherein a simplified Rate Distortion (RD) cost using Hadamard distortion measure and approximated bit rate is used for determining the best weighting factor.

Clause 57. The method of clause 34, wherein the additional prediction signals are explicitly indicated or implicitly inherited for a normal IBC merge mode.

Clause 58. The method of clause 57, wherein the explicitly indicated additional prediction signals use a same IBC advanced motion vector prediction (AMVP) candidate list which is generated for a first explicitly indicated additional prediction signal.

Clause 59. The method of clause 57, wherein the additional prediction signals are explicitly indicated or implicitly inherited except for an IBC SKIP mode.

Clause 60. The method of clause 34, wherein the additional prediction signals are explicitly indicated or implicitly inherited for the MBVD mode.

Clause 61. The method of clause 60, wherein the additional prediction signals are explicitly indicated or implicitly inherited except for an MBVD IBC SKIP mode.

Clause 62. The method of clause 61, wherein there is no inheritance or merging of the additional prediction signals from merging candidates.

Clause 63. The method of clause 60, wherein all explicitly indicated additional prediction signals use the same advanced motion vector prediction (AMVP) candidate list which is generated for the first explicitly signaled additional prediction signal.

Clause 64. The method of clause 34, wherein the additional prediction signals are explicitly indicated or implicitly inherited for a sub-block IBC merge mode.

Clause 65. The method of clause 64, wherein the additional prediction signals are explicitly indicated or implicitly inherited except for an IBC SKIP mode.

Clause 66. The method of clause 65, wherein there is no inheritance or merging of the additional prediction signals from merging candidates.

Clause 67. The method of clause 64, wherein all explicitly indicated additional prediction signals use the same advanced motion vector prediction (AMVP) candidate list which is generated for the first explicitly signaled additional prediction signal.

Clause 68. The method of clause 34, wherein the additional prediction signals are explicitly indicated or implicitly inherited for a non-affine IBC AMVP mode.

Clause 69. The method of clause 68, wherein only one IBC AMVP candidate list is to be constructed.

Clause 70. The method of clause 69, wherein the only one IBC AMVP candidate list is to be constructed for a non-additional prediction signal.

Clause 71. The method of clause 69, wherein the IBC AMVP candidate list is reused for the additional prediction signals.

Clause 72. The method of clause 34, wherein the additional prediction signals are explicitly indicated or implicitly inherited for an affine IBC AMVP mode.

Clause 73. The method of clause 72, wherein the additional prediction signals only support translational prediction signals.

Clause 74. The method of clause 72, wherein an IBC AMVP candidate list is to be constructed.

Clause 75. The method of clause 74, wherein the IBC AMVP candidate list is to be constructed for a non-additional prediction signal.

Clause 76. The method of clause 74, wherein the IBC AMVP candidate list is reused for the additional prediction signals.

Clause 77. The method of any of clauses 74-76, wherein an affine IBC top left control point motion vector (MV) predictor is used as a MV predictor for the additional translational prediction signals.

Clause 78. The method of any of clauses 74-76, wherein an affine IBC top right or bottom left control point motion vector (MV) predictor is used as an MV predictor for the additional translational prediction signals.

Clause 79. The method of clause 34, wherein the IBC prediction mode with the multi-hypothesis is not used together with at least one of the following within a prediction unit (PU): a combined IBC and inter mode, or a combined intra and IBC mode.

Clause 80. The method of clause 79, wherein if the combined IBC and inter mode is selected with an IBC merging candidate that has the additional prediction signals, the additional prediction signals are not inherited or merged.

Clause 81. The method of clause 79, wherein if the combined intra and IBC mode is selected with an IBC merging candidate that has the additional prediction signals, the additional prediction signals are not inherited or merged.

Clause 82. The method of clause 79 or 80, wherein the additional prediction signals are not explicitly indicated in the combined IBC and inter mode.

Clause 83. The method of clause 79 or 81, wherein the additional prediction signals are explicitly indicated in the combined intra and IBC mode.

Clause 84. The method of clause 34, wherein the IBC prediction mode with the multi-hypothesis is not used together with at least one of the following within a prediction unit (PU): an IBC mode based on a triangle partition (TPM_IBC), or an IBC mode based on geometric partitioning (GPM_IBC).

Clause 85. The method of clause 84, wherein if the TPM_IBC mode is selected with an IBC merging candidate that has the additional prediction signals, the additional prediction signals may not be inherited or merged.

Clause 86. The method of clause 84, wherein if the GPM_IBC mode is selected with an IBC merging candidate that has the additional prediction signals, the additional prediction signals are not inherited or merged.

Clause 87. The method of clause 84 or 85, wherein the additional prediction signals are not explicitly indicated in the TPM_IBC mode.

Clause 88. The method of clause 84 or 86, wherein the additional prediction signals are not explicitly indicated in the GPM_IBC mode.

Clause 89. The method of clause 1, wherein the IBC mode based on the OBMC is to be applied, and wherein a motion type of the target video block and a neighboring video block used for the OBMC are the same for at least one of the following: a coding unit (CU) boundary OBMC, or a subblock boundary OBMC.

Clause 90. The method of clause 89, wherein the motion type is IBC or regular inter.

Clause 91. The method of clause 1, wherein the IBC mode based on the OBMC is to be applied, and wherein a motion type of the target video block and a neighboring video block used for the OBMC are different for at least one of the following: a coding unit (CU) boundary OBMC, or a subblock boundary OBMC.

Clause 92. The method of clause 91, wherein one motion type is IBC and the other motion type is regular inter.

Clause 93. The method of clause 1, wherein when and/or how to apply the OBMC for IBC coded blocks is different from those for non-IBC coded blocks.

Clause 94. The method of clause 93, wherein a setting of weights for the OBMC for the IBC coded blocks is different from that for the non-IBC coded blocks.

Clause 95. The method of clause 1, wherein the BV derived from a candidate list for an IBC coded block with geometry or triangle partitions are further refined before being used to derive the prediction signal.

Clause 96. The method of clause 1, wherein the IBC mode based on geometric partitioning (GPM_IBC) with MBVD is to be applied, and wherein additional block vector differences (BVDs) are further applied on top of an existing GPM_IBC merge candidates.

Clause 97. The method of clause 94, wherein the additional BVDs are indicated in a same manner as the MBVD.

Clause 98. The method of clause 96 or 97, wherein two flags separately indicate whether an additional BVD is applied to each GPM_IBC partition.

Clause 99. The method of clause 98, wherein one single flag is indicated to jointly control whether the additional BVD is applied to each GPM_IBC partition.

Clause 100. The method of clause 98, wherein if a flag of one GPM_IBC partition is true, a BVD corresponding to the flag is indicated in a same way as the MBVD.

Clause 101. The method of clause 100, wherein the BVD is indicated by one distance index plus one direction index.

Clause 102. The method of clause 1, wherein the IBC mode based on geometric partitioning (GPM_IBC) with MBVD is to be applied, and wherein merge indices of two GPM_IBC partitions are allowed to be the same if the block vector differences (BVDs) that are applied to the two partitions are not identical.

Clause 103. The method of clause 1, wherein the IBC mode based on geometric partitioning (GPM_IBC) with MBVD is to be applied, and wherein an BV pruning procedure is introduced to construct a GPM_IBC merge candidate list if the GPM_IBC with MBVD is applied.

Clause 104. The method of clause 103, wherein the BV pruning procedure may be based on a threshold.

Clause 105. The method of clause 104, wherein if differences of horizontal and vertical components for two BVs are both smaller than the threshold, one of them is removed from the GPM_IBC merge candidate list.

Clause 106. The method of clause 104, wherein if horizontal and vertical components for two BVs are both the same, one of them is removed from the GPM_IBC merge candidate list.

Clause 107. The method of any of clauses 104-106, wherein the threshold is decided by a size of the target video block.

Clause 108. The method of any of clauses 104-106, wherein the threshold is predefined.

Clause 109. The method of clause 1, wherein the IBC mode based on geometric partitioning (GPM_IBC) with MBVD is to be applied, and wherein a distance index specifies motion magnitude information and indicates a pre-defined offset from a starting point.

Clause 110. The method of clause 109, wherein the pre-defined offset comprises an offset added to at least one of the following: a horizontal component of a starting motion vector (MV), or a vertical component of the starting MV.

Clause 111. The method of clause 109 or 110, wherein the predefined offset is one of 1 pixel, 2 pixels, 4 pixels, 8 pixels, 16 pixels, or 32 pixels.

Clause 112. The method of clause 109 or 110, wherein the predefined offset is one of 1 pixel, 2 pixels, 4 pixels, 8 pixels, 16 pixels, 32 pixels, 64 pixels, or 128 pixels.

Clause 113. The method of clause 109 or 110, wherein the predefined offset is one of 1 pixel, 2 pixels, 3 pixels, 4 pixels, 6 pixels, 8 pixels, or 16 pixels.

Clause 114. The method of clause 109 or 110, wherein the predefined offset is one of 1 pixel, 2 pixels, 3 pixels, 4 pixels, 6 pixels, 8 pixels, 16 pixels, 32 pixels, or 64 pixels.

Clause 115. The method of clause 1, wherein the IBC mode based on geometric partitioning (GPM_IBC) with MBVD is to be applied, and wherein a direction index represents a direction of the block vector difference (BVD) relative to a starting point.

Clause 116. The method of clause 115, wherein the direction index represents a predefined number of BVD directions.

Clause 117. The method of clause 116, wherein the predefined number is set to 4.

Clause 118. The method of clause 116, wherein 2 horizontal directions and 2 vertical directions are used for the BVD directions.

Clause 119. The method of clause 116, wherein 4 diagonal directions are used for the BVD directions.

Clause 120. The method of clause 116, wherein the predefined number is set to 8.

Clause 121. The method of clause 116, wherein 4 diagonal directions plus 2 horizontal directions and 2 vertical directions are used for the BVD directions.

Clause 122. The method of clause 1, wherein the IBC mode based on geometric partitioning (GPM_IBC) with TM is to be applied, and wherein if the GPM_IBC mode is enabled for a coding unit (CU), a CU-level flag indicates whether TM is applied to both geometric partitions.

Clause 123. The method of clause 1, wherein the IBC mode based on geometric partitioning (GPM_IBC) with TM is to be applied, and wherein if the GPM_IBC mode is enabled for a coding unit (CU), two CU-level flag indicates whether TM is applied to each geometric partition.

Clause 124. The method of clause 1, wherein the IBC mode based on geometric partitioning (GPM_IBC) with TM is to be applied, and wherein motion information for at least one geometric partition is refined using the TM.

Clause 125. The method of clause 124, wherein if only above template is available for the target video block, the GPM_IBC_TM mode uses the above template.

Clause 126. The method of clause 124, wherein if only left template is available for the target video block, the GPM_IBC_TM mode uses the left template.

Clause 127. The method of clause 124, wherein if both above and left templates are available for the target video block, the GPM_IBC_TM mode uses at least one of the following: the left template, the above template, or both above and left templates.

Clause 128. The method of clause 124, wherein if the TM is chosen, a template is constructed using at least one of the following: left neighboring samples according to a partition angle, or above neighboring samples according to the partition angle.

Clause 129. The method of clause 124, wherein a motion is refined by minimizing a difference between a current template and a reference template in a target picture associated with the target video block using a same search pattern of TM merge mode.

Clause 130. The method of clause 1, wherein the IBC mode based on geometric partitioning with the MBVD and the IBC mode based on geometric partitioning with the TM are exclusively enabled to one GPM_IBC block.

Clause 131. The method of any of clauses 1-130, wherein in the IBC prediction mode, prediction samples are derived from blocks of sample values of a same video region as determined by the BVs.

Clause 132. The method of any of clauses 1-130, wherein the conversion includes encoding the target video block into the bitstream.

Clause 133. The method of any of clauses 1-131, wherein the conversion includes decoding the target video block from the bitstream.

Clause 134. An apparatus for processing video data comprising a processor and a non-transitory memory with instructions thereon, wherein the instructions upon execution by the processor, cause the processor to perform a method in accordance with any of clauses 1-133.

Clause 135. A non-transitory computer-readable storage medium storing instructions that cause a processor to perform a method in accordance with any of clauses 1-133.

Clause 136. A non-transitory computer-readable recording medium storing a bitstream of a video which is generated by a method performed by a video processing apparatus, wherein the method comprises: determining an intra block copy (IBC)-based mode to be applied for the target video block, the IBC-based mode being based on at least one of the following: an IBC mode based on affine motion compensated prediction, an affine IBC merge mode with block vector differences (MBVD), an intra template matching for IBC mode (TM_IBC), wherein a derived block vector (BV) by the TM_IBC is used as base candidates for the MBVD, an intra template matching for IBC mode (TM_IBC), wherein a derived block vector (BV) by the TM_IBC is used as BV prediction candidate for IBC non-merge mode, an IBC prediction mode based on multi-hypothesis, an IBC mode based on overlapped block motion compensation (OBMC), an IBC mode based on geometric partitioning with the MBVD, or an IBC mode based on geometric partitioning with template matching (TM); and generating the bitstream based on the IBC-based mode.

Clause 137. A method for storing a bitstream of a video, comprising: determining an intra block copy (IBC)-based mode to be applied for the target video block, the IBC-based mode being at least one of the following: an IBC mode based on affine motion compensated prediction, an affine IBC merge mode with block vector differences (MBVD), an intra template matching for IBC mode (TM_IBC), wherein a derived block vector (BV) by the TM_IBC is used as base candidates for the MBVD, an intra template matching for IBC mode (TM_IBC), wherein a derived block vector (BV) by the TM_IBC is used as BV prediction candidate for IBC non-merge mode, an IBC prediction mode based on multi-hypothesis, an IBC mode based on overlapped block motion compensation (OBMC), an IBC mode based on geometric partitioning with the MBVD, or an IBC mode based on geometric partitioning with template matching (TM); generating the bitstream based on the IBC-based mode; and storing the bitstream in a non-transitory computer-readable recording medium.

### Example Device

FIG. 54 illustrates a block diagram of a computing device 5400 in which various embodiments of the present disclosure can be implemented. The computing device 5400 may be implemented as or included in the source device 110 (or the video encoder 114 or 200) or the destination device 120 (or the video decoder 124 or 300).

It would be appreciated that the computing device 5400 shown in FIG. 54 is merely for purpose of illustration, without suggesting any limitation to the functions and scopes of the embodiments of the present disclosure in any manner.

As shown in FIG. 54, the computing device 5400 includes a general-purpose computing device 5400. The computing device 5400 may at least comprise one or more processors or processing units 5410, a memory 5420, a storage unit 5430, one or more communication units 5440, one or more input devices 5450, and one or more output devices 5460.

In some embodiments, the computing device 5400 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 5400 can support any type of interface to a user (such as “wearable” circuitry and the like).

The processing unit 5410 may be a physical or virtual processor and can implement various processes based on programs stored in the memory 5420. In a multi-processor system, multiple processing units execute computer executable instructions in parallel so as to improve the parallel processing capability of the computing device 5400. The processing unit 5410 may also be referred to as a central processing unit (CPU), a microprocessor, a controller or a microcontroller.

The computing device 5400 typically includes various computer storage medium. Such medium can be any medium accessible by the computing device 5400, including, but not limited to, volatile and non-volatile medium, or detachable and non-detachable medium. The memory 5420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 5430 may be any detachable or non-detachable medium and may include a machine-readable medium such as a memory, flash memory drive, magnetic disk or another other media, which can be used for storing information and/or data and can be accessed in the computing device 5400.

The computing device 5400 may further include additional detachable/non-detachable, volatile/non-volatile memory medium. Although not shown in FIG. 54, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 5440 communicates with a further computing device via the communication medium. In addition, the functions of the components in the computing device 5400 can be implemented by a single computing cluster or multiple computing machines that can communicate via communication connections. Therefore, the computing device 5400 can operate in a networked environment using a logical connection with one or more other servers, networked personal computers (PCs) or further general network nodes.

The input device 5450 may be one or more of a variety of input devices, such as a mouse, keyboard, tracking ball, voice-input device, and the like. The output device 5460 may be one or more of a variety of output devices, such as a display, loudspeaker, printer, and the like. By means of the communication unit 5440, the computing device 5400 can further communicate with one or more external devices (not shown) such as the storage devices and display device, with one or more devices enabling the user to interact with the computing device 5400, or any devices (such as a network card, a modem and the like) enabling the computing device 5400 to communicate with one or more other computing devices, if required. Such communication can be performed via input/output (I/O) interfaces (not shown).

In some embodiments, instead of being integrated in a single device, some or all components of the computing device 5400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 5400 may be used to implement video encoding/decoding in embodiments of the present disclosure. The memory 5420 may include one or more video coding modules 5425 having one or more program instructions. These modules are accessible and executable by the processing unit 5410 to perform the functionalities of the various embodiments described herein.

In the example embodiments of performing video encoding, the input device 5450 may receive video data as an input 5470 to be encoded. The video data may be processed, for example, by the video coding module 5425, to generate an encoded bitstream. The encoded bitstream may be provided via the output device 5460 as an output 5480.

In the example embodiments of performing video decoding, the input device 5450 may receive an encoded bitstream as the input 5470. The encoded bitstream may be processed, for example, by the video coding module 5425, to generate decoded video data. The decoded video data may be provided via the output device 5460 as the output 5480.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, during a conversion between a target video block of a video and a bitstream of the video, an intra block copy (IBC)-based mode to be applied for the target video block, the IBC-based mode being based on at least one of the following:
an IBC mode based on affine motion compensated prediction (Affine_IBC),
an affine IBC merge mode with block vector differences (MBVD),
an intra template matching for IBC mode (TM_IBC), wherein a derived block vector (BV) by the TM_IBC is used as base candidates for the MBVD,
an intra template matching for IBC mode (TM_IBC), wherein a derived block vector (BV) by the TM_IBC is used as BV prediction candidate for IBC non-merge mode,
an IBC prediction mode based on multi-hypothesis,
an IBC mode based on overlapped block motion compensation (OBMC),
an IBC mode based on geometric partitioning with the MBVD, or
an IBC mode based on geometric partitioning with template matching (TM); and
performing the conversion based on the IBC-based mode.

2. The method of claim 1, wherein an affine motion model is utilized to predict the target video block from the reconstructed samples or pixels within the same picture, or
wherein the Affine_IBC mode is to be applied, and wherein an affine motion field of the target video block is described by motion information of two control points or three control points, wherein the affine motion field of the target video block is described by the 4 parameter affine model or 6 parameter affine model, or
wherein the c comprises an affine IBC merge mode and affine IBC advanced motion vector prediction (AMVP) mode, wherein the affine IBC merge mode is performed similar as an affine merge mode, and wherein the affine IBC AMVP mode is performed similar as an affine AMVP mode.

3. The method of claim 1, wherein a BV for a pixel of the target video block or for a sub-block of the target video block derived from an affine model is rounded or clipped to the integer precision, or
wherein a BV prediction of a control point inherited from a neighbouring video block of the target video block or derived from an affine model is rounded or clipped to the integer precision, or
wherein a prediction refinement with optical flow is used for the IBC mode based on affine motion compensated prediction, and wherein the prediction refinement with optical flow for the IBC mode based on affine motion compensated prediction is performed similar as a prediction refinement with optical flow for an affine mode, or
wherein the Affine_IBC mode is a merge mode wherein no BV difference (BVD) is coded, or
wherein the Affine_IBC mode is an inter mode wherein an indication of a BV difference (BVD) is coded, or
wherein the Affine_IBC mode is a merge mode wherein indications of BV differences (BVDs) within an affine BVD candidate list are coded or derived, and wherein an index of a BVD is coded.

4. The method of claim 1, wherein block vectors of control points used in the Affine_IBC mode may be derived according to one or more BVs derived from an affine BV candidate list and one or more BV differences (BVDs) selected from a given affine BVD candidate list, and wherein the affine IBC MBVD mode is to be applied, and wherein an affine IBC merge candidate is selected, and BVs of control points are further refined by indications of BVD information, and
wherein the BVD information for the BVs of all control points are the same, or
wherein the BVD information for the BVs of at least two control points are different, or
wherein a BV for a pixel of the target video block or for a sub-block of the target video block derived from an affine model is rounded or clipped to an integer precision, or
wherein a BV prediction of a control point inherited from a neighbouring block of the target video block or derived from an affine model is rounded or clipped to the integer precision, or
wherein the BVD information for the BVs of control points in the Affine_IBC_MBVD mode is different from that utilized for a translational MBVD methods, or
wherein the affine BVD candidate list only includes integer BVD candidates.

5. The method of claim 1, wherein if the derived BV by the TM_IBC is used as the base candidates for the MBVD, the BV is further refined by indicated block vector difference (BVD) information, and
wherein BVDs are indicated in a same manner as MBVD, or
wherein the BVDs are signaled in the same manner as the IBC non-merge mode, or
wherein a syntax element indicates whether the derived BV by the TM_IBC is further refined by the MBVD, and wherein the syntax element is indicated only if the TM_IBC mode is applied,
wherein the derived BV by the TM_IBC is the only candidate for the IBC non-merge mode if the derived BV is available, or
wherein the derived BV by the TM_IBC is the k-th candidate for the IBC non-merge mode if the derived BV is available, and wherein the k-th candidate is the first candidate, or
wherein a syntax element indicates whether the derived BV by the TM_IBC is used as a BV prediction candidate for the IBC non-merge mode, and wherein the syntax element is indicated only if the TM_IBC mode is applied.

6. The method of claim 1, wherein the IBC prediction mode based on multi-hypothesis is to be applied, and wherein one or more additional prediction signals for motion-compensating are indicated or derived, in addition to a conventional uni-prediction signal, or
wherein the one or more additional prediction signals for motion-compensating are indicated or derived and different from that in a case where only uni-prediction signal is used, and wherein if one or more additional prediction signals for motion-compensating are indicated or derived, in addition to a conventional uni-prediction signal, a resulting overall prediction signal is derived by a sample-wise weighted superposition, and
wherein the resulting overall prediction signal is accumulated iteratively with each additional prediction signal as:
$${p}_{n + 1} = ( 1 - {α}_{n + 1} ) {p}_{n} + {α}_{n + 1} {h}_{n + 1} ,$$
wherein resulting overall prediction signal is derived as the last weighted prediction signal having the largest index (n+1), and wherein one or two additional prediction signals are used, or
wherein a weighting factor for the sample-wise weighted superposition is predefined, and wherein the weighting factor is set to ½, or
wherein a weighting factor for the sample-wise weighted superposition is selected from a predefined set, and wherein the predefined set comprises one of the following: {½, ¼}, {¼, −⅛}, or {½, ¼, −⅛}, and
wherein the weighting factor is specified by an index, or
wherein a simplified Rate Distortion (RD) cost using Hadamard distortion measure and approximated bit rate is used for determining the best weighting factor, or
wherein a weighting factor for the sample-wise weighted superposition is position-dependent for each sample, and wherein the weighting factor is set to 1, 0, or ½, or
wherein a weighting factor for the sample-wise weighted superposition is indicated from encoder to decoder.

7. The method of claim 6, wherein if one or more additional prediction signals for motion-compensating are indicated or derived, in addition to a conventional uni-prediction signal, motion parameters of each additional prediction hypothesis are indicated by
a first indicating mode in which the motion parameters of each additional prediction hypothesis are indicated explicitly by specifying a block vector predictor index and a block vector difference, or
a second indicating mode in which the motion parameters of each additional prediction hypothesis are indicated implicitly by specifying a merge index, and
wherein the first indicating mode and the second indicating mode are distinguished with each other by a separate multi-hypothesis IBC merge flag, or
wherein multi-hypothesis motion estimation is performed in the first indicating mode, and
wherein additional IBC prediction hypotheses are searched for a predefined number (N) of IBC modes having first N lowest Hadamard Rate Distortion (RD) costs, or
wherein the additional IBC prediction hypotheses are searched for two of IBC modes having first two lowest Hadamard RD costs, or
wherein a motion estimation with a restricted search range is performed for the searching, and wherein the restricted search range is set to 16, or
wherein a simplified Rate Distortion (RD) cost using Hadamard distortion measure and approximated bit rate is used for determining the best weighting factor, or
wherein the additional prediction signals are explicitly indicated or implicitly inherited for a normal IBC merge mode, and
wherein the explicitly indicated additional prediction signals use a same IBC advanced motion vector prediction (AMVP) candidate list which is generated for a first explicitly indicated additional prediction signal, or
wherein the additional prediction signals are explicitly indicated or implicitly inherited except for an IBC SKIP mode, or
wherein the additional prediction signals are explicitly indicated or implicitly inherited for the MBVD mode, and
wherein the additional prediction signals are explicitly indicated or implicitly inherited except for an MBVD SKIP mode, and wherein there is no inheritance or merging of the additional prediction signals from merging candidates, or
wherein all explicitly indicated additional prediction signals use the same advanced motion vector prediction (AMVP) candidate list which is generated for the first explicitly signaled additional prediction signal.

8. The method of claim 6, wherein if one or more additional prediction signals for motion-compensating are indicated or derived, in addition to a conventional uni-prediction signal, the additional prediction signals are explicitly indicated or implicitly inherited for a sub-block IBC merge mode, and
wherein the additional prediction signals are explicitly indicated or implicitly inherited except for a sub-block IBC SKIP mode, and wherein there is no inheritance or merging of the additional prediction signals from merging candidates, or
wherein all explicitly indicated additional prediction signals use the same advanced motion vector prediction (AMVP) candidate list which is generated for the first explicitly signaled additional prediction signal, or
wherein the additional prediction signals are explicitly indicated or implicitly inherited for a non-affine IBC AMVP mode, and
wherein only one IBC AMVP candidate list is to be constructed, and wherein the only one IBC AMVP candidate list is to be constructed for a non-additional prediction signal, or
wherein the IBC AMVP candidate list is reused for the additional prediction signals.

9. The method of claim 6, wherein if one or more additional prediction signals for motion-compensating are indicated or derived, in addition to a conventional uni-prediction signal, the additional prediction signals are explicitly indicated or implicitly inherited for an affine IBC AMVP mode, and
wherein the additional prediction signals only support translational prediction signals, or
wherein an IBC AMVP candidate list is to be constructed, and
wherein the IBC AMVP candidate list is to be constructed for a non-additional prediction signal, or
wherein the IBC AMVP candidate list is reused for the additional prediction signals, and
wherein an affine IBC top left control point motion vector (MV) predictor is used as a MV predictor for the additional translational prediction signals, or
wherein an affine IBC top right or bottom left control point motion vector (MV) predictor is used as an MV predictor for the additional translational prediction signals.

10. The method of claim 6, wherein if one or more additional prediction signals for motion-compensating are indicated or derived, in addition to a conventional uni-prediction signal, the IBC prediction mode with the multi-hypothesis is not used together with at least one of the following within a prediction unit (PU): a combined IBC and inter mode, or a combined intra and IBC mode, and
wherein if the combined IBC and inter mode is selected with an IBC merging candidate that has the additional prediction signals, the additional prediction signals are not inherited or merged, or
wherein if the combined intra and IBC mode is selected with an IBC merging candidate that has the additional prediction signals, the additional prediction signals are not inherited or merged, and
wherein the additional prediction signals are not explicitly indicated in the combined IBC and inter mode, or
wherein the additional prediction signals are explicitly indicated in the combined intra and IBC mode, or
wherein the IBC prediction mode with the multi-hypothesis is not used together with at least one of the following within a prediction unit (PU): an IBC mode based on a triangle partition (TPM_IBC), or an IBC mode based on geometric partitioning (GPM_IBC), and
wherein if the TPM_IBC mode is selected with an IBC merging candidate that has the additional prediction signals, the additional prediction signals are not inherited or merged, or
wherein if the GPM_IBC mode is selected with an IBC merging candidate that has the additional prediction signals, the additional prediction signals are not inherited or merged, and
wherein the additional prediction signals are not explicitly indicated in the TPM_IBC mode, or
wherein the additional prediction signals are not explicitly indicated in the GPM_IBC mode.

11. The method of claim 1, wherein the IBC mode based on the OBMC is to be applied, and wherein a motion type of the target video block and a neighboring video block used for the OBMC are the same for at least one of the following: a coding unit (CU) boundary OBMC, or a subblock boundary OBMC, or wherein the motion type is IBC or regular inter, and wherein the IBC mode based on the OBMC is to be applied, or
wherein a motion type of the target video block and a neighboring video block used for the OBMC are different for at least one of the following: a coding unit (CU) boundary OBMC, or a subblock boundary OBMC, and wherein one motion type is IBC and the other motion type is regular inter, or
wherein when and/or how to apply the OBMC for IBC coded blocks is different from those for non-IBC coded blocks, and wherein a setting of weights for the OBMC for the IBC coded blocks is different from that for the non-IBC coded blocks, or
wherein the BV derived from a candidate list for an IBC coded block with geometry or triangle partitions are further refined before being used to derive the prediction signal, or
wherein the IBC mode based on geometric partitioning (GPM_IBC) with MBVD is to be applied, and wherein additional block vector differences (BVDs) are further applied on top of an existing GPM_IBC merge candidate.

12. The method of claim 11, wherein if a setting of weights for the OBMC for the IBC coded blocks is different from that for the non-IBC coded blocks, the additional BVDs are indicated in a same manner as the MBVD, and wherein two flags separately indicate whether an additional BVD is applied to each GPM_IBC partition, and
wherein one single flag is indicated to jointly control whether the additional BVD is applied to each GPM_IBC partition, or
wherein if a flag of one GPM_IBC partition is true, a BVD corresponding to the GPM_IBC partition is indicated in a same way as the MBVD, and wherein the BVD is indicated by one distance index plus one direction index.

13. The method of claim 1, wherein the IBC mode based on geometric partitioning (GPM_IBC) with MBVD is to be applied, and wherein merge indices of two GPM_IBC partitions are allowed to be the same if the block vector differences (BVDs) that are applied to the two partitions are not identical, or
wherein the IBC mode based on geometric partitioning (GPM_IBC) with MBVD is to be applied, and wherein an BV pruning procedure is introduced to construct a GPM_IBC merge candidate list if the GPM_IBC with MBVD is applied, and wherein the BV pruning procedure may be based on a threshold, and
wherein if differences of horizontal and vertical components for two BVs are both smaller than a threshold, one of them is removed from the GPM_IBC merge candidate list, or
wherein if horizontal and vertical components for two BVs are both the same, one of them is removed from the GPM_IBC merge candidate list, and
wherein the threshold is decided by a size of the target video block, or
wherein the threshold is predefined.

14. The method of claim 1, wherein the IBC mode based on geometric partitioning (GPM_IBC) with MBVD is to be applied, and wherein a distance index specifies motion magnitude information and indicates a pre-defined offset from a starting point, and wherein the pre-defined offset comprises an offset added to at least one of the following: a horizontal component of a starting BV, or a vertical component of the starting BV, and
wherein the predefined offset is one of 1 pixel, 2 pixels, 4 pixels, 8 pixels, 16 pixels, or 32 pixels, or
wherein the predefined offset is one of 1 pixel, 2 pixels, 4 pixels, 8 pixels, 16 pixels, 32 pixels, 64 pixels, or 128 pixels, or
wherein the predefined offset is one of 1 pixel, 2 pixels, 3 pixels, 4 pixels, 6 pixels, 8 pixels, or 16 pixels, or
wherein the predefined offset is one of 1 pixel, 2 pixels, 3 pixels, 4 pixels, 6 pixels, 8 pixels, 16 pixels, 32 pixels, or 64 pixels.

15. The method of claim 1, wherein the IBC mode based on geometric partitioning (GPM_IBC) with MBVD is to be applied, and wherein a direction index represents a direction of the block vector difference (BVD) relative to a starting point, and
wherein the direction index represents a predefined number of BVD directions, or
wherein the predefined number is set to 4, or
wherein 2 horizontal directions and 2 vertical directions are used for the BVD directions, or
wherein 4 diagonal directions are used for the BVD directions, or
wherein the predefined number is set to 8, or
wherein 4 diagonal directions plus 2 horizontal directions and 2 vertical directions are used for the BVD directions.

16. The method of claim 1, wherein the IBC mode based on geometric partitioning (GPM_IBC) with TM is to be applied, and wherein if the GPM_IBC mode is enabled for a coding unit (CU), a CU-level flag indicates whether TM is applied to both geometric partitions, or
wherein the IBC mode based on geometric partitioning (GPM_IBC) with TM is to be applied, and wherein if the GPM_IBC mode is enabled for a coding unit (CU), two CU-level flag indicates whether TM is applied to each geometric partition, or
wherein the IBC mode based on geometric partitioning (GPM_IBC) with TM is to be applied, and wherein motion information for at least one geometric partition is refined using the TM.

17. The method of claim 16, when a CU-level flag indicates whether TM is applied to both geometric partitions,
wherein if only above template is available for the target video block, the GPM_IBC_TM mode uses the above template, or
wherein if only left template is available for the target video block, the GPM_IBC_TM mode uses the left template, or
wherein if both above and left templates are available for the target video block, the GPM_IBC_TM mode uses at least one of the following:
the left template,
the above template, or
both above and left templates.

18. The method of claim 1, wherein the conversion includes encoding the target video block into the bitstream, or
wherein the conversion includes decoding the target video block from the bitstream.

19. An apparatus for processing video data comprising a processor and a non-transitory memory with instructions thereon, wherein the instructions upon execution by the processor, cause the processor to perform a method comprising:
determining, during a conversion between a target video block of a video and a bitstream of the video, an intra block copy (IBC)-based mode to be applied for the target video block, the IBC-based mode being based on at least one of the following:
an IBC mode based on affine motion compensated prediction (Affine_IBC),
an affine IBC merge mode with block vector differences (MBVD),
an intra template matching for IBC mode (TM_IBC), wherein a derived block vector (BV) by the TM_IBC is used as base candidates for the MBVD,
an intra template matching for IBC mode (TM_IBC), wherein a derived block vector (BV) by the TM_IBC is used as BV prediction candidate for IBC non-merge mode,
an IBC prediction mode based on multi-hypothesis,
an IBC mode based on overlapped block motion compensation (OBMC),
an IBC mode based on geometric partitioning with the MBVD, or
an IBC mode based on geometric partitioning with template matching (TM); and performing the conversion based on the IBC-based mode.

20. A non-transitory computer-readable storage medium storing instructions that cause a processor to perform a method comprising:
determining, during a conversion between a target video block of a video and a bitstream of the video, an intra block copy (IBC)-based mode to be applied for the target video block, the IBC-based mode being based on at least one of the following:
an IBC mode based on affine motion compensated prediction (Affine_IBC),
an affine IBC merge mode with block vector differences (MBVD),
an intra template matching for IBC mode (TM_IBC), wherein a derived block vector (BV) by the TM_IBC is used as base candidates for the MBVD,
an intra template matching for IBC mode (TM_IBC), wherein a derived block vector (BV) by the TM_IBC is used as BV prediction candidate for IBC non-merge mode,
an IBC prediction mode based on multi-hypothesis,
an IBC mode based on overlapped block motion compensation (OBMC),
an IBC mode based on geometric partitioning with the MBVD, or
an IBC mode based on geometric partitioning with template matching (TM); and
